(19) United States
(12) Patent Application Publication
(10) Pub. No.: US 2007/0027868 A1
(43) Pub. Date: Feb. 1, 2007

(54) Database software program and related method for using it

(75) Inventor: Ali Mohammed, Chino Hills, CA (US)

Correspondence Address: CONNOLLY BOVE LODGE & HUTZ LLP, P.O. BOX 2207, WILMINGTON, DE, 19899, US

(73) Assignee: Warner Bros. Entertainment Inc.

(21) Appl. No.: 11/194,098

(22) Filed: Jul. 28, 2005

(51) Int. Cl. G06F 7/00

(52) U.S. Cl. 707/7

(57) ABSTRACT

A computer-readable medium included in a server that has a database and to which a workstation having a monitor is coupled for viewing by a user. The computer-readable medium includes instructions for database management. The database includes project data related to multiple tasks handled by more than one project group. The instructions prompt a display of the project data on the monitor. The instructions prompt a display of a filter on the monitor that the user can use to perform sorting of the project data.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention

The invention relates generally to the field of database management. More specifically, the invention relates to a software program that facilities user interface with multiple databases.

2. Description of the Related Art

Thread Manager is the trade name of a database management software program written by Deloitte Consulting located in New York, N.Y. The program is used to enter and manipulate data stored in multiple databases, and thus, is an idea tool for project management applications where more than one database is utilized. However, limitations associated with the program prevent its widespread use for projects involving multiple sub-projects and tasks handled by different groups of employees within an organization. Accordingly, there is a need for a database software program that can facilitate the management of project data when a project includes multiple sub-projects and tasks handled by different groups of employees. The present invention satisfies this need.

### SUMMARY OF THE INVENTION

Embodiments of the present invention include a computer-readable medium included in a server that has a database and to which a workstation having a monitor is coupled for viewing by a user. The computer-readable medium includes instructions for database management. The database includes project data related to multiple tasks handled by more than one project group. The instructions prompt a display of the project data on the monitor. The instructions prompt a display of a filter on the monitor that the user can use to perform sorting of the project data.

In other, more detailed features of the invention, the instructions prompt a display of an icon on the monitor that is selectable by the user and that generates a report based on the project data. The instructions allow the user to input project data into the database. The project data is selected from the group consisting of project release information, project division information, business unit information, and territory information. The instructions are written in a computer language selected from the group consisting of MS Access and Visual Basic.

In other, more detailed features of the invention, the instructions are configured to facilitate the display of stakeholder project data selected from the group consisting of a stakeholder's name, a stakeholder's job title, a stakeholder's business role, a stakeholder's work location, a stakeholder's electronic-mail address, a stakeholder's facsimile number, a stakeholder's business unit, a stakeholder's network identification, a stakeholder's employment start date, a stakeholder's employment end date, a stakeholder's spending limit, a stakeholder's approval limit, and a stakeholder's spending limit approver. The instructions are configured to facilitate a display of inventory data selected from the group consisting of server identification information, workstation identification information, and printer information.

In other, more detailed features of the invention, the instructions are configured to facilitate a display of business process data selected from the group consisting of project organization information, team member information, project policy information, project procedures information, business process information, business sub-process information, business activity information, business work step information, project issue information, action item information, and change request information. The project data displayed on the monitor is configured in a screen, and the instructions are configured to facilitate copying of a functionality of the screen and project data mapped to the screen when the user creates another screen.

In other, more detailed features of the invention, the instructions are configured to provide the user with access to a view, which facilitates a fast querying of project data stored in the database. The instructions are configured to facilitate a display of change request information selected from the group consisting of an estimated time of completion of a change request and an impact of the change request on different project teams. The instructions are configured to facilitate a display of training information selected from the group consisting of training course information, a training course developer name, facility information, and enrollee information.

In other, more detailed features of the invention, the instructions are configured to pull stakeholder information from the database, enroll a stakeholder in a training course, and notify the stakeholder of a class schedule. The instructions include a security feature that restricts the user's access to particular project data and provides the user permission to project data selected from the group consisting of read-only access, read-write-create access, and read-write-create-destroy access. The instructions include an audit trail that tracks change information selected from the group consisting of a time when a change was made to the data in the databases and an indication of who made the change.

Another exemplary embodiment of the invention is a computer-readable medium included in a server that has a database and to which a workstation having a monitor is coupled. The computer-readable medium includes instructions for database management. The database includes project data related to multiple tasks handled by more than one project group. The instructions prompt a display of the project data on the monitor for viewing by a user. The instructions prompt a display of a filter on the monitor that the user can use to perform sorting of the project data. The project data displayed on the monitor is configured in a screen, and the instructions are configured to facilitate copying of a functionality of the screen and project data mapped to the screen when the user creates another screen. The instructions are configured to provide the user with access to a view that facilitates a fast querying of project data stored in the database. The instructions are configured to facilitate a display of change request information selected from the group consisting of an estimated time of completion of a change request and an impact of the change request on different project teams. The instructions are configured to facilitate a display of training information selected from the group consisting of training course information, a training course developer name, facility information, and enrollee information. The instructions include a security feature that restricts the user's access to particular project data and provides the user permission to project data selected from the group consisting of read-only access, read-write-create access, and read-write-create-destroy access. The instructions include an audit trail that tracks change information selected from the group consisting of a time when a change was made to the data in the databases and an indication of who made the change.

An exemplary method according to the present invention is a method for managing a database stored on a server. The method includes providing a workstation having a monitor configured to facilitate a display of project data included in the database for viewing by a user, wherein the project data is related to multiple tasks handled by more than one project group, providing the user an ability to perform a search on the project data, displaying a filter on the monitor that the user can use to perform sorting of the project data, and providing the user an ability to display search results on the monitor.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is a block diagram of a computer system including a server for storing a program according to a preferred embodiment of the present invention.

FIG. 2 is a diagram of a view formed from two data tables.

FIG. 3 is a flow diagram of the process for adding a field to a table generated by the program.

FIG. 4 is a printout of a change request screen generated by the program.

FIG. 5 is a printout of a change request data entry screen generated by the program with a change request tab selected.

FIG. 6 is a printout of a main menu screen generated by the program.

FIG. 7 is a printout of a stakeholders screen generated by the program.

FIG. 8 is a printout of a stakeholder data entry screen generated by the program with a stakeholder tab selected.

FIG. 9 is a printout of the stakeholder data entry screen generated by the program with a meetings attended tab selected.

FIG. 10 is a printout of the stakeholder data entry screen generated by the program with a notes tab selected.

FIG. 11 is a printout of the stakeholder data entry screen generated by the program with a miscellaneous information tab selected.

FIG. 12 is a printout of a positions data entry screen generated by the program.

FIG. 13 is a printout of the stakeholder data entry screen generated by the program with a mapped roles tab selected.

FIG. 14 is a printout of the stakeholder data entry screen generated by the program with a desktop tab selected.

FIG. 15 is a printout of a stakeholder groups screen generated by the program.

FIG. 16 is a printout of a business roles to position mapping screen generated by the program.

FIG. 17 is a printout of a business role to position mapping data entry screen generated by the program.

FIG. 18 is a printout of a reports screen generated by the program.

FIG. 19 is a printout of a business roles screen generated by the program.

FIG. 20 is a printout of a to-be interfaces screen generated by the program.

FIG. 21 is a printout of an interface data entry screen generated by the program with an overview tab selected.

FIG. 22 is a printout of the interface data entry screen generated by the program with a document tab selected.

FIG. 23 is a printout of the interface data entry screen generated by the program with a related interfaces tab selected.

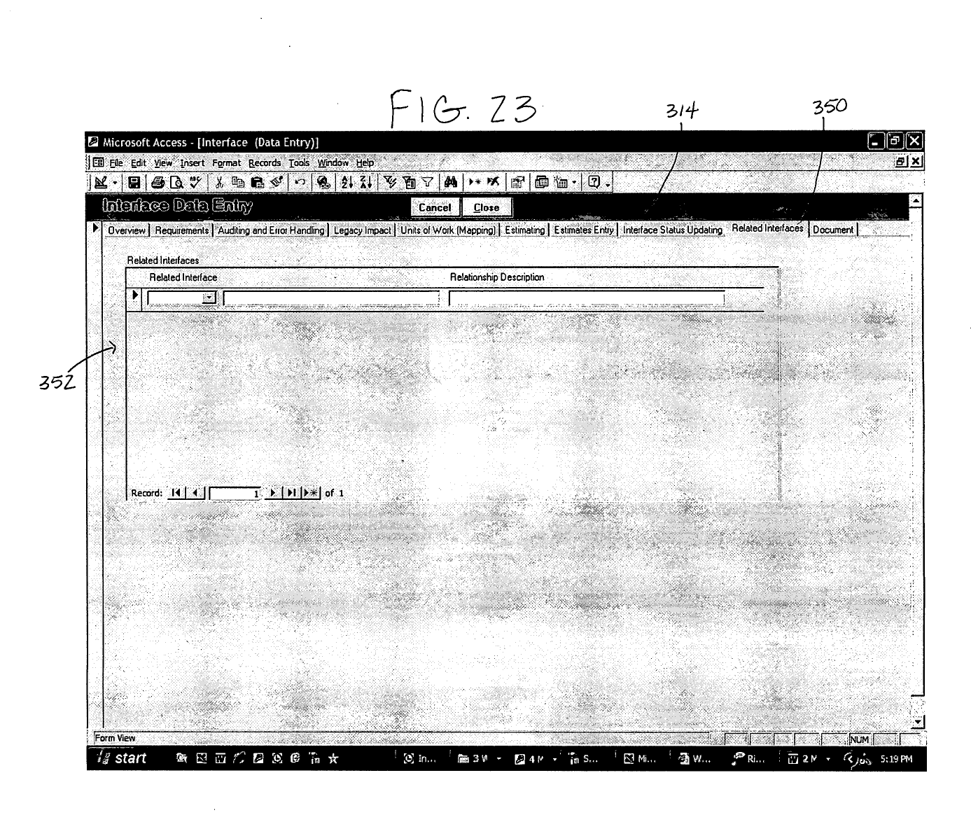

FIG. 24 is a printout of an example report screen generated by the program.

FIG. 25 is a printout of an interface browse form screen generated by the program.

FIG. 26 is a printout of a conversions screen generated by the program.

FIG. 27 is a printout of a conversion data entry screen generated by the program with an overview tab selected.

FIG. 28 is a printout of the conversion data entry screen generated by the program with a related conversions tab selected.

FIG. 29 is a printout of the conversion data entry screen generated by the program with a documents tab selected.

FIG. 30 is a printout of a reports data entry screen generated by the program with a report tab selected.

FIG. 31 is a printout of the reports data entry screen generated by the program with a related reports/forms tab selected.

FIG. 32 is a printout of the reports data entry screen generated by the program with a document tab selected.

FIG. 33 is a printout of an enhancements screen generated by the program.

FIG. 34 is a printout of an enhancements data entry screen generated by the program with an enhancements tab selected.

FIG. 35 is a printout of the enhancements data entry screen generated by the program with a related enhancements tab selected.

FIG. 36 is a printout of a business processes screen generated by the program.

FIG. 37 is a printout of a business process data entry screen generated by the program with a business process tab selected.

FIG. 38 is a printout of the business process data entry screen generated by the program with an applies to tab selected.

FIG. 39 is a printout of the business process data entry screen generated by the program with a copy tab selected.

FIG. 40 is a printout of the business process data entry screen generated by the program with a BU gap tab selected.

FIG. 41 is a printout of the business process data entry screen generated by the program with a territory gap tab selected.

FIG. 42 is a printout of the business process data entry screen generated by the program with a BP view tab selected.

FIG. 43 is a printout of a business process view screen generated by the program.

FIG. 44 is a printout of a work steps screen generated by the program.

FIG. 45 is a printout of a work steps data entry screen generated by the program with a work step tab selected.

FIG. 46 is a printout of the work step data entry screen generated by the program with a forms tab selected.

FIG. 47 is a printout of the work step data entry screen generated by the program with a copy tab selected.

FIG. 48 is a printout of a business rules screen generated by the program.

FIG. 49 is a printout of a policies screen generated by the program.

FIG. 50 is a printout of a policies data entry screen generated by the program with a policy tab selected.

FIG. 51 is a printout of a procedures screen generated by the program.

FIG. 52 is a printout of a procedures data entry screen generated by the program with a procedure tab selected.

FIG. 53 is a printout of an issue management screen generated by the program.

FIG. 54 is a printout of an issue management data entry screen generated by the program with an issue tab selected.

FIG. 55 is a printout of a change request data entry screen generated by the program with a change request tab selected.

FIG. 56 is a printout of the change request data entry screen generated by the program with a description tab selected.

FIG. 57 is a printout of the change request data entry screen generated by the program with an impact tab selected.

FIG. 58 is a printout of the change request data entry screen generated by the program with a communication required tab selected.

FIG. 59 is a printout of the change request data entry screen generated by the program with a link deliverables tab selected.

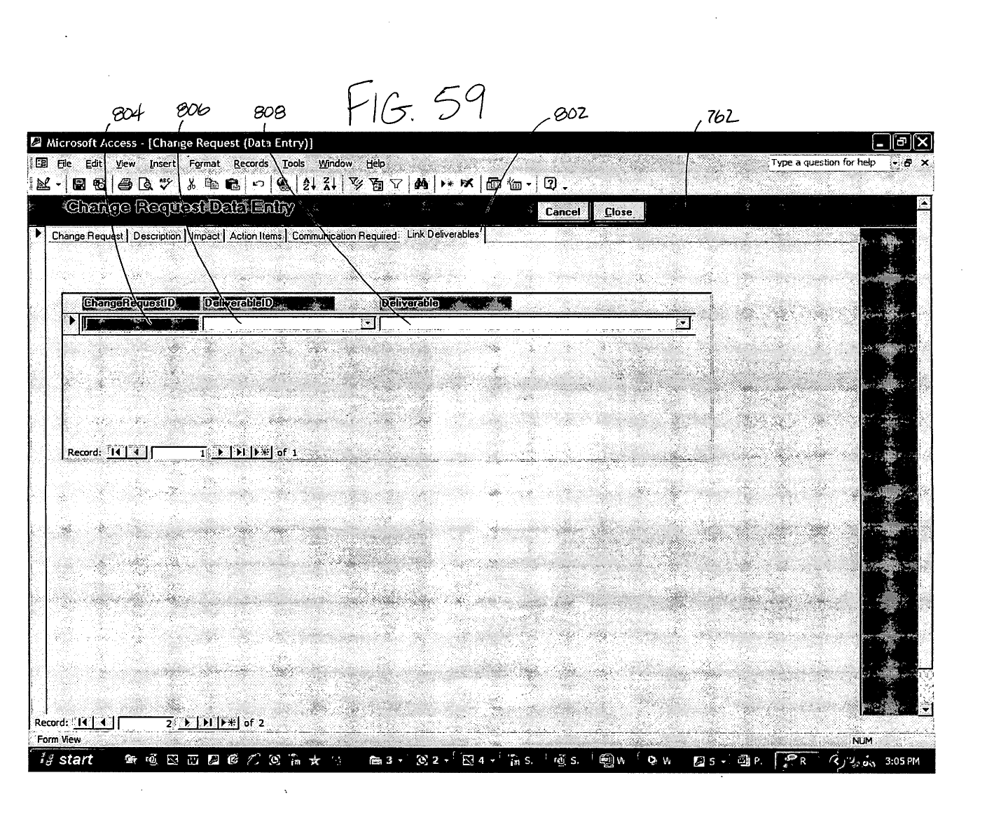

FIG. 60 is a printout of a project team members screen generated by the program.

FIG. 61 is a printout of a team members data entry screen generated by the program with a team member tab selected.

FIG. 62 is a printout of a training courses screen generated by the program.

FIG. 63 is a printout of a training courses data entry screen generated by the program with a course tab selected.

FIG. 64 is a printout of a stored procedure properties screen generated by the program.

FIG. 65 is a printout of a transactions scripts screen generated by the program.

FIG. 66 is a printout of a transaction scripts details screen generated by the program with a scripts tab selected.

FIG. 67 is a printout of an example report screen generated by the program.

FIG. 68 is a printout of an example query builder screen generated by the program.

FIG. 69 is a printout of a custom reports and forms screen generated by the program.

### DETAILED DESCRIPTION OF THE PREFERRED EMBODIMENTS

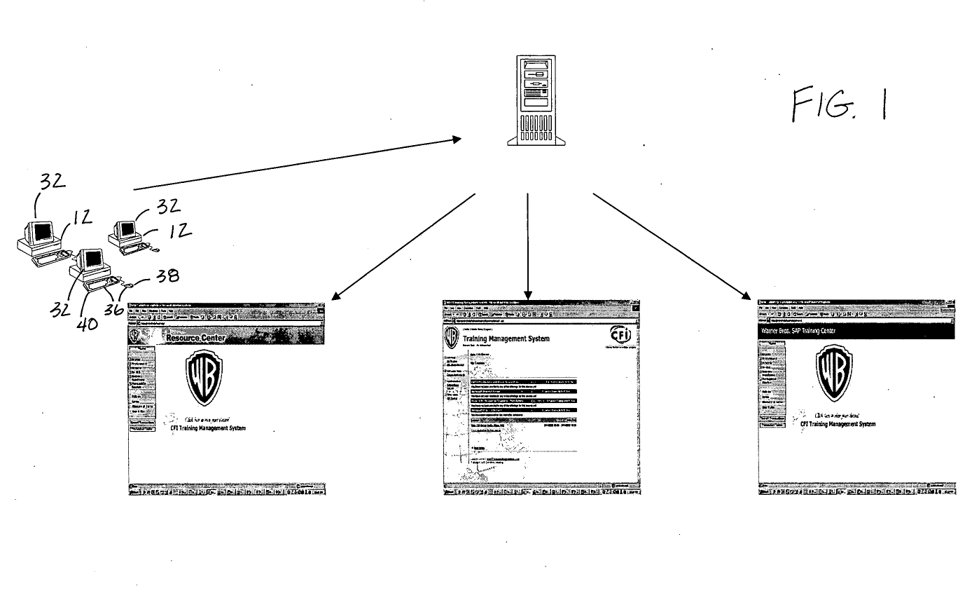

Referring to FIG. 1, the invention is embodied in a database software program that provides instructions regarding the input, manipulation, and use of the data included in the database. The program is stored within a memory (not shown) and/or storage device (not shown) included in a server 10 to which workstations 12 are coupled. The program is written in both MS Access and Visual Basic. Embodiments of the program are used as project repositories, because the program can be used to enter, manipulate, and integrate vast quantities of project data, e.g., information about each business process, sub-process, activity, and work step included in the project, from multiple databases into a single relational database.

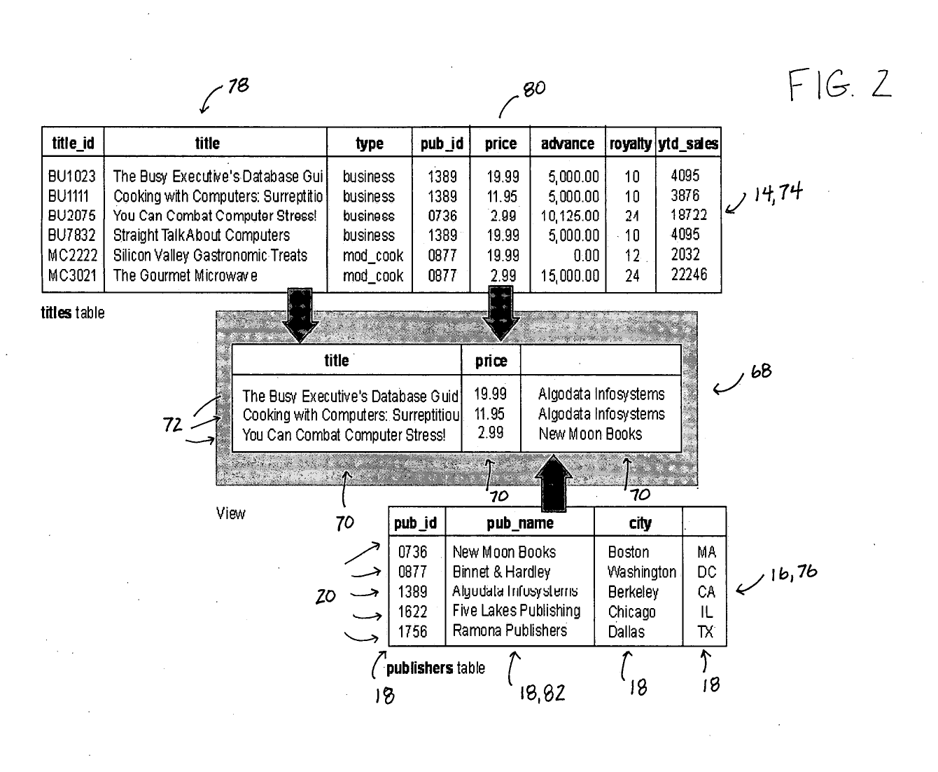

Referring to FIG. 2, a relational database is a collection of data organized in a set of tables 14 and 16, where the data is grouped into predefined categories. Each table, also referred to as a relation, has one or more data categories organized into columns 18. Each row 20 of the table contains a unique instance of data for the categories defined by the columns.

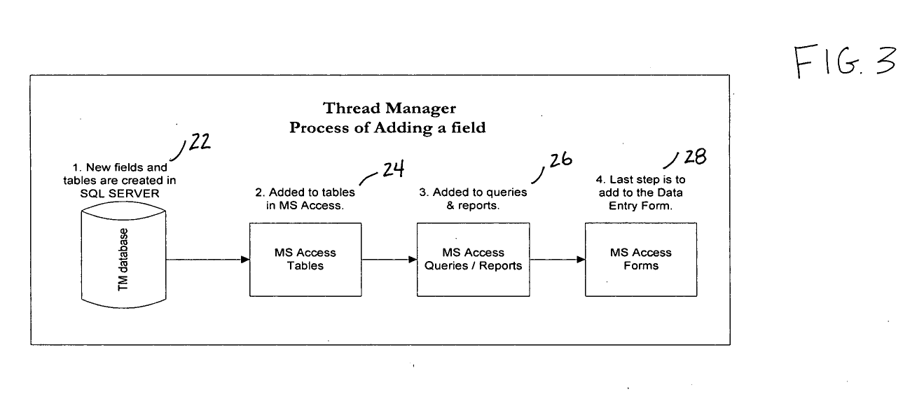

Referring to FIG. 3, adding or modifying the fields in a table 14 and 16 requires the following steps. In the first step 22, new fields are created using the SQL Server programming language. In the second step 24, the new fields are added to the tables using the MS Access programming language. In the third step 26, the new fields are added to the queries and reports, which are utilized by the program. In the fourth step 28, the field is added to the Data Entry Forms, which are displayed to the user.

By using the program, data consistency is maintained across multiple sub-project teams because the data is entered and recorded in a consistent format. Also, the program advantageously allows project team members real-time access to project data.

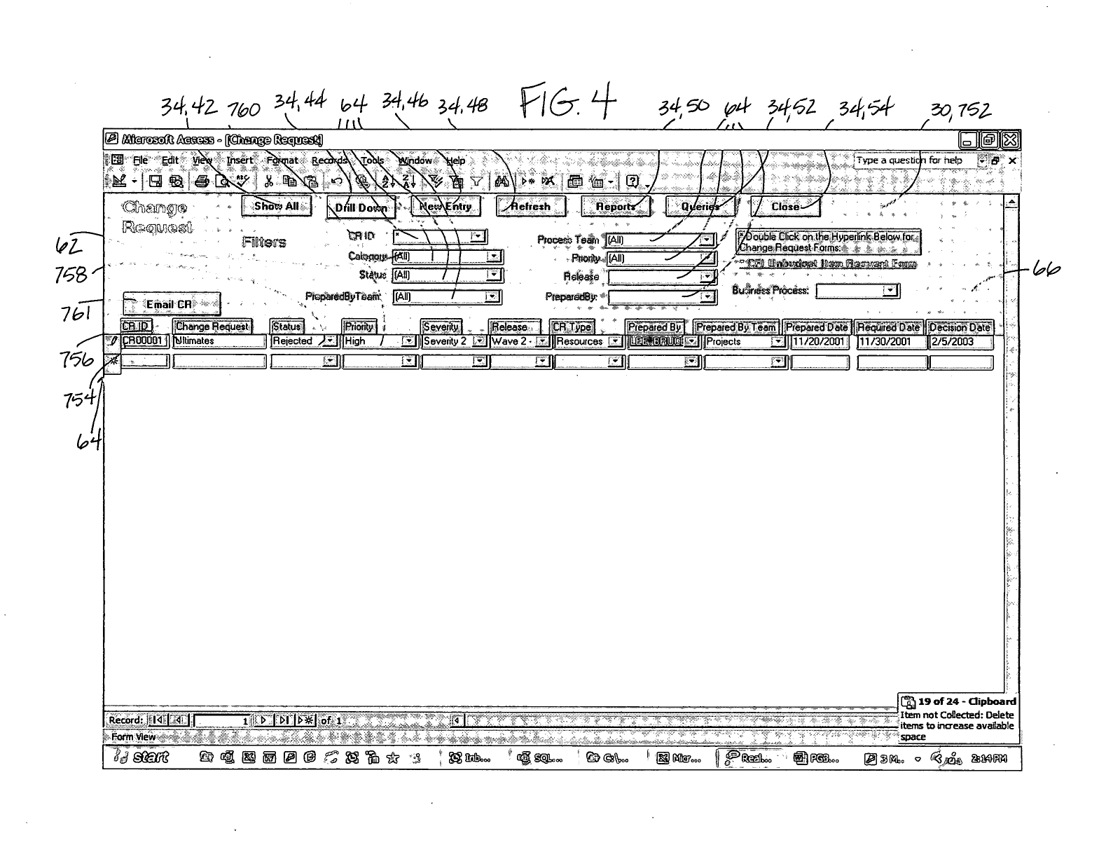

Referring again to FIG. 1 and additionally to FIG. 4, users interface with the program and its associated databases through various hierarchically related display screens 30, which are generated by the program and displayed on the monitor 32 of the user's workstation 12. The screens allow the user to input and review the data stored in the databases, which are stored in the memory (not shown) and/or storage device (not shown) in the server 10.

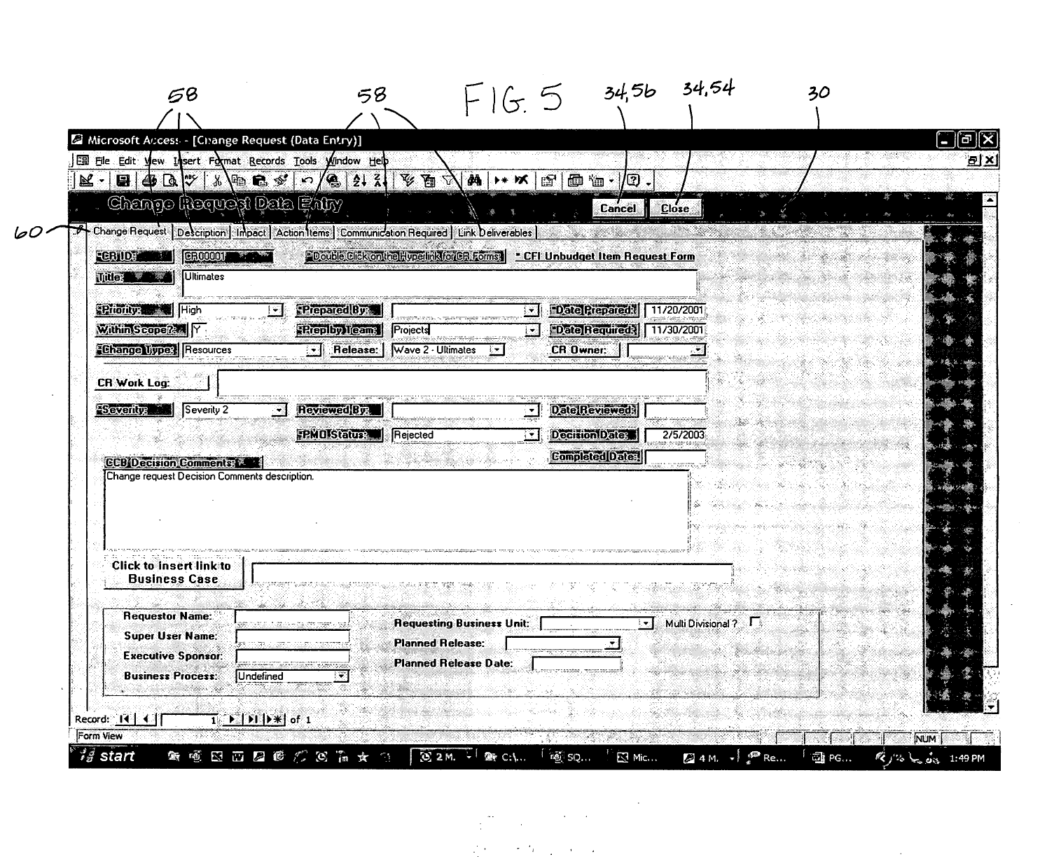

The user can select action buttons 34 on the screens 30 using an input/output device 36, e.g., mouse 38 and keyboard 40, to perform various functions. Referring additionally to FIG. 5, the screens may include the following action buttons: show all 42, drill down 44, new entry 46, refresh 48, reports 50, queries 52, close 54, and cancel 56. After the user selects the show all button, all records are displayed, and any filters that were set are removed. The user would select the drill down button to view related screens that are hierarchically below the current screen. The new entry button is selected by the user when the user wants to type in a new data entry. The screen refreshes itself after the user selects the refresh button. When the user is ready to generate a report (not shown) for analysis by the user, the user selects the reports button. The report can be of various formats as discussed later in this document. The user selects the queries button when he or she wants to perform a query, i.e., request information from the database, on one or more tables 14 and 16 of data stored in the database. The close button is selected by the user when he or she wants to exit the screen. The cancel button is selected by the user when he or she wants to cancel any additions or changes made to the data on the screen.

Also, some screens 30 include tabs 58, which can be selected by the user to view related screens. Initially, when the screen is first displayed, the screen associated with the left-most tab 60 is displayed, and thus, the left-most tab is initially selected by default. In addition, some of the screens include filters 62, which can be used to sort and view data. The filters include fields 64 into which the user types the information of interest. After the user types the enter key (not shown) on the keyboard 40, the program sorts the data based on the information of interest, and once completed, displays an updated screen showing the filtered results. Some of the screens also include hyperlinks 66, which automatically perform a specific function after the hyperlink is selected by the user. For example, selection of a hyperlink can result in the display of forms (not shown) and templates (not shown) for the entry of data, and the display of additional reference documents (not shown), e.g., specifications.

Referring again to FIG. 2, the program utilizes views 68 to facilitate fast querying of data from the database. A view is a virtual table created in SQL Server whose contents are defined by a query. Similar to a table 14 and 16, a view consists of a set of named columns 70 and rows 72 of data. However, a view does not exist as a stored set of data values in the database. The rows and columns of data come from the tables referenced in the query defining the view, and are produced dynamically by the view. There are no restrictions on querying using views, and few restrictions exist on modifying data using them.

An example of a view 68 is shown in FIG. 2, which illustrates a titles table 74, a publishers table 76, and the view. The view is created from data in the two tables. More specifically, the view includes the title and price data 78 and 80, respectively, from the titles table, and the publisher's name 82 from the publisher's table. Accordingly, a view acts as a filter on the underlying tables referenced in the view. Also, the query that defines the view can be based on one or more tables and/or views. Distributed queries also can be used to define views that use data from multiple data sources, e.g., multiple databases. This is useful if the user wants to combine similarly structured data from different servers 10, each of which stores data for a different region of an organization.

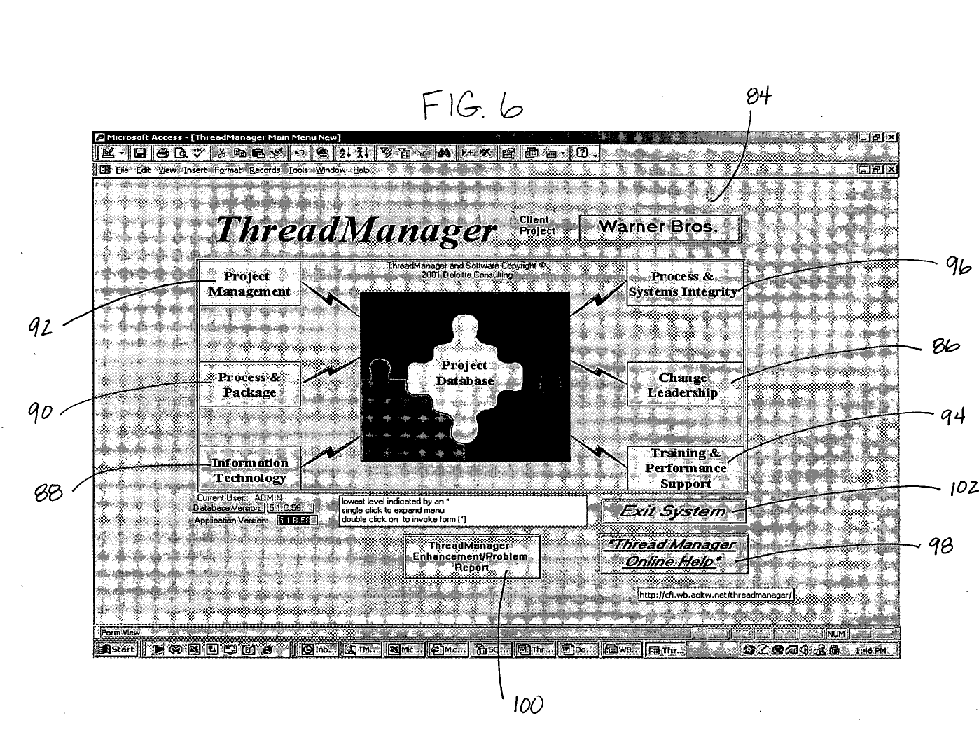

Referring to FIG. 6, one of the program's screen is a main menu screen 84 which includes user-selectable buttons 86-100 for the following submenus: the change leadership submenu 86, the information technology submenu 88, the process and package submenu 90, the project management submenu 92, the training and performance support submenu 94, and the process and system integrity submenu 96 (which is not used). The main menu also includes user-selectable buttons for an online help site 98 and an enhancement/problem report 100 where project team members log issues, and future enhancements and modifications to the program. In addition, the main menu screen includes an exit system button 102, which, when selected, takes the user out of the program.

The Change Leadership Submenu

The change leadership submenu includes screens 30 that display data related to: the project's organizational structure, the geographic location information for project subgroups and teams, and the business roles of the project team members. Additionally, the change leadership submenu includes screens that display data associated with each project stakeholder, which is an individual that is impacted by the project. For example, a project stakeholder can be an employee or contractor currently working on the project, a former employee or contractor, or a supplier or customer involved with the project.

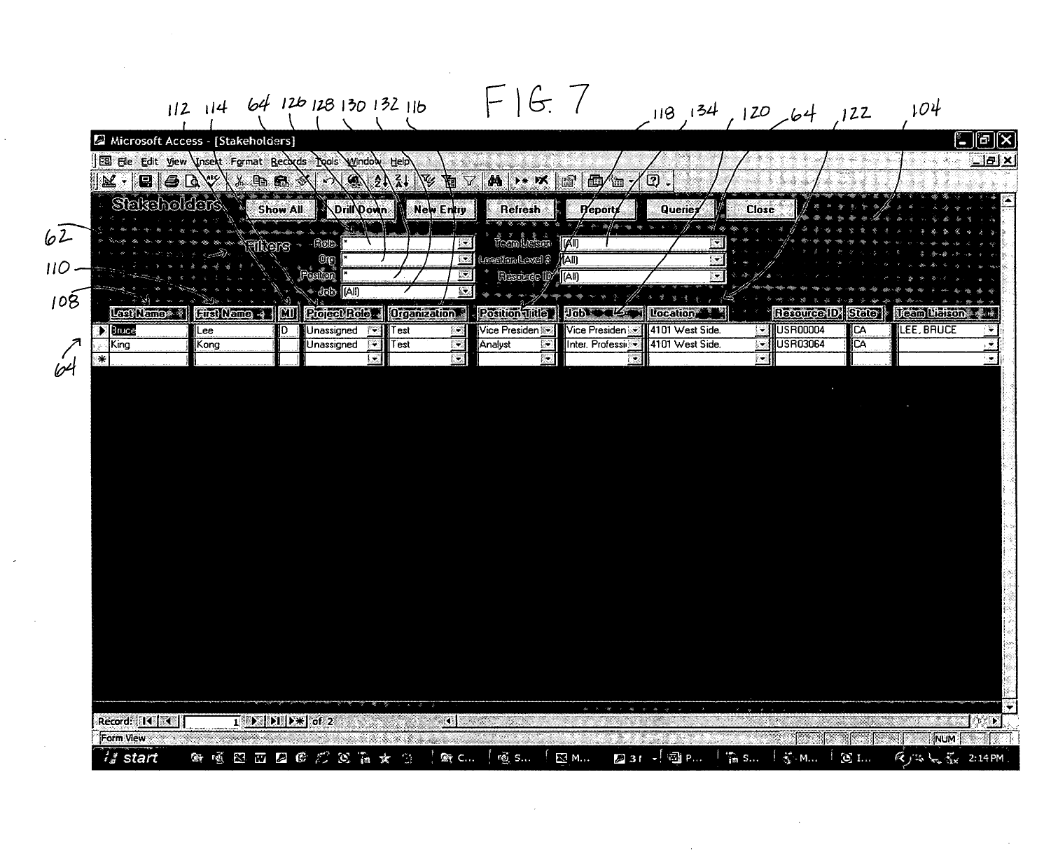

Referring to FIG. 7, the change leadership submenu includes a stakeholders screen 104, which includes fields 64 used to display stakeholder-related data, for example, a stakeholder's last name 108, first name 110, middle initial (“MI”) 112, project role 114, organization 116, position title 118, job 120, and location 122. The stakeholders screen also includes filters 62, having fields for the entry of various stakeholder data, for example, the stakeholder's role 126, organization 128, position 130, job 132, and location 134, which can be used to sort the stakeholder data.

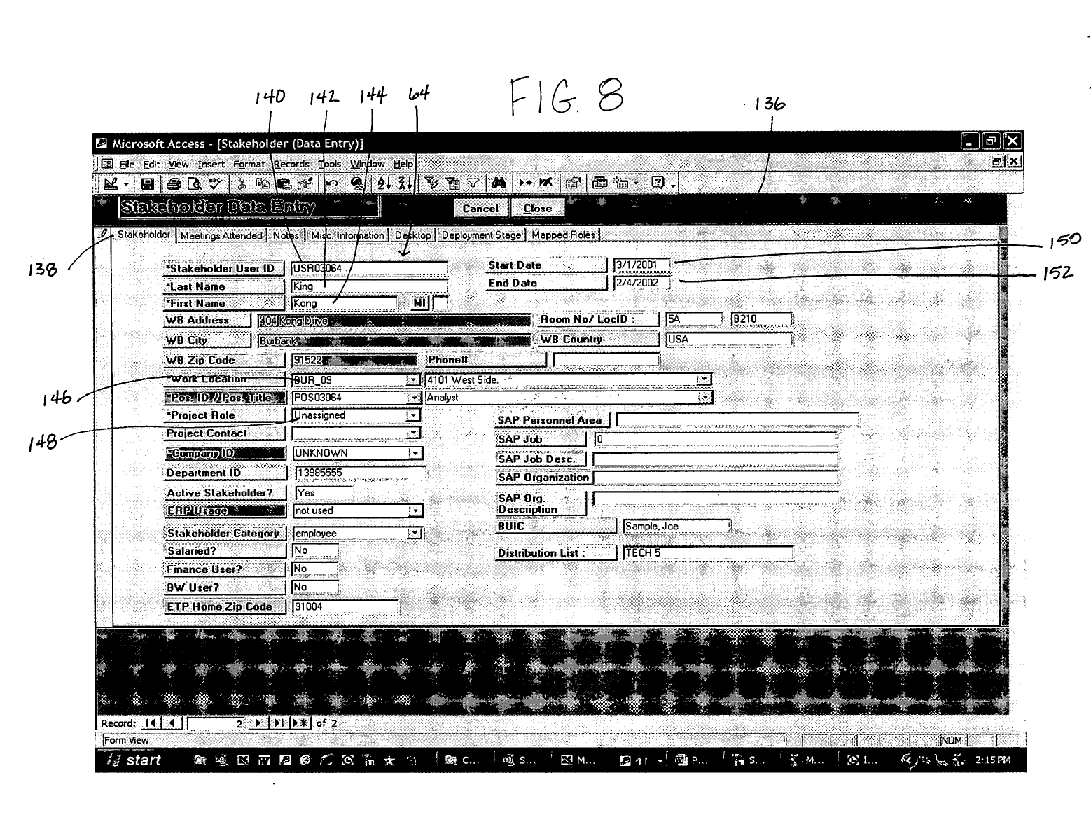

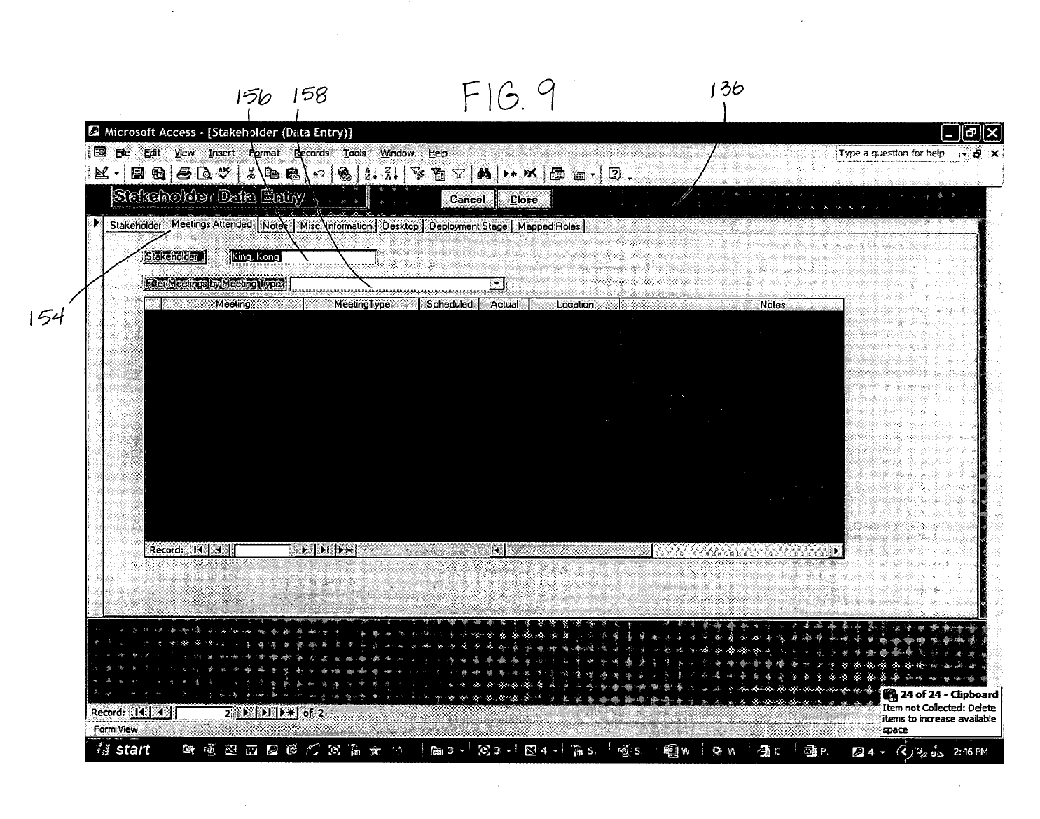

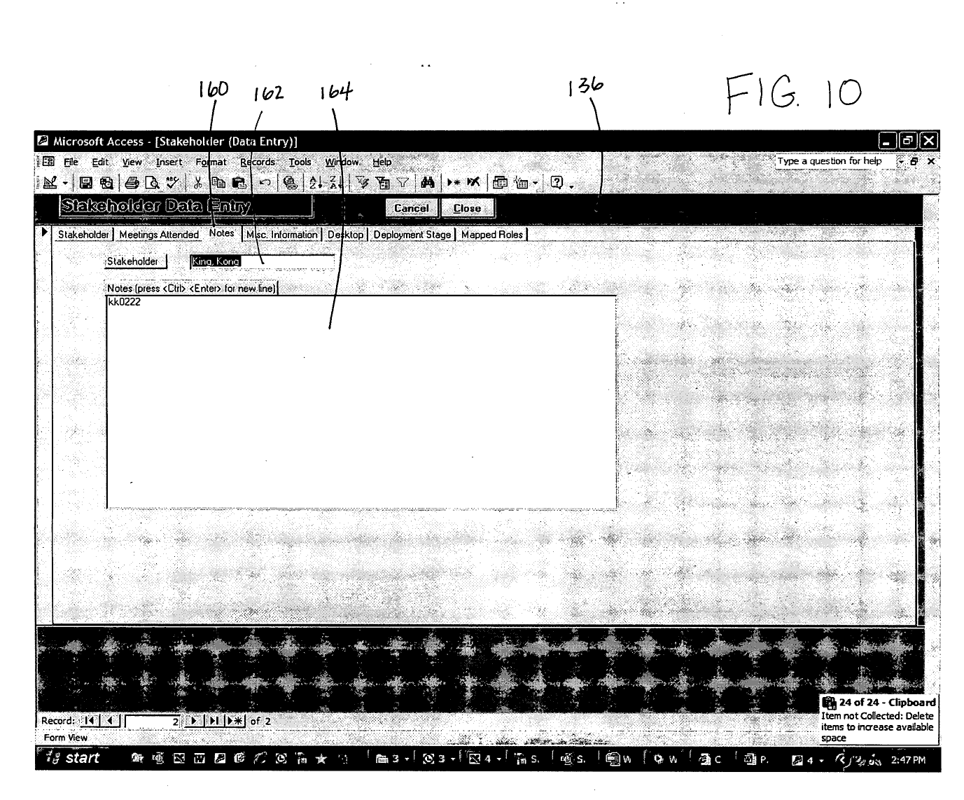

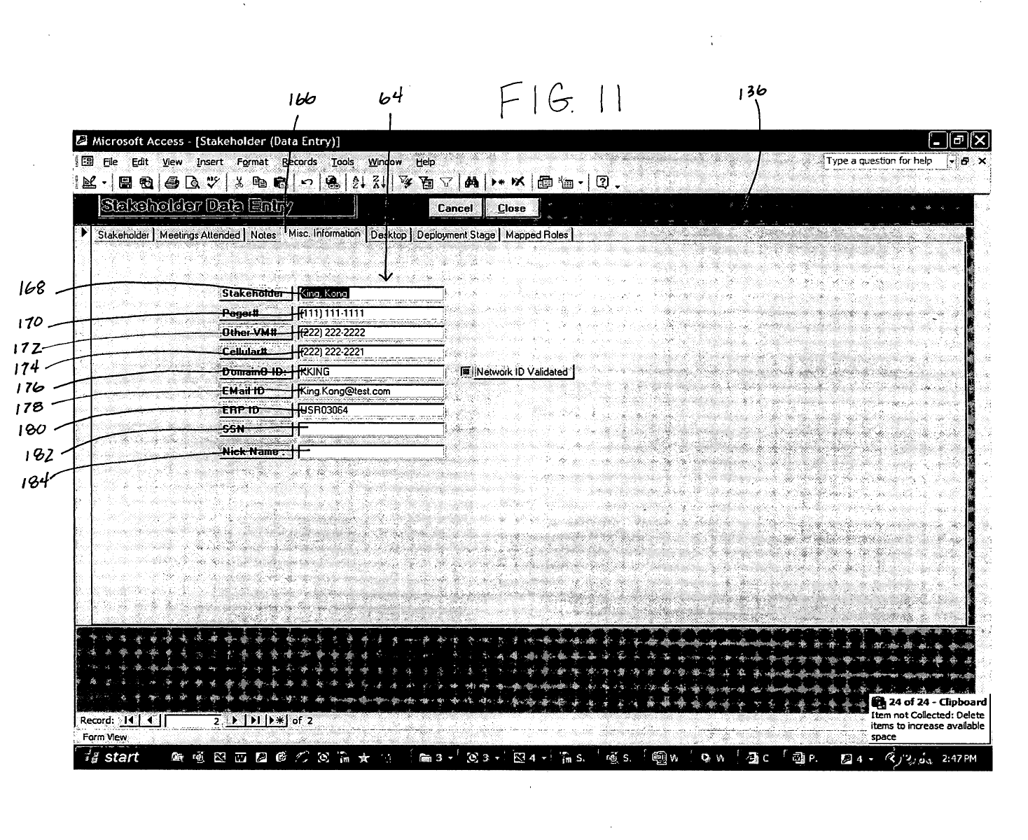

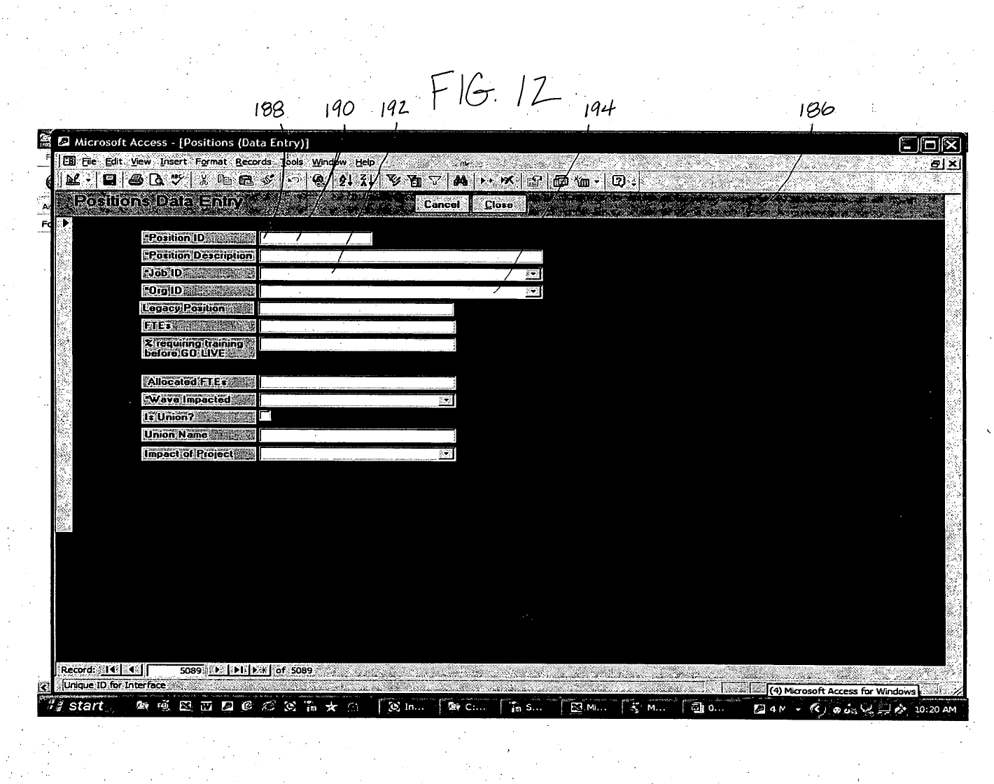

Referring to FIG. 8, stakeholder information can be entered by the user in a stakeholder data entry screen 136 when the stakeholder tab 138 is selected. The stakeholder data entry screen includes fields 64 for the entry of information, for example, the stakeholder's user ID 140, last name 142, first name 144, work location 146, project role 148, start date 150, and end date 152. Referring to FIG. 9, when the meetings attended tab 154 is selected on the stakeholder data entry screen, a field 156 is displayed for the entry of a stakeholder name, and another field 158 is displayed for filtering meetings attended by the stakeholder by the meeting type. Referring to FIG. 10, when the notes tab 160 is selected on the stakeholder data entry screen, a field 162 is displayed for the entry of a stakeholder's name, and another field 164 is displayed for the entry of notes related to the stakeholder. Referring to FIG. 11, when the miscellaneous information tab 166 is selected on the stakeholder data entry screen, fields are displayed for the entry of a stakeholder's name 168, the stakeholder's pager phone number 170, other voice message phone number 172, cellular phone number 174, domain ID 176, electronic-mail ID 178, ERP ID 180, social security number 182, and nick name 184. ERP stands for enterprise resource planning, which is any software system designed to support and automate the business process of medium and large businesses. If the stakeholder's position information has not been input to the database, the user can input the stakeholder's position data on a positions data entry screen 186, as shown in FIG. 12. In the position data entry screen, the user can enter position-related information, for example, the position ID 188, position description 190, job ID 192, and organization ID 194.

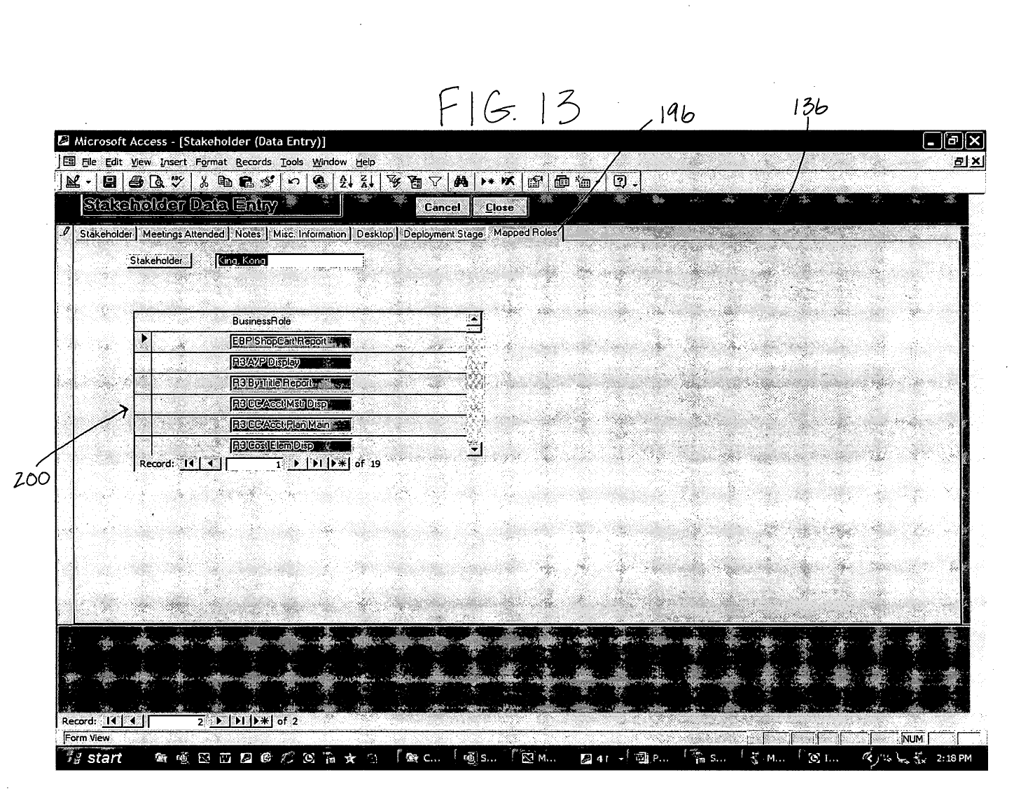

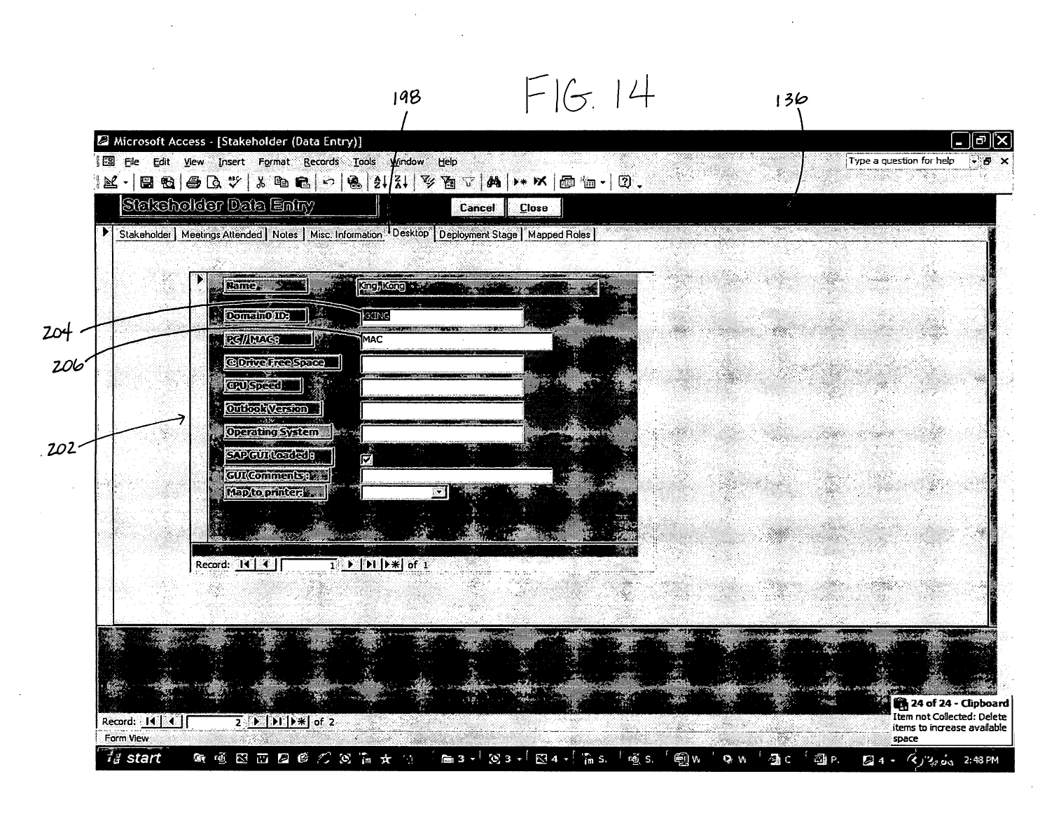

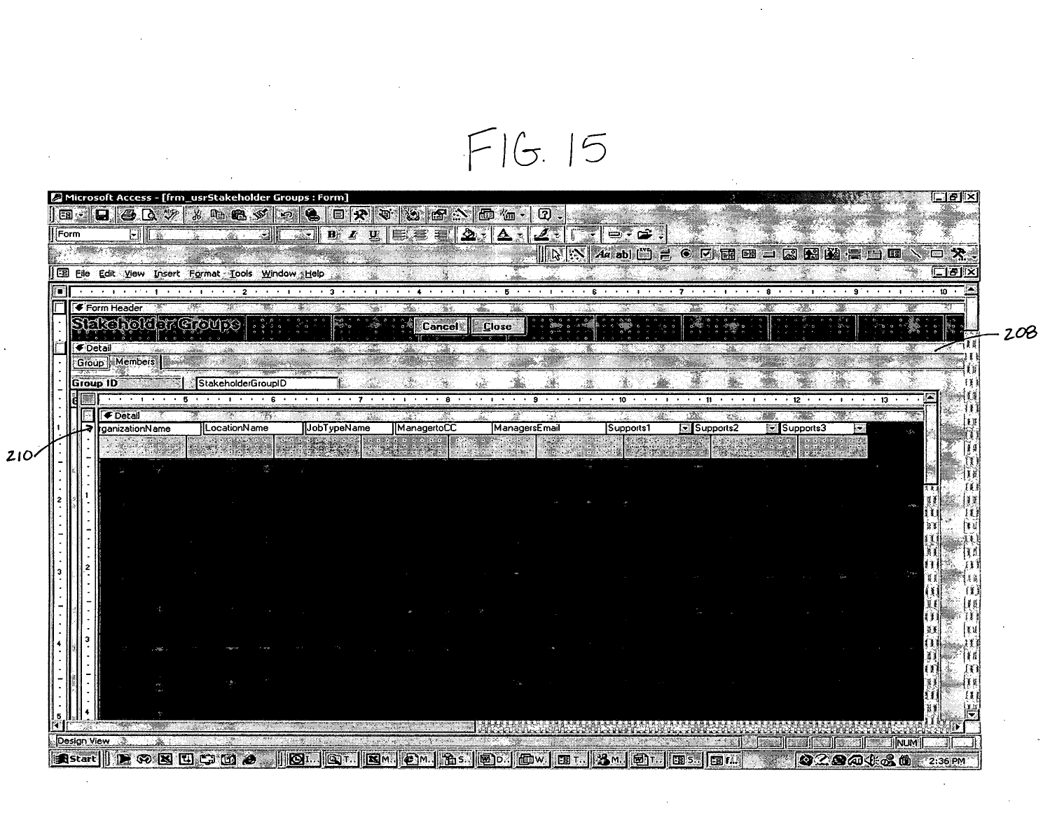

Referring additionally to FIGS. 13 and 14, the mapped roles tab 196 and the desktop tab 198, respectively, can be selected on the stakeholder data entry screen 136 to display fields 200 of information related to the stakeholder's business role (e.g., purchase order maintainer or shop cart approver), and fields 202 for the entry of stakeholder desktop information, for example, the stakeholder's domain ID 204 and whether the stakeholder is a PC or MAC user 206. Referring to FIG. 15, the change leadership submenu also includes a stakeholder groups screen 208, which includes fields 210 used to associate groups of stakeholders with the functional areas of the organization that the groups support.

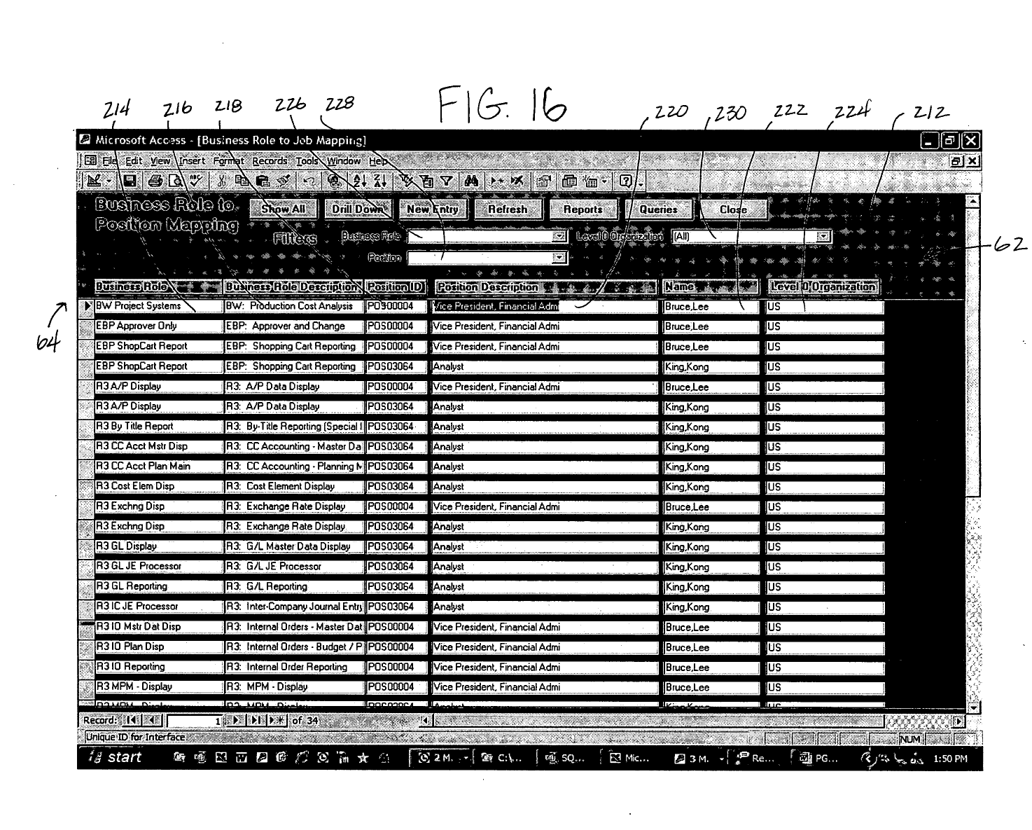

FIG. 16 is a printout of a business roles to position mapping screen 212, which is a screen 30 under the change leadership submenu that includes stakeholder information. The business roles to position mapping screen includes fields 64 for display of the stakeholder's business role 214, business role description 216, position identifier number (“position ID”) 218, position description 220, stakeholder's name 222, and organization name 224. A user that accesses the business role to position mapping screen can quickly identify the stakeholder associated with a particular business role, position, or organization by using the filters 62 at the top-center of the screen. The filters on the business role to position mapping screen include fields for the business role 226, position 228, and organization name 230.

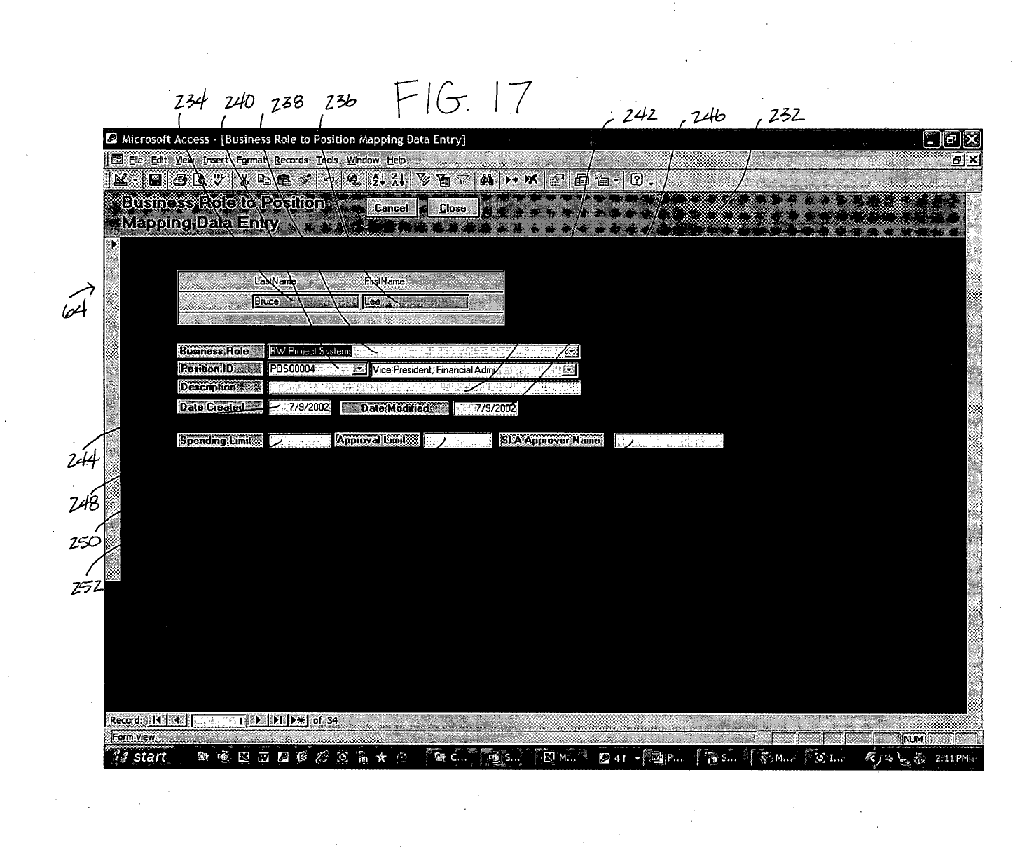

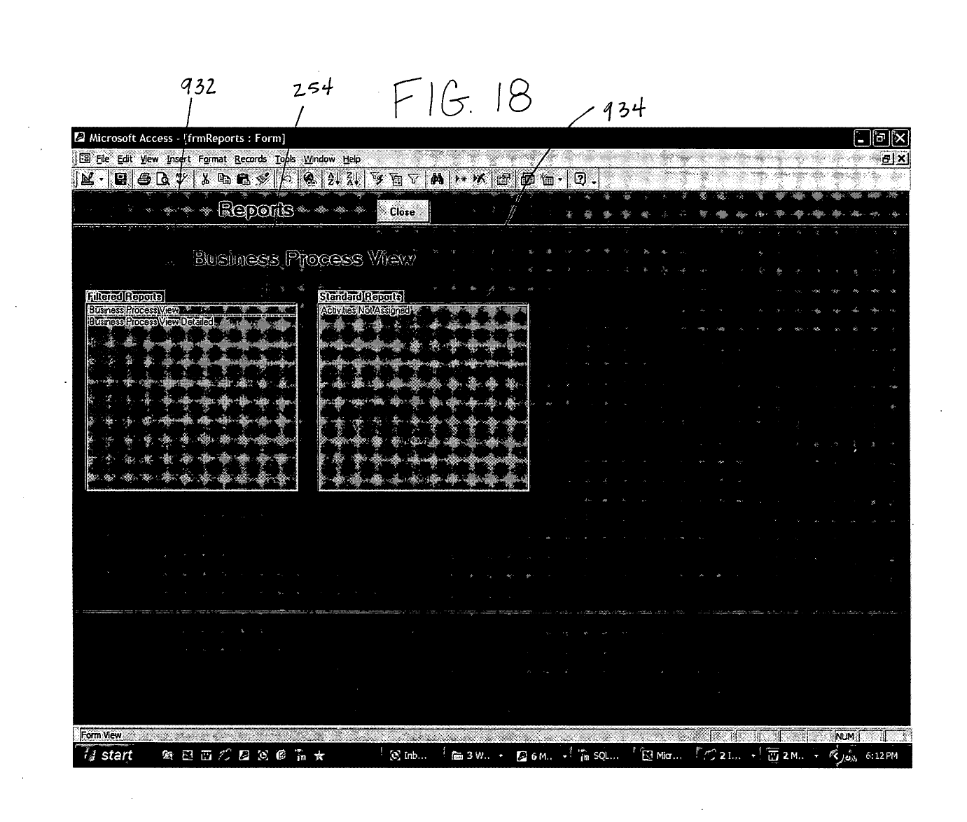

Referring to FIG. 17, a business role to position mapping data entry screen 232 is the screen 30 where a stakeholder is assigned or mapped to a business role. The business role to position mapping data entry screen includes fields 64 for the entry of the stakeholder's last name 234, first name 236, business role 238, position ID 240, and position description 242. Also, the business role to position mapping data entry screen includes fields for the entry of the date the position was created 244, and the date when the position was modified 246. Furthermore, the business role to position mapping data entry screen includes fields that display the spending limit 248 and the approval limit 250 (e.g., in dollars), and the name of the stakeholder's spending limit approver 252 (“SLA Approver”). Referring to FIG. 18, the names of various reports 254 are listed that can be created based on the business role to position mapping data.

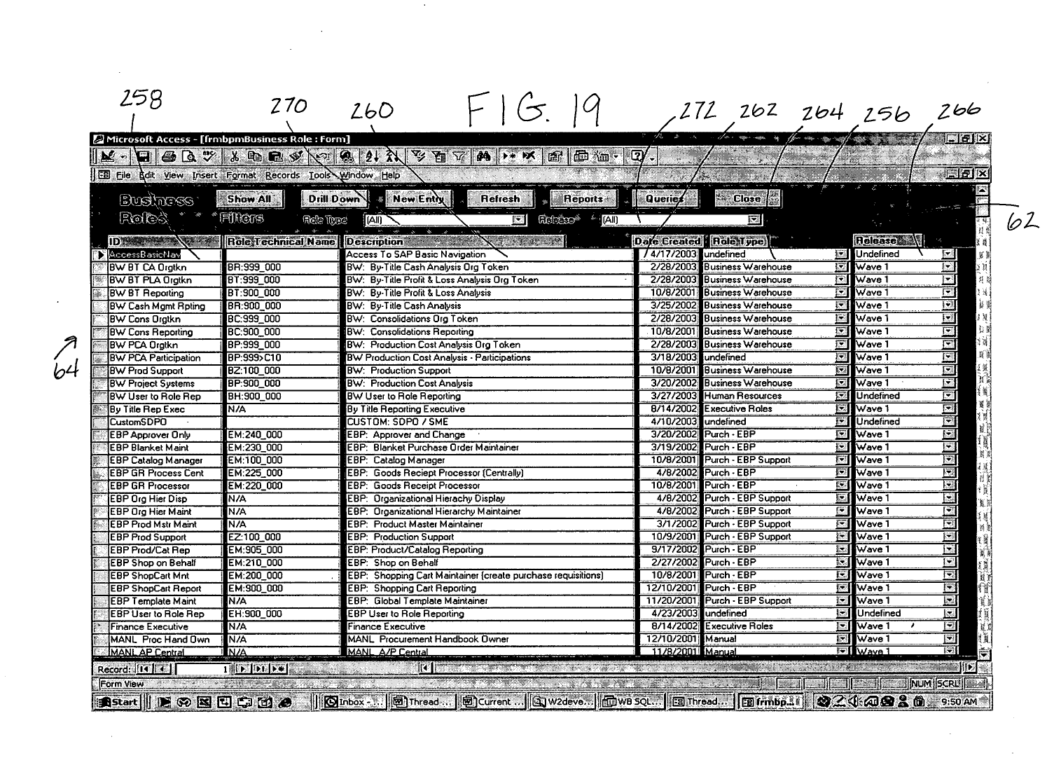

Referring to FIG. 19, the change leadership submenu also includes the business roles screen 256 which includes fields 64 for the display of business role-related data, for example, the business role ID 258, description 260, date created 262, role type 264, and release 266. The release is the name associated with a particular version of the program. The business roles screen also includes filters 62 having fields, which allow the user to sort the business role data by the business role type 270 and release 272.

The Information Technology Submenu

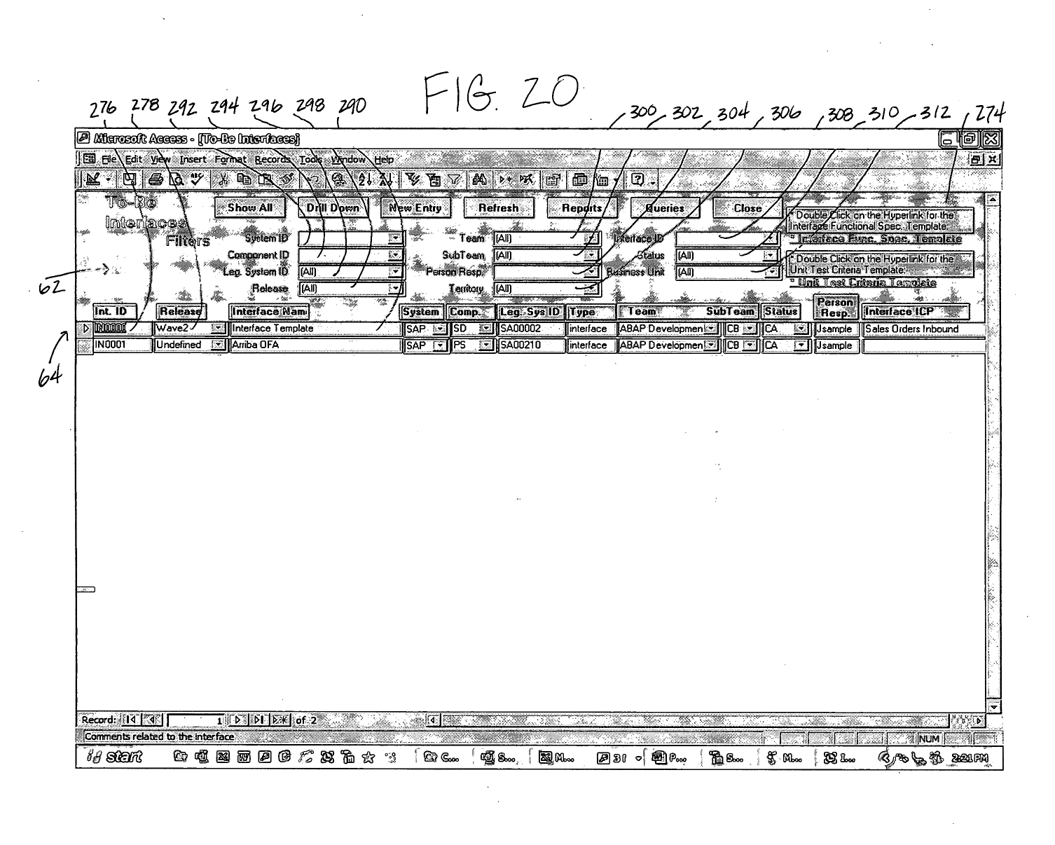

The information technology submenu includes screens 30 that display an inventory of the project's system components (see FIG. 1), e.g., servers 10, workstations 12, and printers (not shown). Referring to FIG. 20, the information technology submenu includes a to-be interfaces screen 274, which displays detailed information about all of the interfaces. The interfaces include any manual or automated systems or processes created for the project that provide for data exchange within the system. The to-be interfaces screen includes fields 64 for the display of information related to the future interfaces, for example, the interface ID 276, release 278, and interface name 280. The to-be interfaces screen also includes filters 62 having fields that allow for data sorting by, for example, the system ID 292, component ID 294, legacy system ID 296, release 298, team 300, sub team 302, person responsible 304, territory 306, interface ID 308, status 310, and business unit 312. A legacy system is an existing system or prior system. The territory can be a specific country or geographic region. The filters allow for the sorting and the generation of filtered reports (not shown) of the details about the interfaces, design specification, and other supportive information that defines the interfaces.

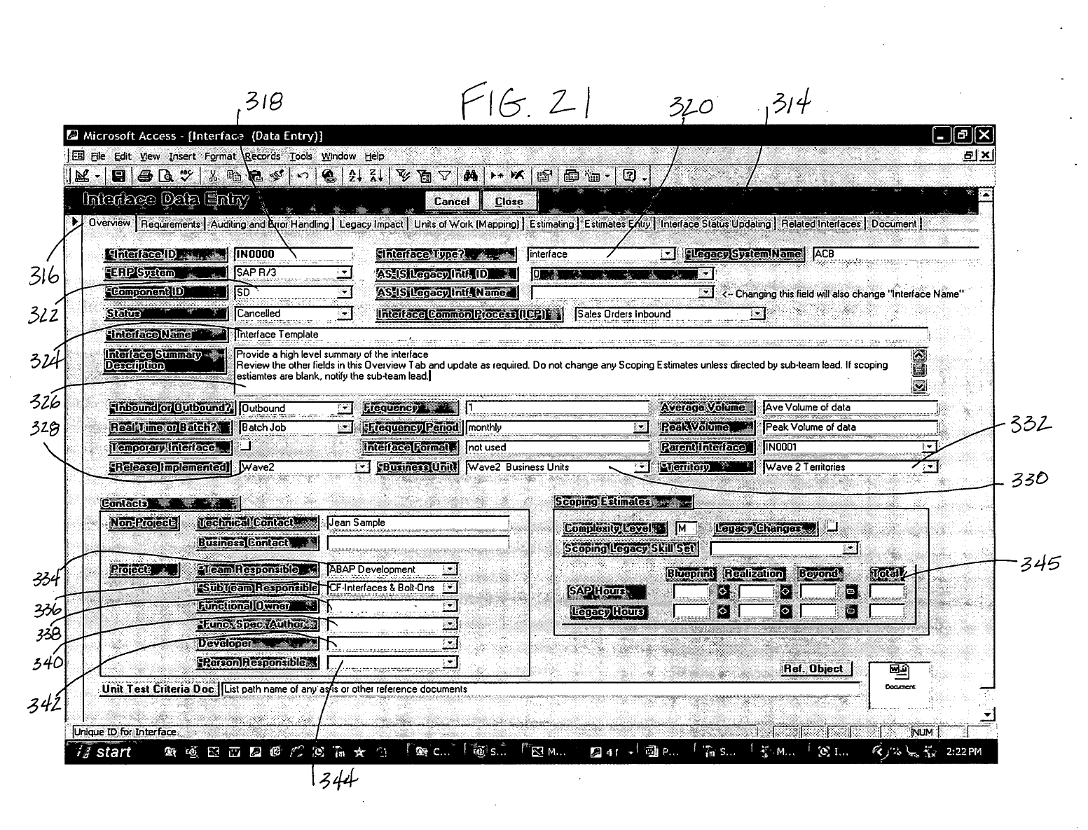

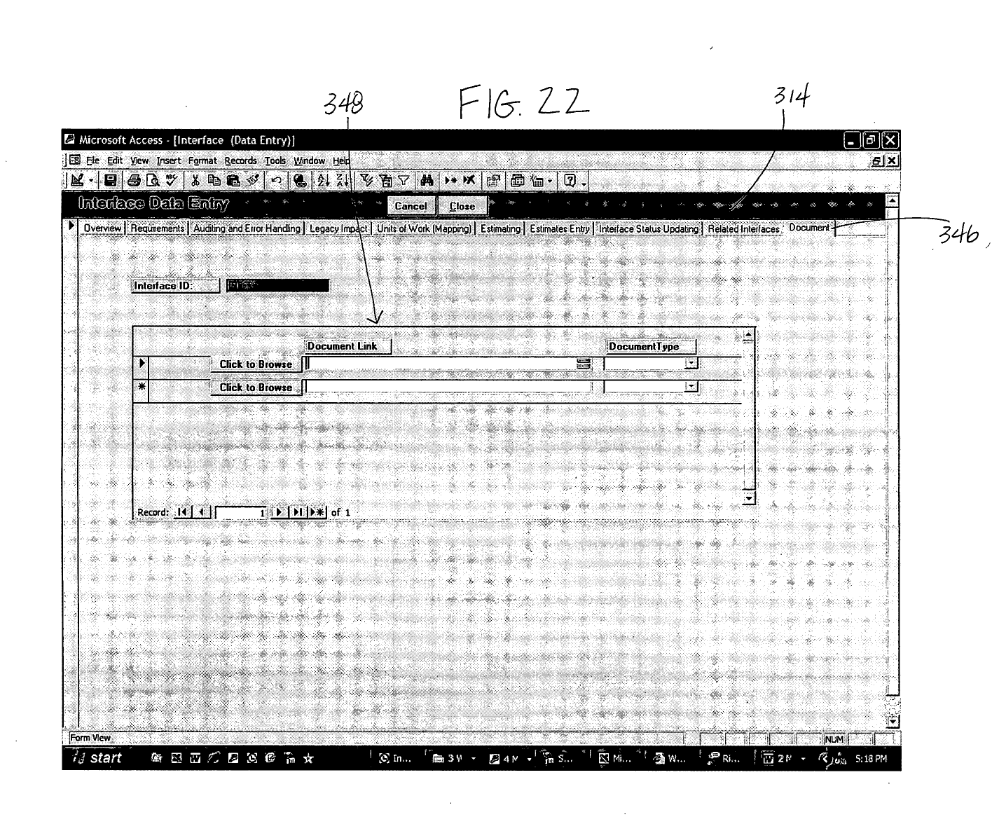

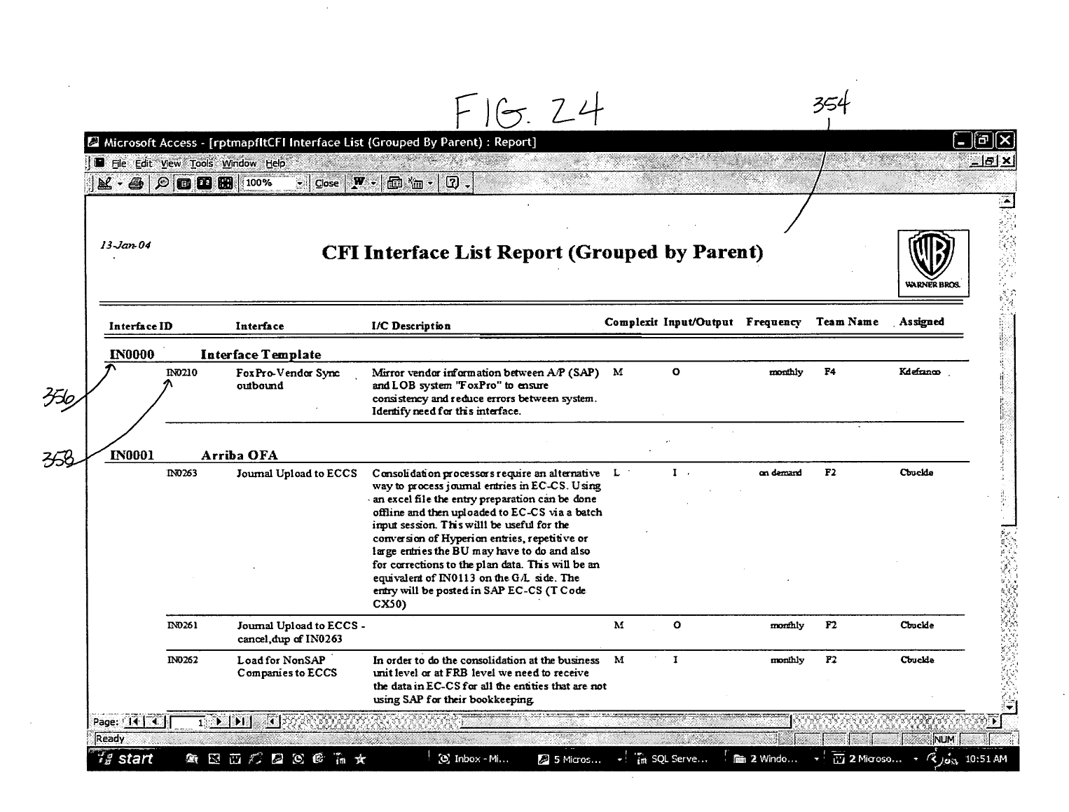

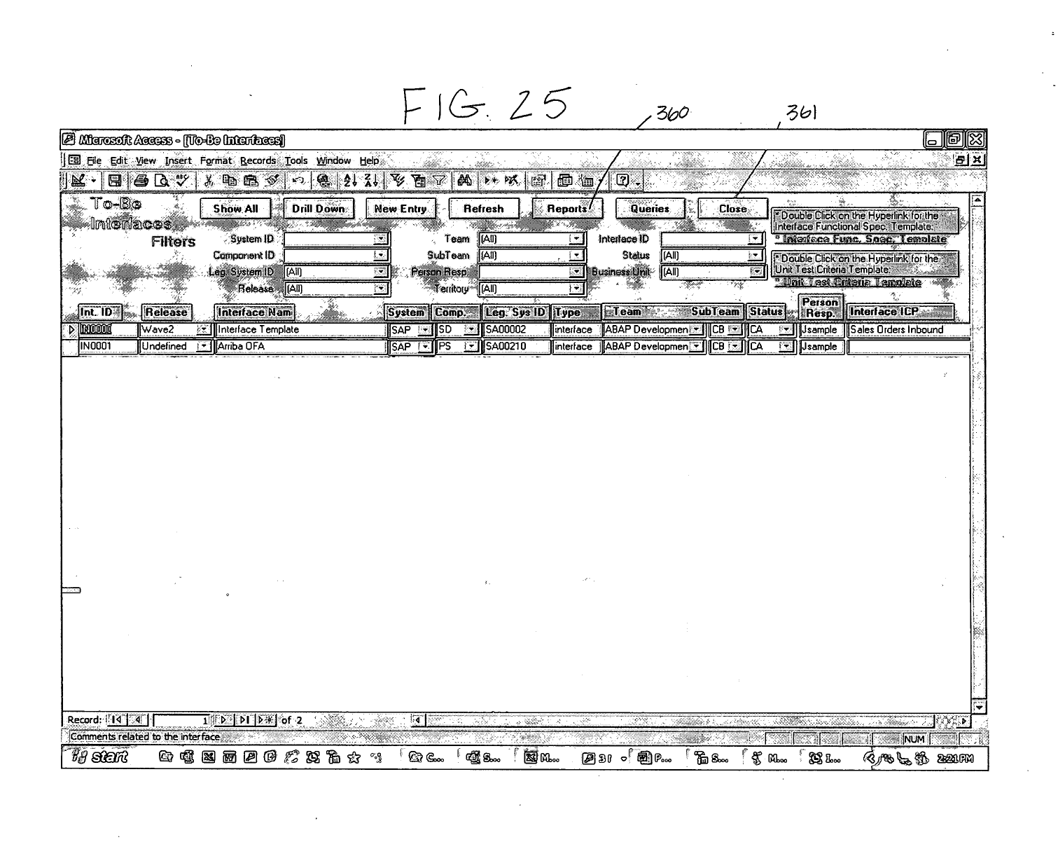

Referring to FIG. 21, an interface data entry screen 314, also included under the information technology submenu, is used for the entry of information about an interface. When the overview tab 316 is selected, the interface data entry screen includes fields 64 for the entry of interface-related information, for example, the interface ID 318, interface type 320, status 322, interface name 324, interface summary description 326, release implemented 328, business unit 330, and territory 332. The interface data entry screen also includes fields for the entry of the project responsible team 334, responsible sub team 336, functional owner 338, functional specification author 340, developer 342, and person responsible 344. Furthermore, the interface data entry screen also includes fields for the entry of scooping estimates 345, which document the estimated effort required to implement the interface and its complexity. Referring to FIG. 22, the interface data entry screen also includes a document tab 346, which, when selected, allows the user to view links 348 to supporting documentation (not shown). The interface data entry screen also includes a related interfaces tab 350, which, when selected, allows the user to view information related to dependencies 352 between the interfaces, e.g., interface A is related to interface B. Regarding the relationship between interfaces, FIG. 24 is a printout of an example report screen 354, which displays the relationship between the parent and child interfaces, with a parent interface ID 356 positioned above its related child interface IDs 358. The report shown in FIG. 24 is available by clicking on the reports button 360 in an interface browse form screen 361 of FIG. 25.

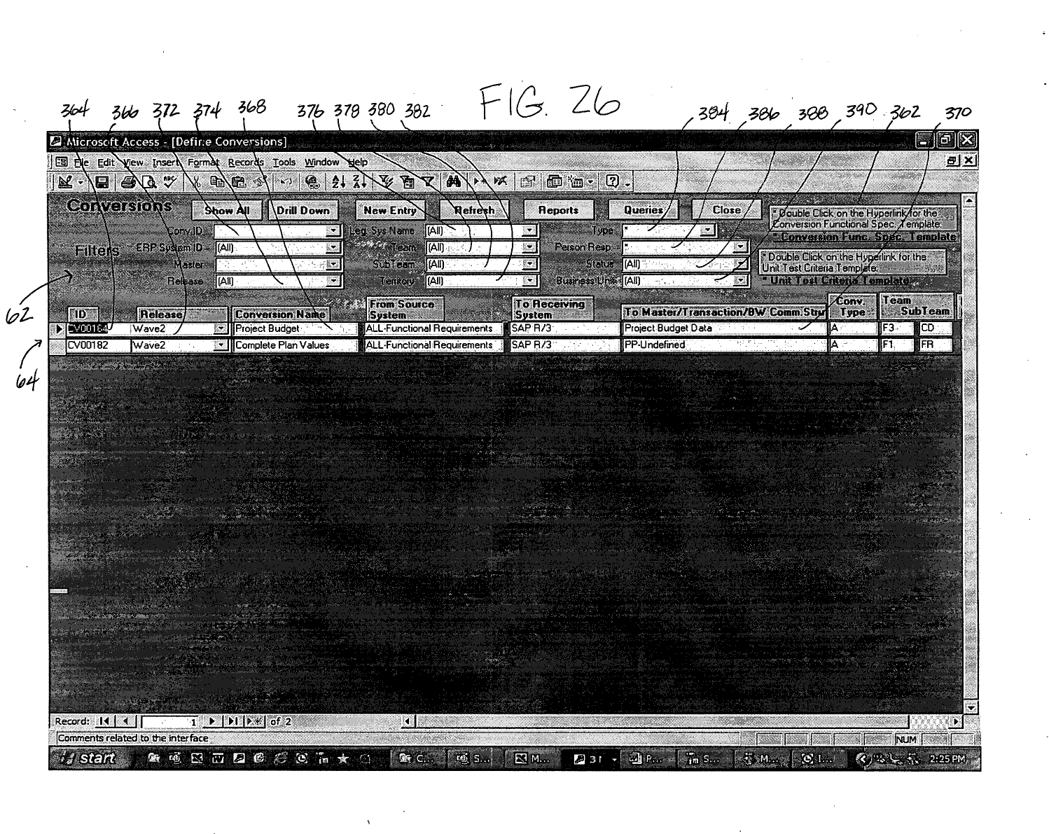

Referring to FIG. 26, a conversions screen 362, also under the information technology submenu, includes fields 64 for the display of information related to future system changes and conversions, e.g., the process of moving information, programs, and data from a legacy system to a new system. The fields in the conversion screen include, for example, the conversion ID 364, release 366, conversion name 368, and conversion type 370. The conversions screen also includes filters 62, for example, the conversion ID 372, release 374, legacy system name 376, team 378, sub team 380, territory 382, type 384, person responsible 386, status 388, and business unit 390.

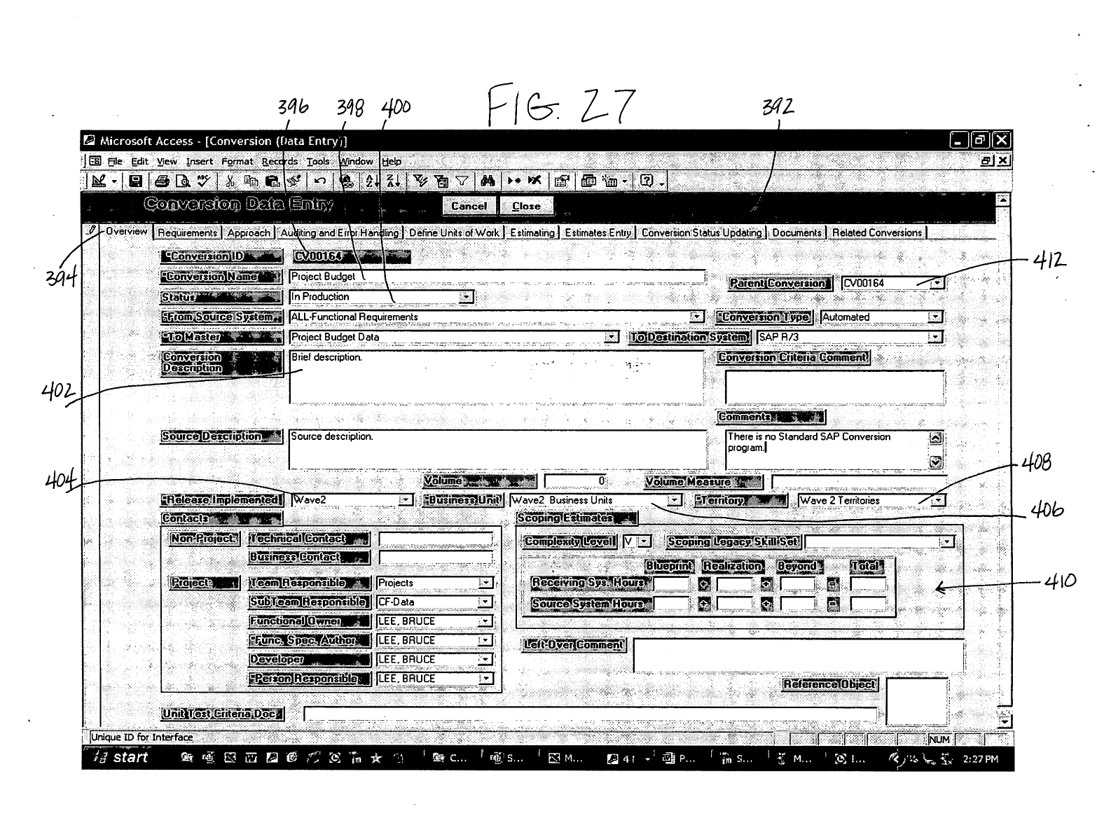

Referring to FIG. 27, a conversion data entry screen 392, when an overview tab 394 is selected, includes fields 64 for the viewing or entry of information related to each conversion, for example, the conversion ID 396, conversion name 398, status 400, conversion description 402, release 404, business unit 406, and territory 408. The conversion data entry screen also includes fields for the entry of scoping estimates 410. Furthermore, the conversion data entry screen includes a field 412 to indicate the conversion ID of the parent conversion, thus, the parent/child relationship between conversions can be entered by the user into the conversion data entry screen.

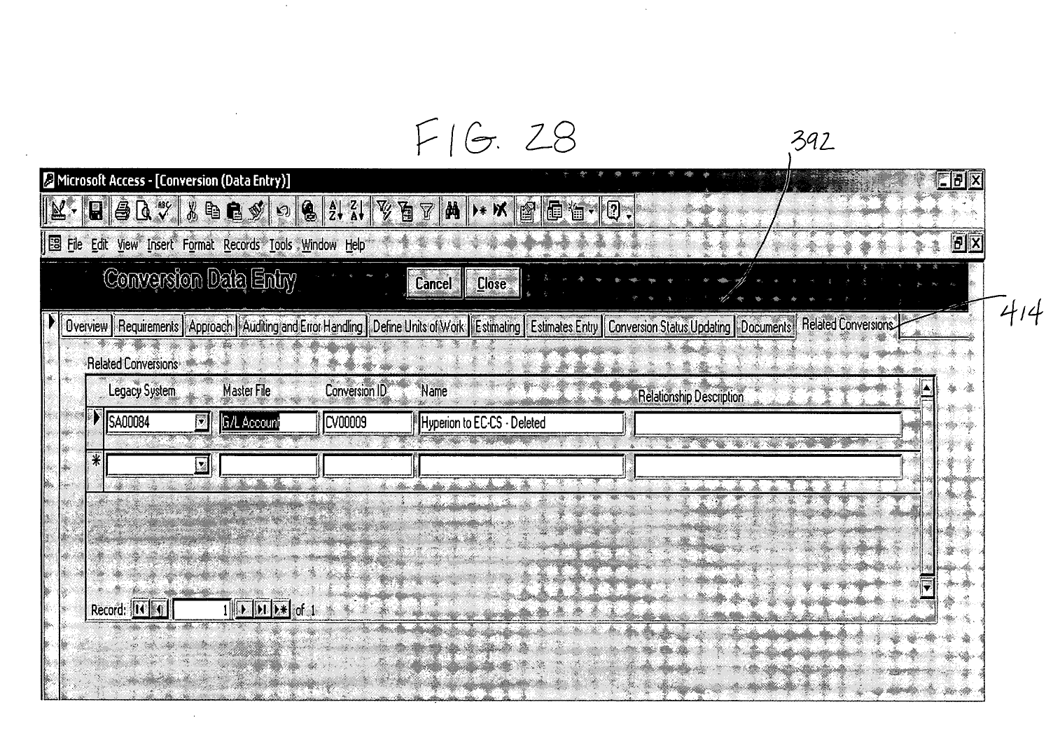

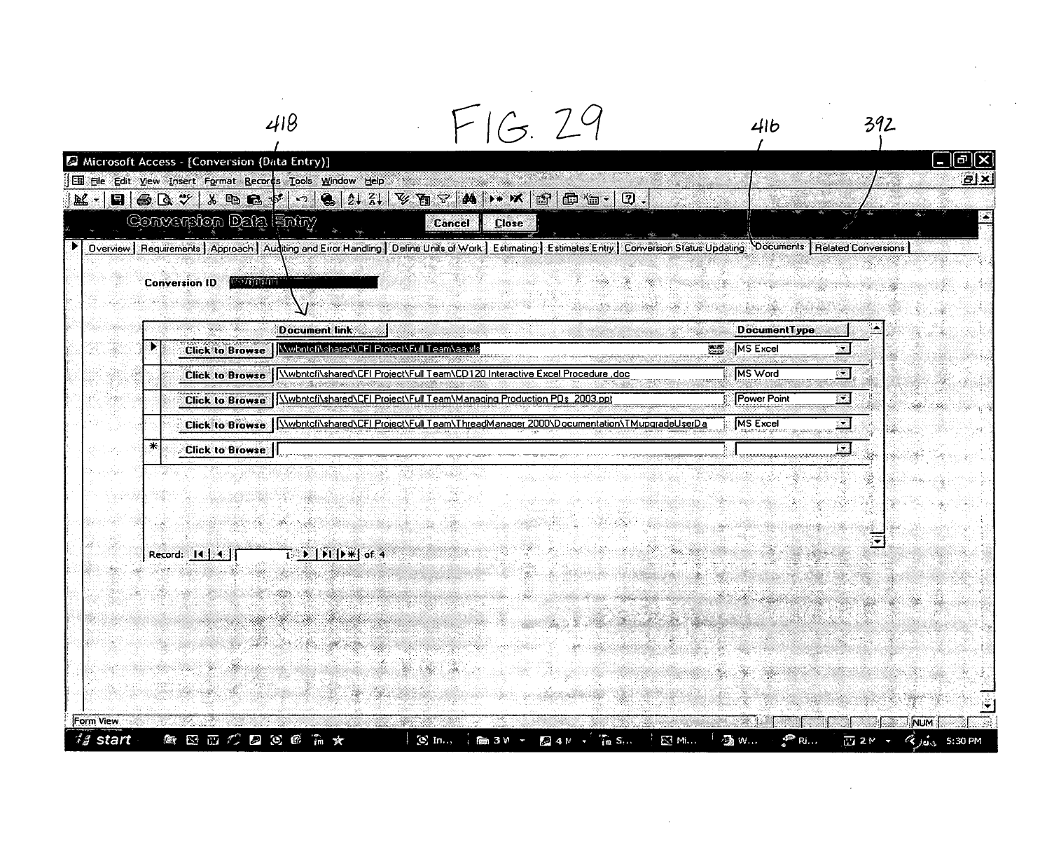

Referring to FIG. 28, when a related conversions tab 414 is selected on the conversion data entry screen 392, the dependencies between conversions are shown. Referring to FIG. 29, when a documents tab 416 is selected, the conversion data entry screen provides the user with links 418 to supporting documents (not shown), e.g., screen shots and design specifications.

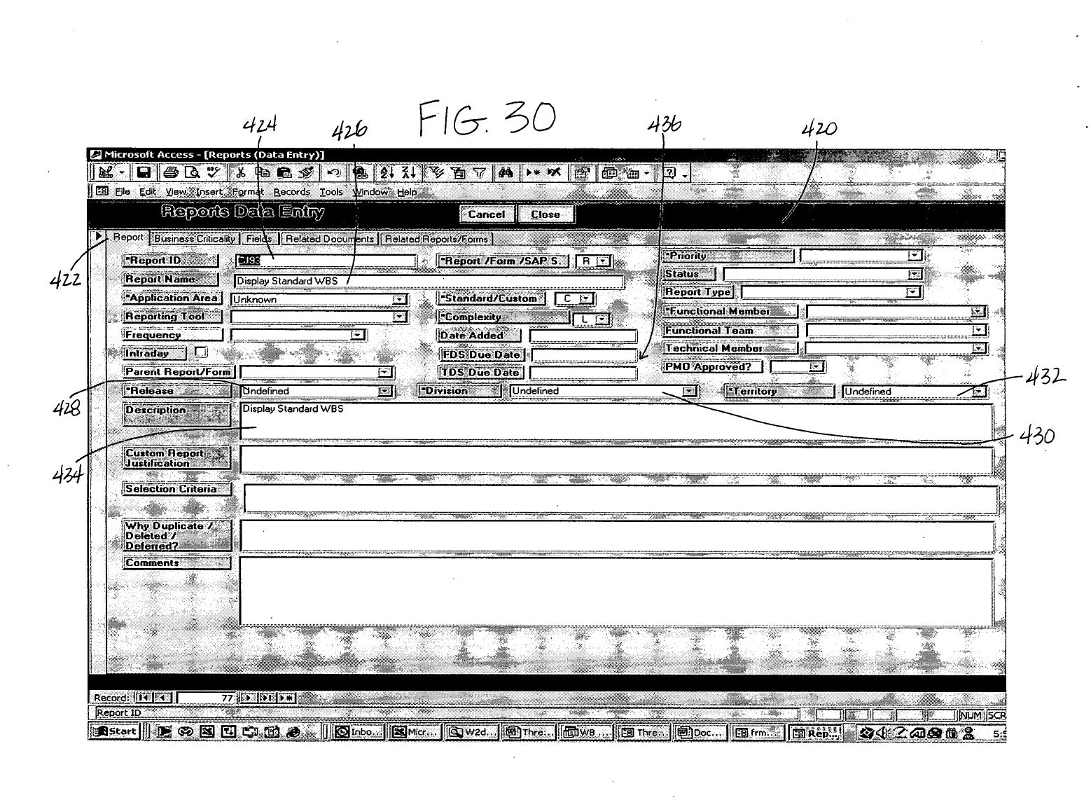

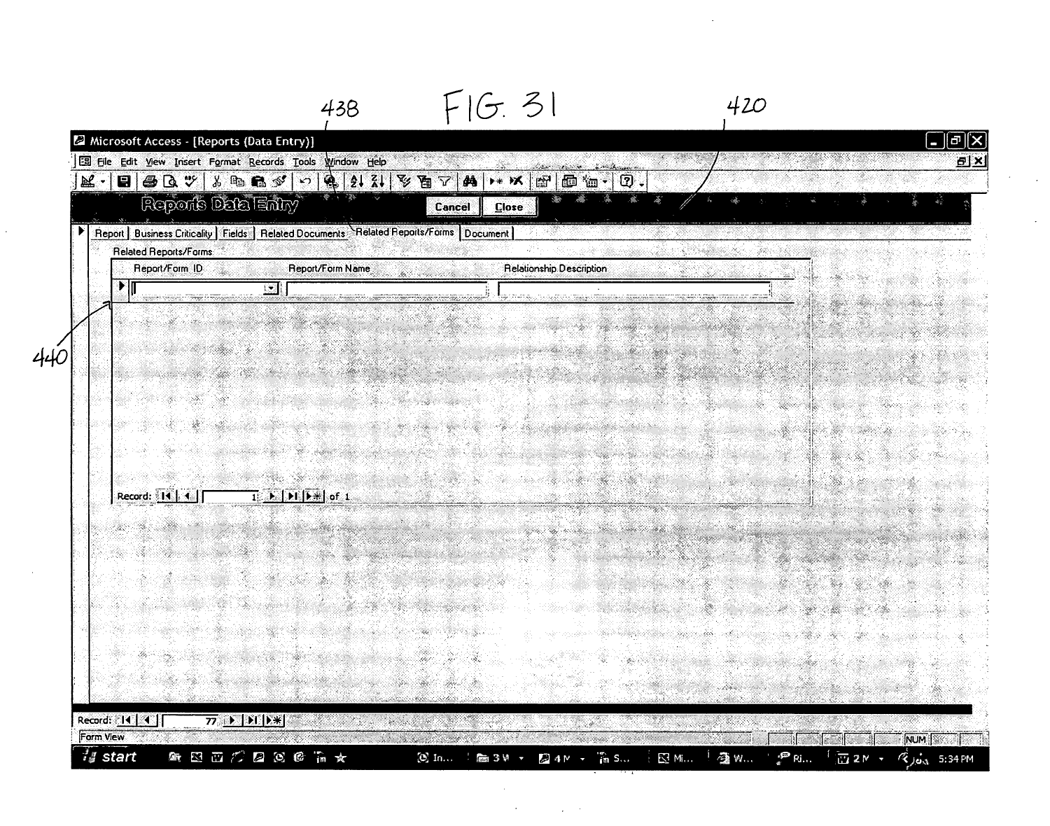

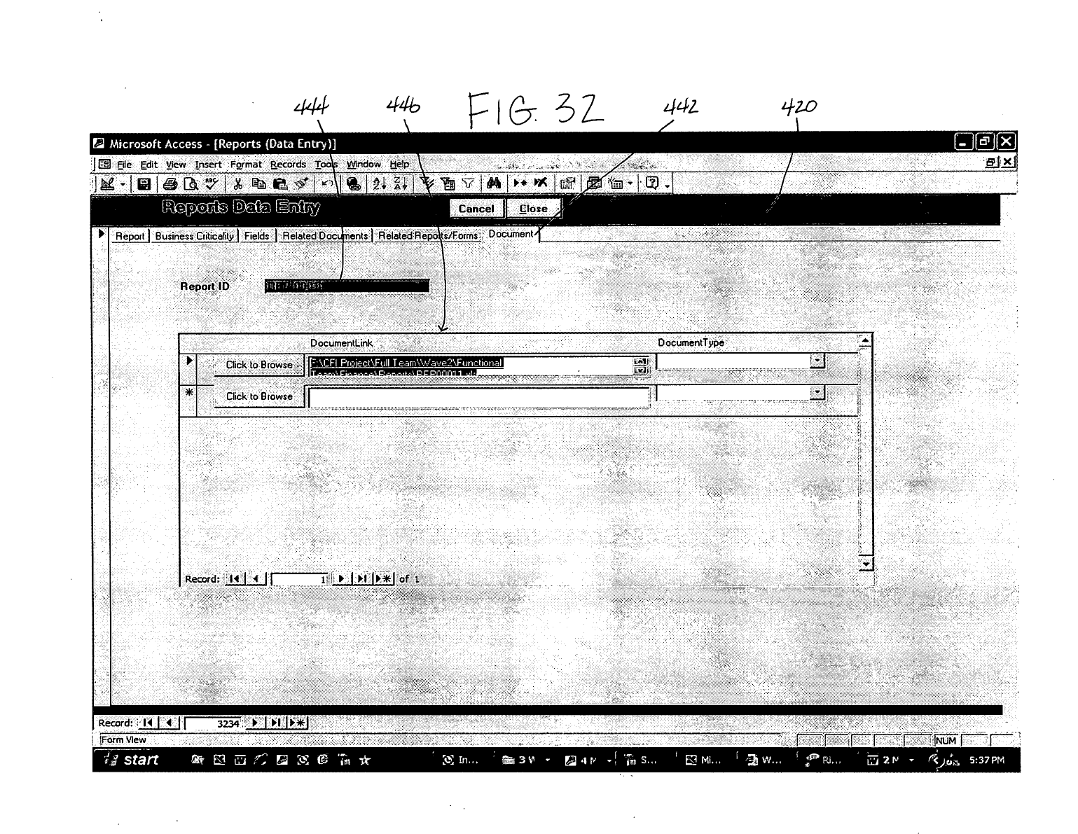

Referring to FIG. 30, the information technology submenu also includes a report data entry screen 420, which displays information relating to the design of a report (not shown). When a report tab 422 is selected, the report data entry screen includes fields 64 for the entry and display of the report ID 424, report name 426, release 428, division 430, territory 432, and description 434. Function design specification (“FDS”), which is a specification that can assist in the building of a report, and technical design specification (“TDS”), which is a specification that can assist in the building of a report, due date fields 436 also are included in the report data entry screen. Referring to FIG. 31, when a related reports/forms tab 438 is selected on the reports data entry screen, fields 440 are displayed for the entry of dependency information between the reports/forms. Referring additionally to FIG. 32, when a document tab 442 is selected on the reports data entry screen, fields are displayed for the viewing and entry of the report ID 444 and links 446 to supporting documentation, e.g., screen shots and design specifications (not shown).

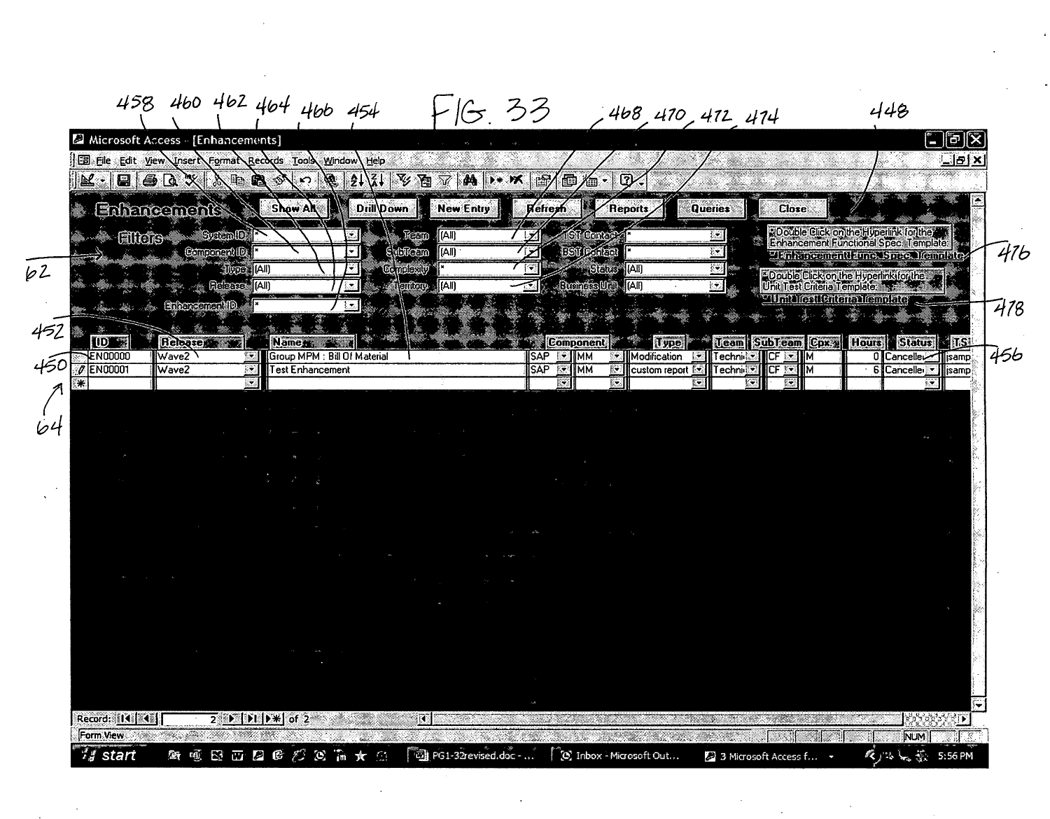

Referring to FIG. 33, the information technology submenu also includes an enhancements screen 448, which displays fields 64 including information related to the various enhancements made to the program, for example, the enhancement ID 450, release 452, name 454, and status 456. The enhancements screen also includes filters 62 having fields for the entry of, for example, the system ID 458, component ID 460, type 462, release 464, enhancement ID 466, team 468, sub team 470, complexity 472, and territory 474. In addition, two hyperlinks 476 and 478, are located at the top right of the enhancements screen. The hyperlinks allow the user to link to either a functional specification template (not shown), which is an additional specification document that can be attached, or a unit test criteria template (not shown), which allows for unit test information relating to the enhancement.

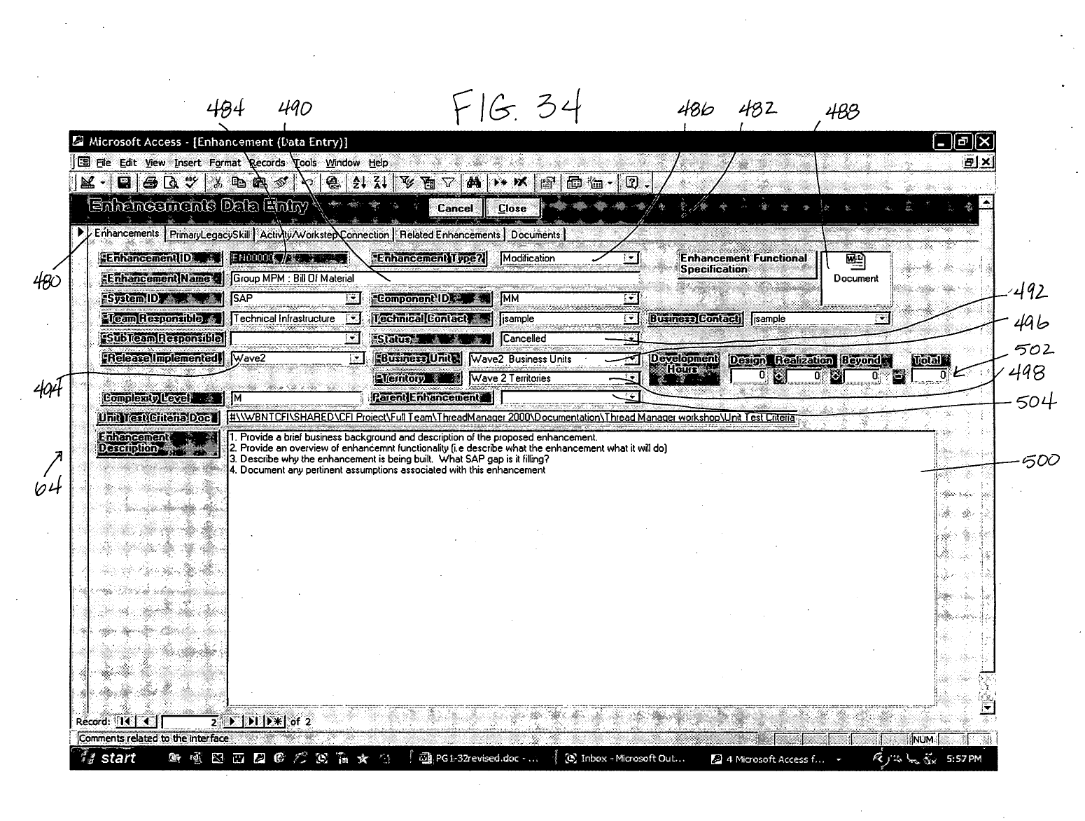

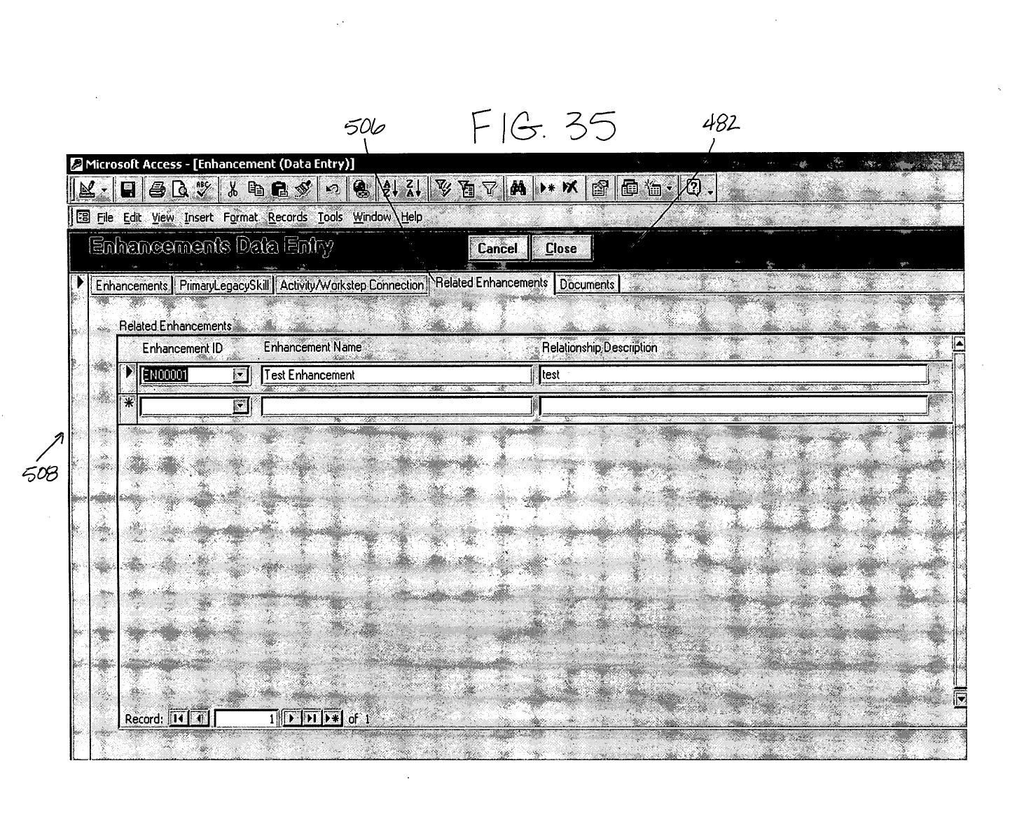

Referring to FIG. 34, when an enhancements tab 480 is selected on an enhancements data entry screen 482, fields 64 for the entry of the enhancement ID 484, enhancement type 486, enhancement function specification 488, enhancement name 490, status 492, release 494, business unit 496, territory 498, and enhancement description 500 are displayed. The enhancement data screen also includes fields for the entry of the development effort 502 (in hours) for the enhancement, and the enhancement ID of the parent enhancement 504. Referring additionally to FIG. 35, the enhancements data entry screen includes a related enhancements tab 506, which, when selected by the user, displays fields for the entry of information 508 related to the dependencies of the enhancements (the relationship of the enhancements to one another).

The Process and Package Submenu

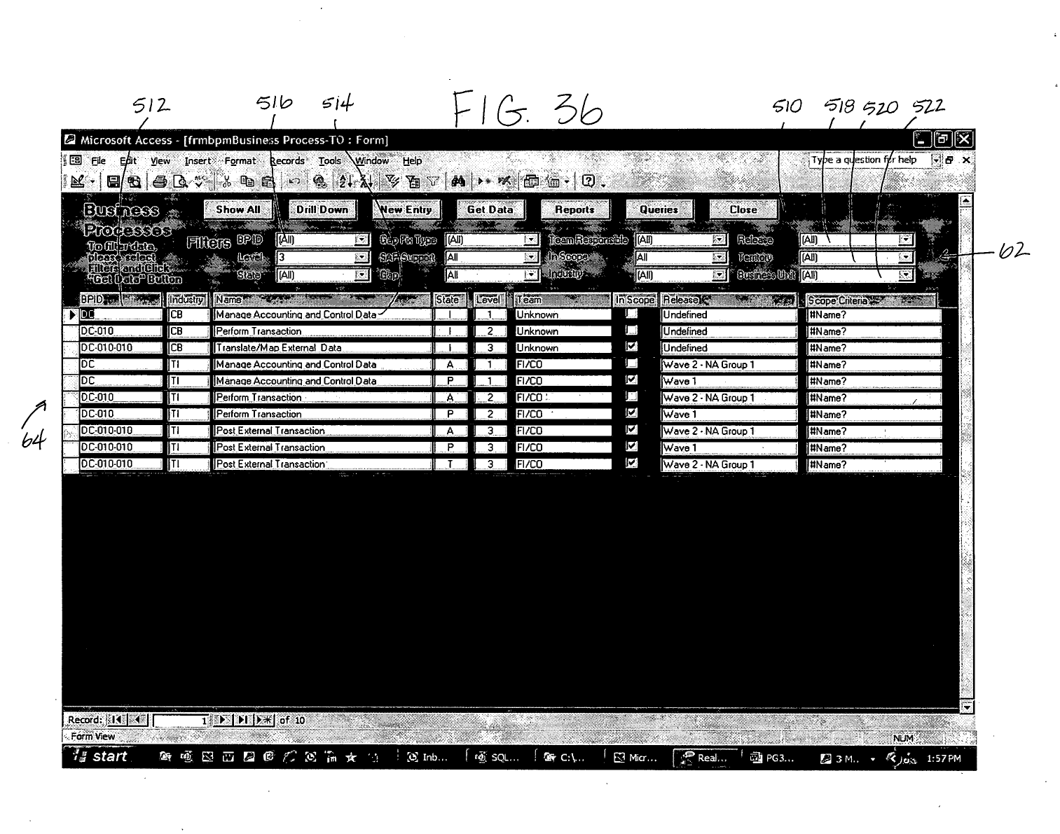

The process and package submenu includes business process information for a project, for example, information about business processes, sub-processes, activities, and work steps included in the project. In particular, the process and package submenu includes a business processes screen 510 (see FIG. 36), which includes fields 64 that display the business process ID (“BPID”) 512, business process name 514, and additional information for the processes, sub-processes, and activities included in the project. The business processes screen also includes filters 62 for use in filtering the process-related data based on information including, for example, the BPID 516, release 518, territory 520, and business unit 522.

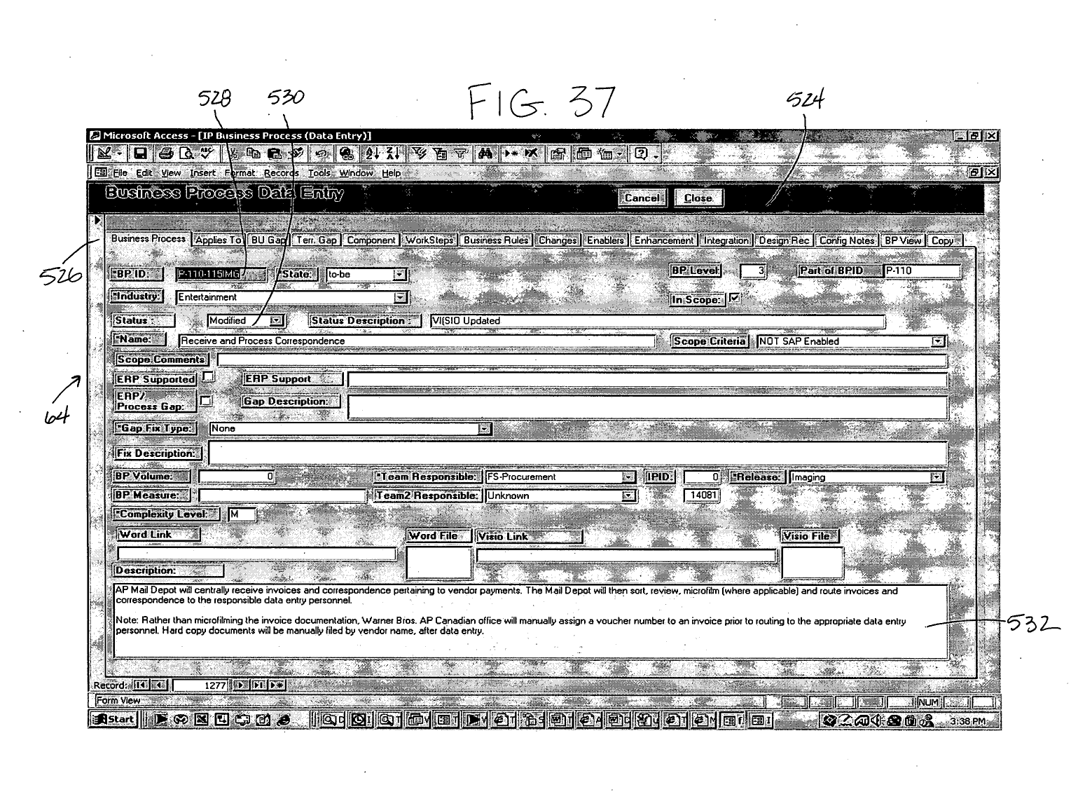

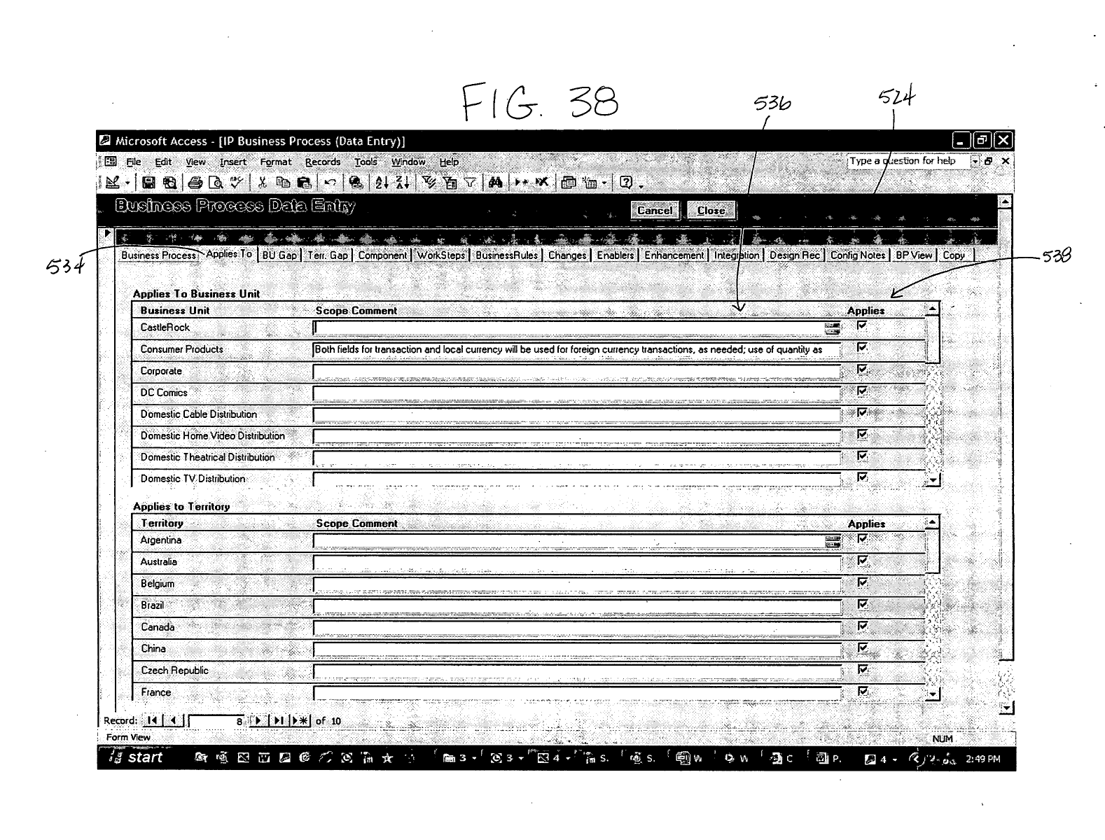

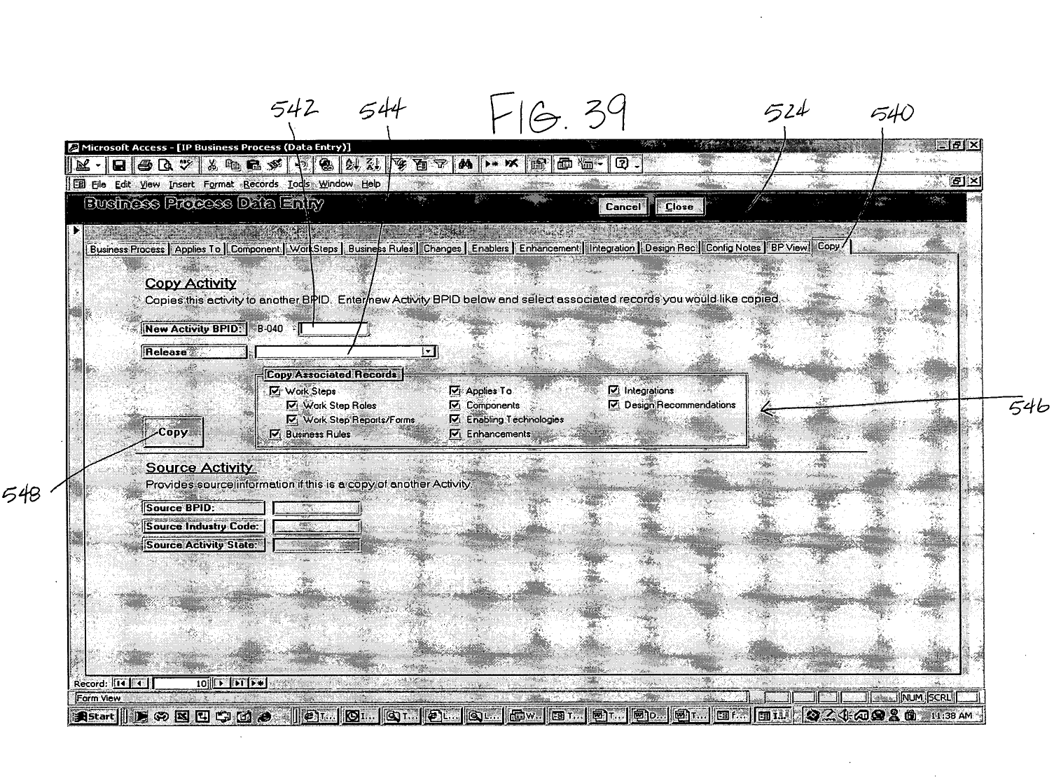

Referring to FIG. 37, the process and package submenu also includes a business process data entry screen 524, which includes a business process tab 526. When the business process tab is selected, the business process data entry screen includes fields 64 for the entry of process-related data, for example, the BP ID 528, status 530, and description 532. Referring additionally to FIG. 38, when the applies to tab 534 is selected on the business process data entry screen, fields 536 are displayed for the entry of comments as to the scope of the business process data, and check boxes 538 are displayed, which indicate to which business unit and territory the business process data applies. Referring additionally to FIG. 39, the business process data entry screen includes a copy tab 540, which, when selected by the user, allows the user the ability to copy all of the functionality of the business process data entry screen and the relevant data mapped to the activity, as part of the process for creating a new business process data entry. The user enters the new activity BPID and release in the corresponding fields 542 and 544, respectively, selects the appropriate check boxes 546, and then selects the copy button 548. Accordingly, this copy functionality increases the speed with which a user creates/adds business process data to the database.

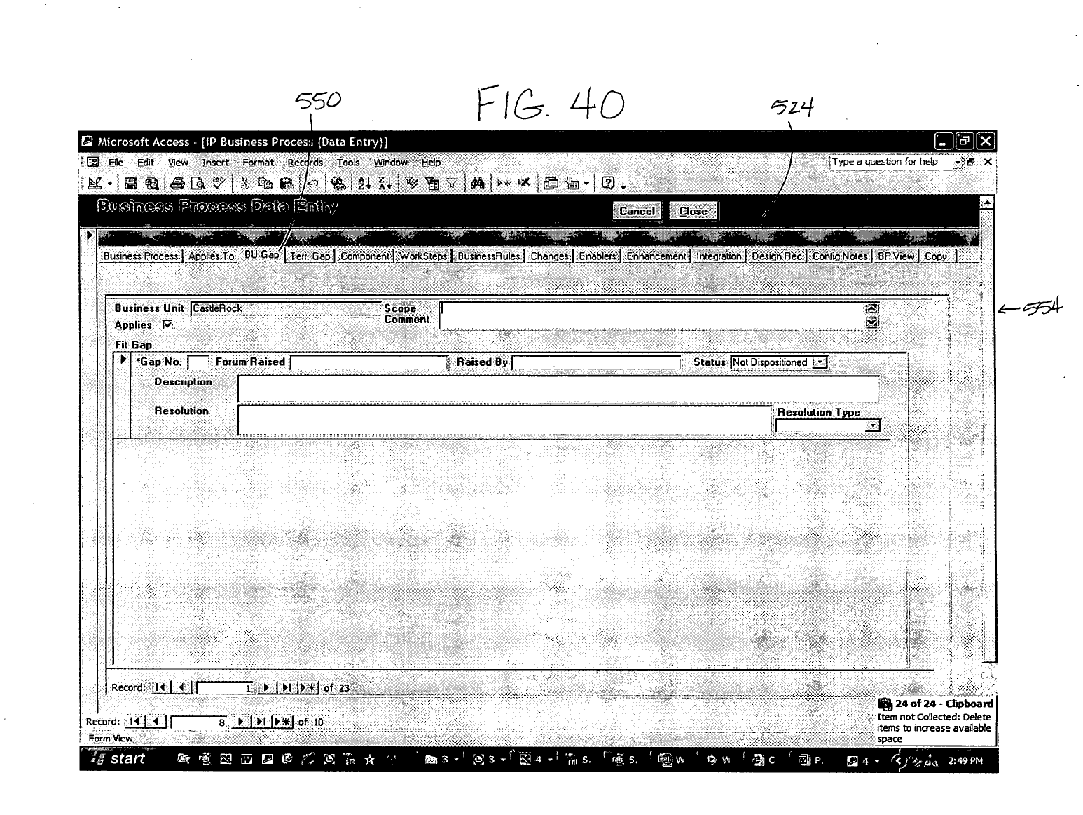

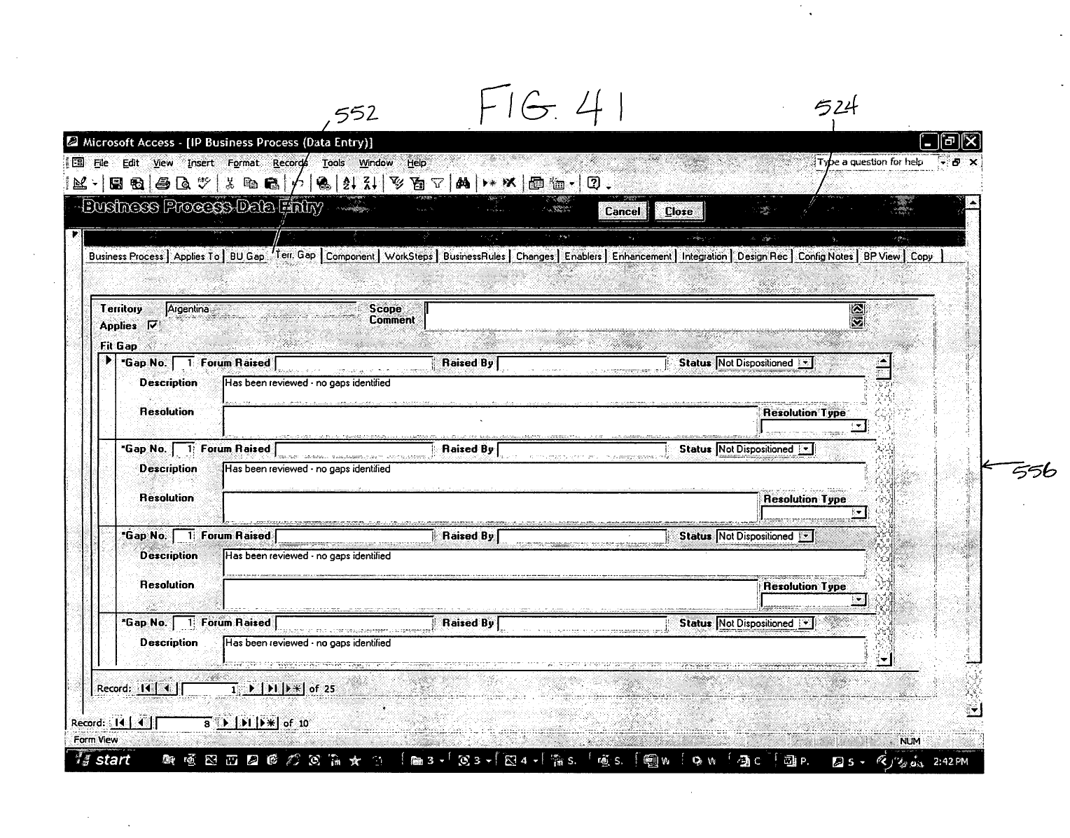

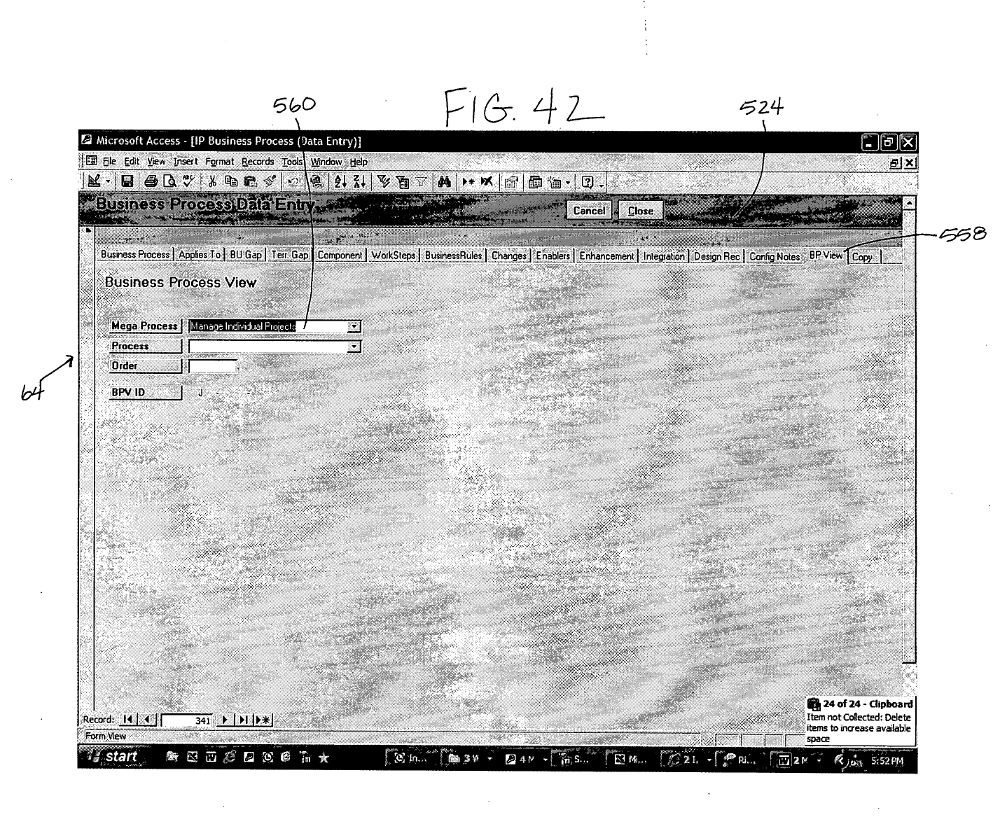

The business process data entry screen 524 also includes a business unit gap (“BU gap”) tab 550 (see FIG. 40) and a territory gap tab 552 (see FIG. 41), which, when selected, respectively allow the user to enter fit gap analysis data 554 and 556 for business unit and territory information. Fit gap analysis data includes items that were missed when the system was designed and implemented. As shown in FIG. 42, the business process data entry screen also includes a business process view (“BP view”) tab 558, which, when selected, displays fields 64 for the entry of the name of a mega-process 560, which includes one or more processes, and the process to which the mega-process belongs.

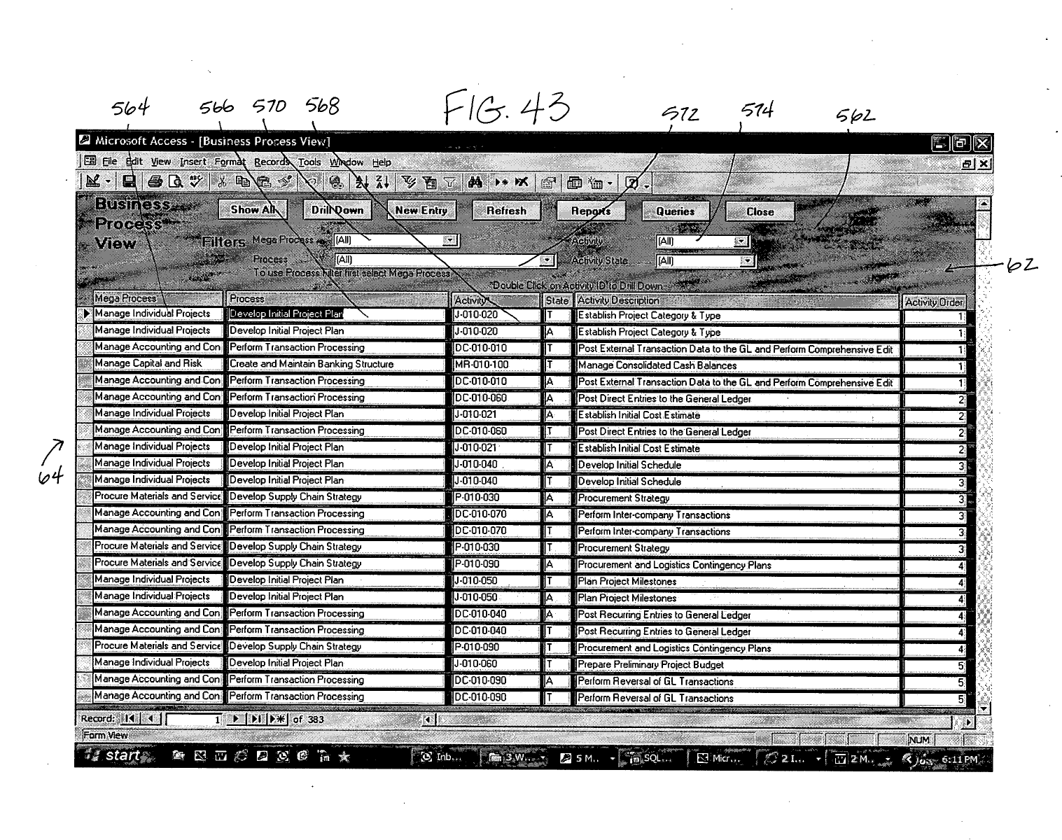

Referring to FIG. 43, the details of each mega-process are displayed in a business process view screen 562, which includes fields 64 for the name of the mega-process 564, process 566, and activity 568. Thus, the business process view screen provides a hierarchical view of the processes and activities that make up a project. The business process view screen also includes filters 62 for sorting the business process data based on, for example, the name of the megaprocess 570, process 572, and activity 574.

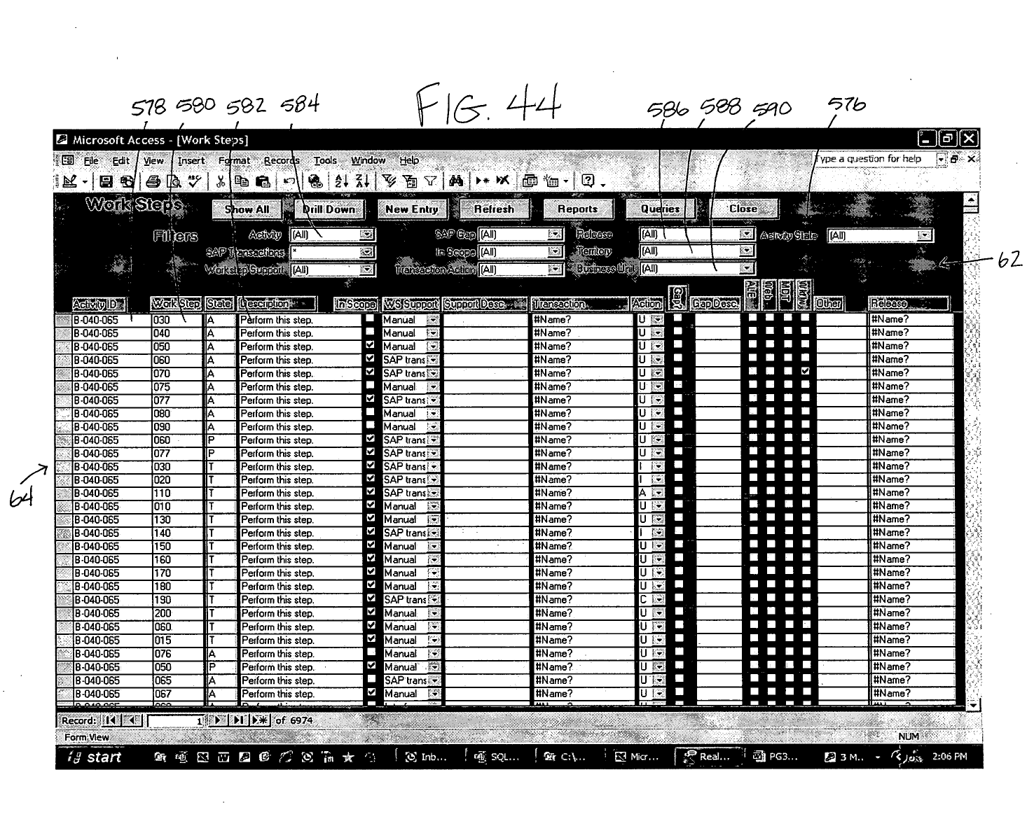

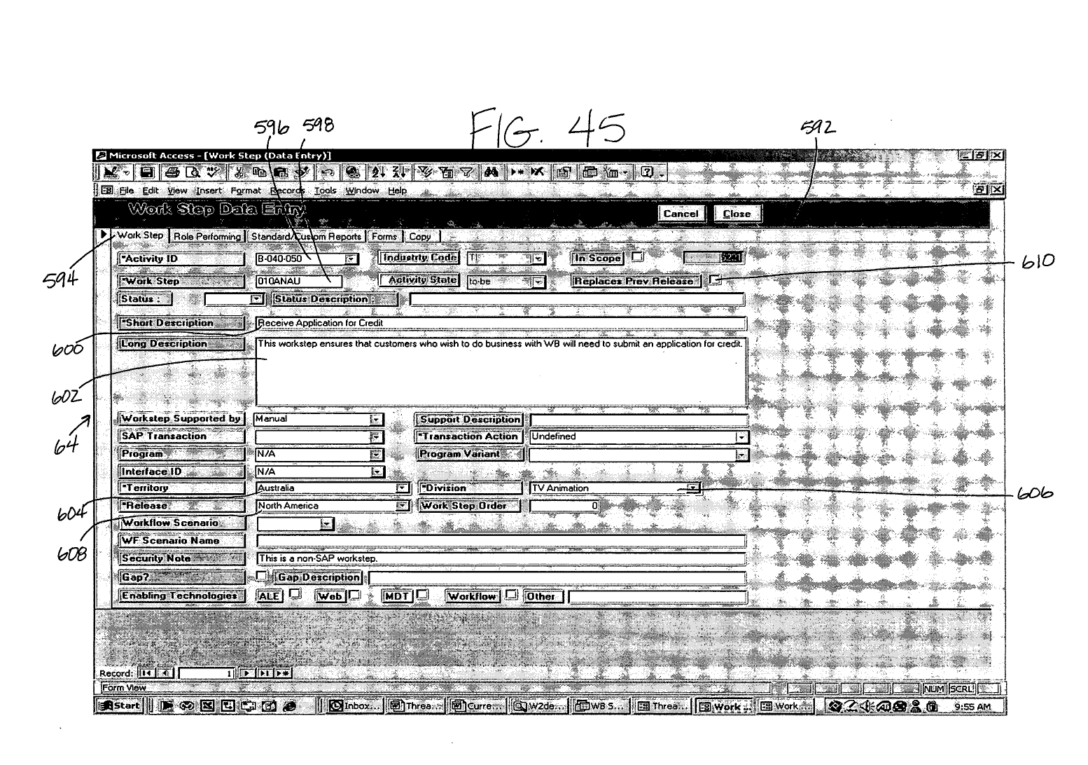

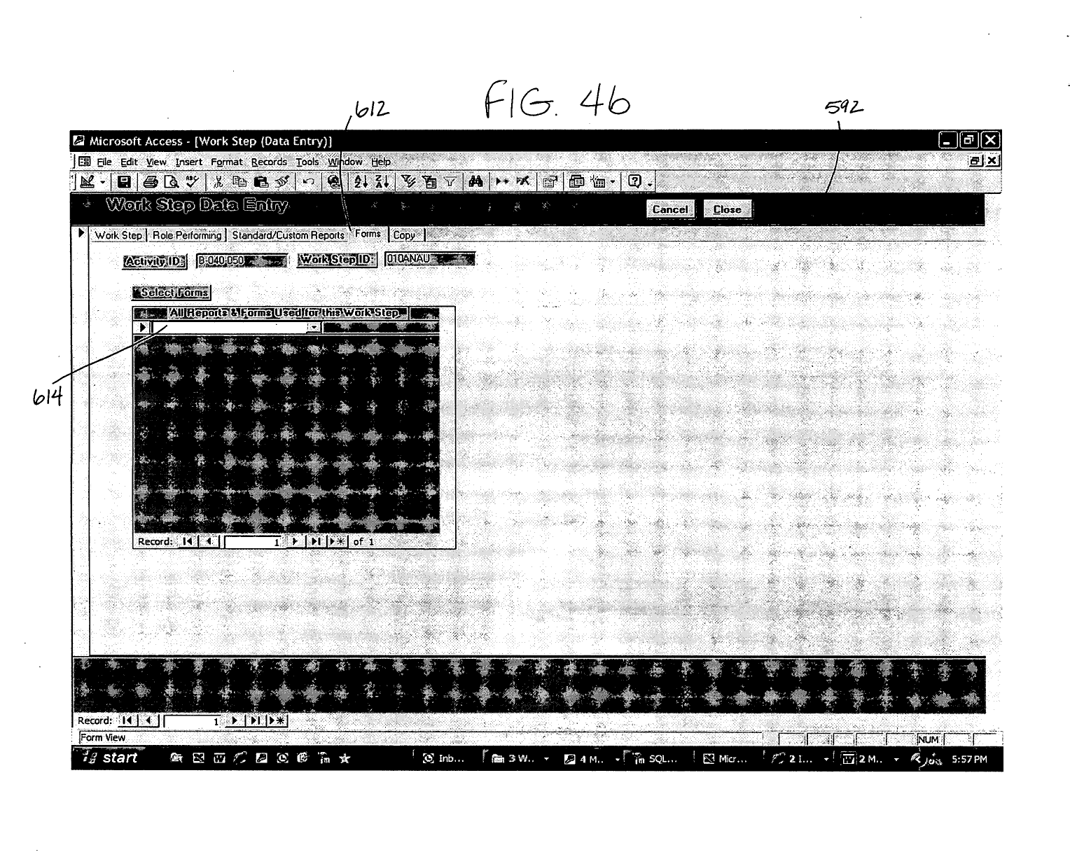

Referring to FIG. 44, the process and package submenu also includes a work steps screen 576, which includes fields 64 that display information related to each work step of a process. For example, the work steps screen includes fields for the activity ID 578, work step number 580, and work step description 582. The work steps screen also includes filters 62, for example, the name of the activity 584, release 586, territory 588, and business unit 590 associated with each work step. The work steps screen has a related work step data entry screen 592 (see FIG. 45) which, when the work step tab 594 is selected, includes fields for the entry of, for example, the activity ID 596, work step ID 598, short description of the work step 600, long description of the work step 602, territory 604, division 606, and release 608 for the work step. The work steps screen also includes a check box field 610 used to indicate whether the current work step replaces a work step previously stored in the database. Referring additionally to FIG. 46, the work step data entry screen includes a forms tab 612, which, when selected, allows the user to map a report (not shown) to a work step by selecting it from a drop down field 614.

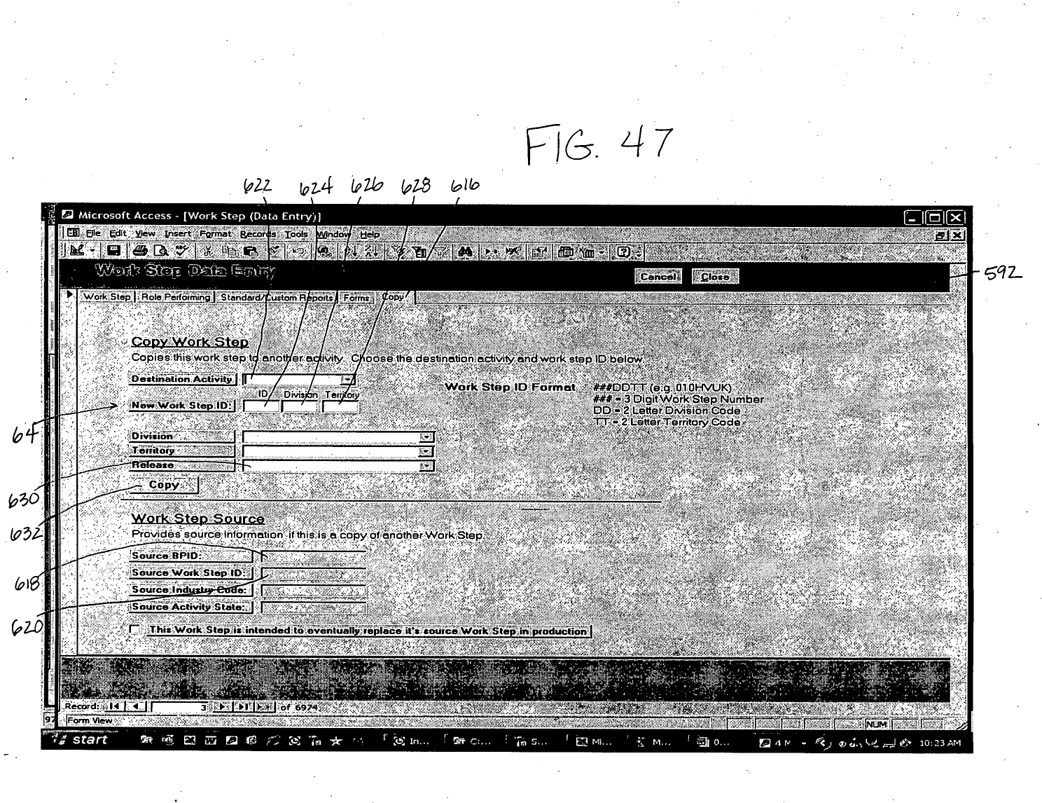

Referring additionally to FIG. 47, the work step data entry screen 592 includes a copy tab 616, which, when selected, allows the user to copy all relevant functionality and data for a particular work step for use in creating a new work step. The screen includes fields 64 for the source business process ID 618 and the source work step ID 620 of the work step that is to be copied. Next, the work step data entry screen includes fields for the entry of the destination activity 622, new work step ID 624, division 626, territory 628, and release 630 information. Finally, the user selects the copy button 632, and the program takes the old work step ID and replaces it with the new work step ID. Thus, by using the copy functionality, a user more efficiently can create new work steps based on an existing work step.

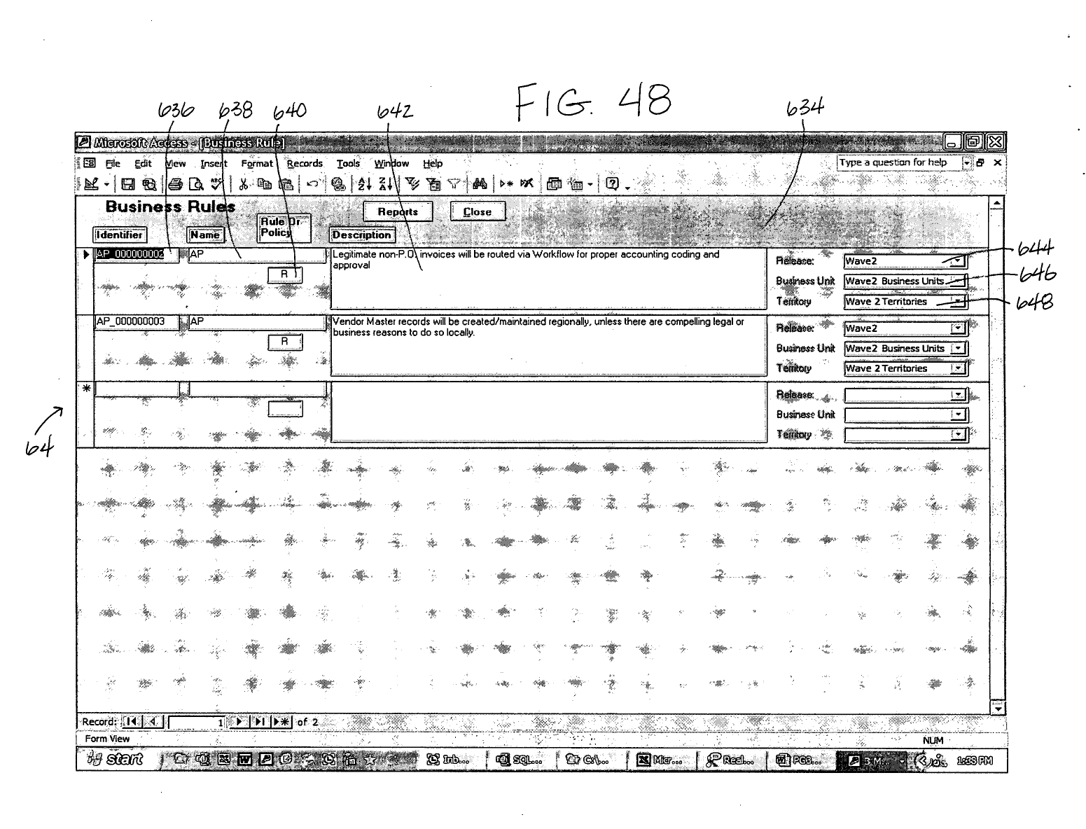

Referring additionally to FIG. 48, a business rules screen 634, which is under the process and package submenu, includes data related to various business rules and policies to be followed by project members. The business rules screen includes fields 64 for the display of the business rule identifier 636, name of a functional area 638, whether it is business rule or a policy 640, and a description of the rule 642. The business rules screen also includes fields for the display of the project release 644, business unit 646, and territory 648 information for each business rule or policy.

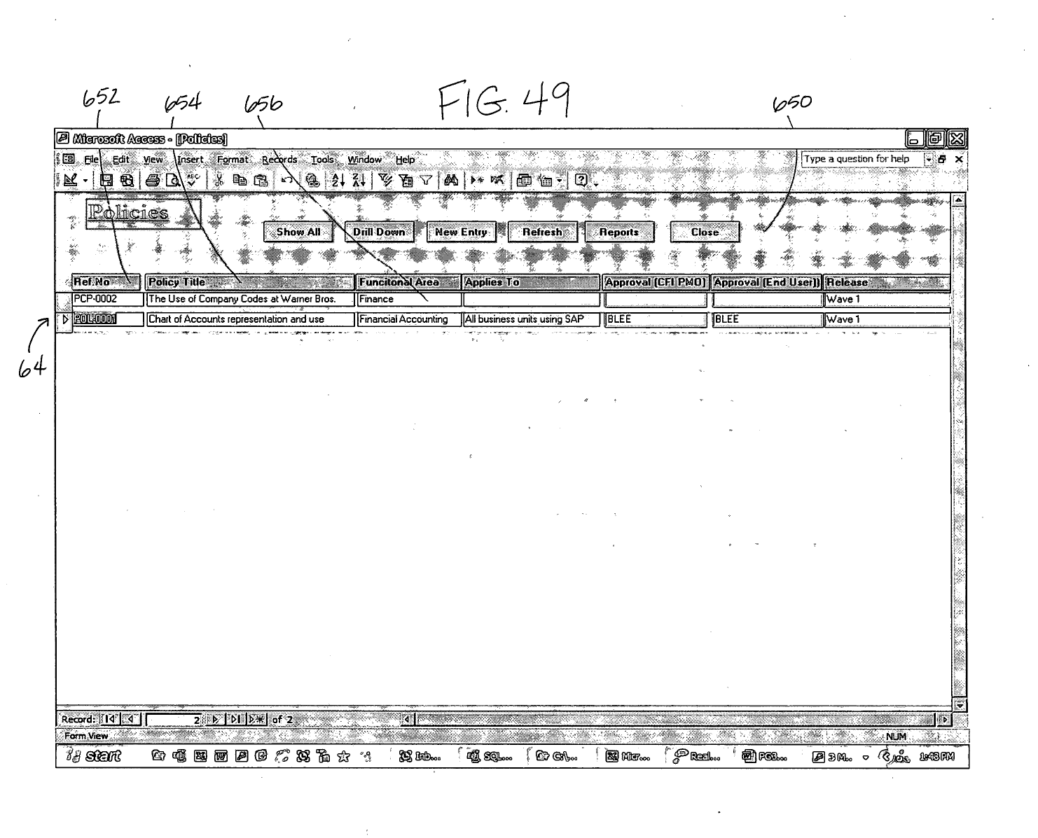

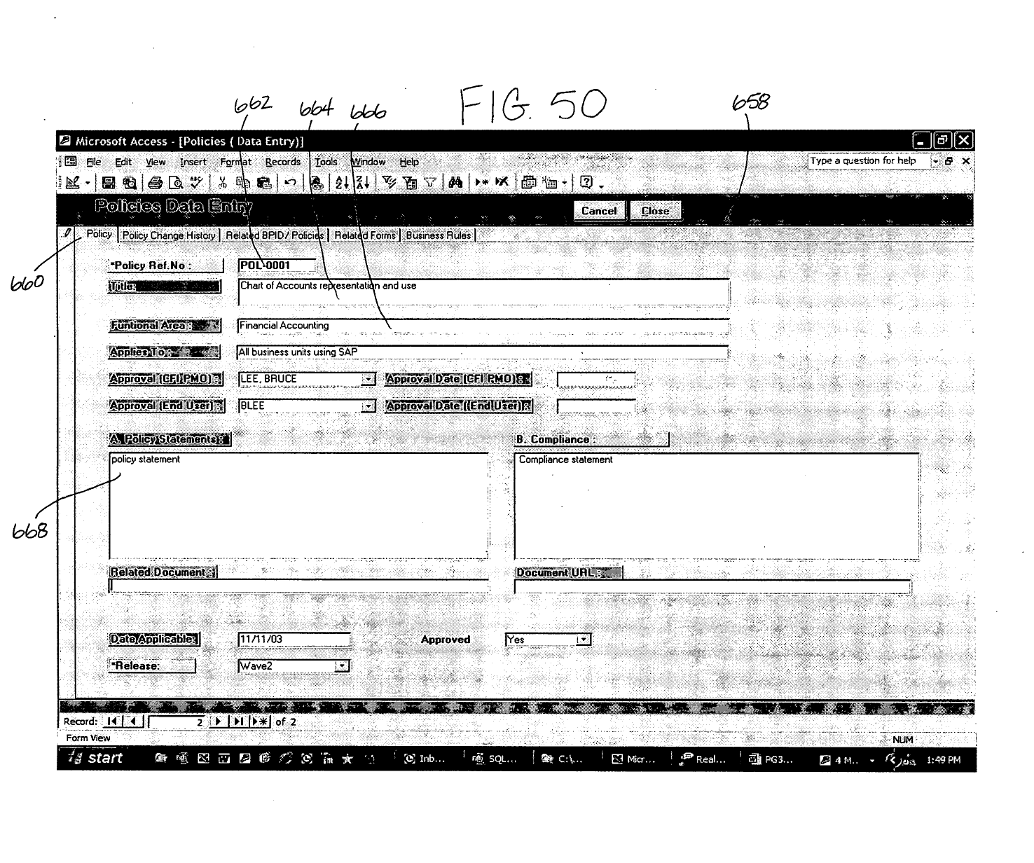

Referring to FIG. 49, the process and package submenu also includes a policies screen 650, which displays project policy information. In particular, the policies screen includes fields 64 for the display of the policy reference number 652, policy title 654, and name of the functional area of the organization to which the policy applies 656. Referring additionally to FIG. 50, policy information can be entered by the user in the policies data entry screen 658, which, when a policy tab 660 is selected, includes fields for the entry and display of the policy reference number 662, title 664, functional area to which the policy applies 666, and policy statement 668.

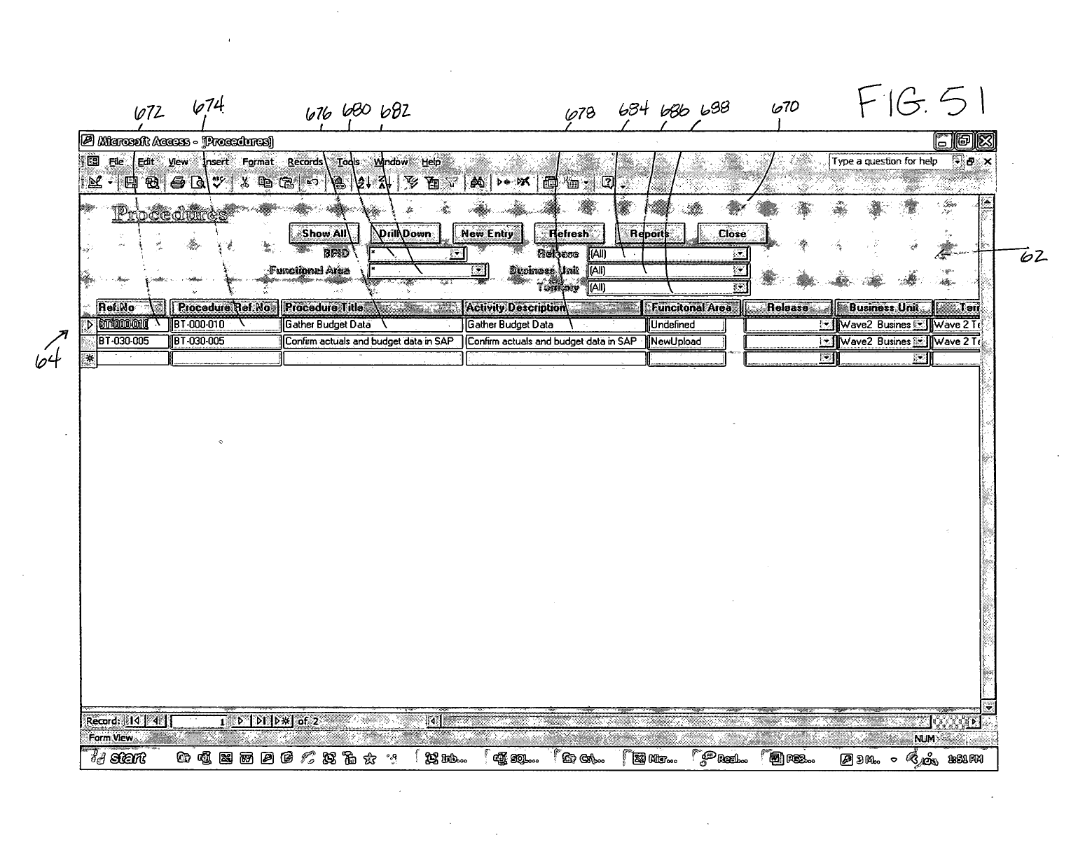

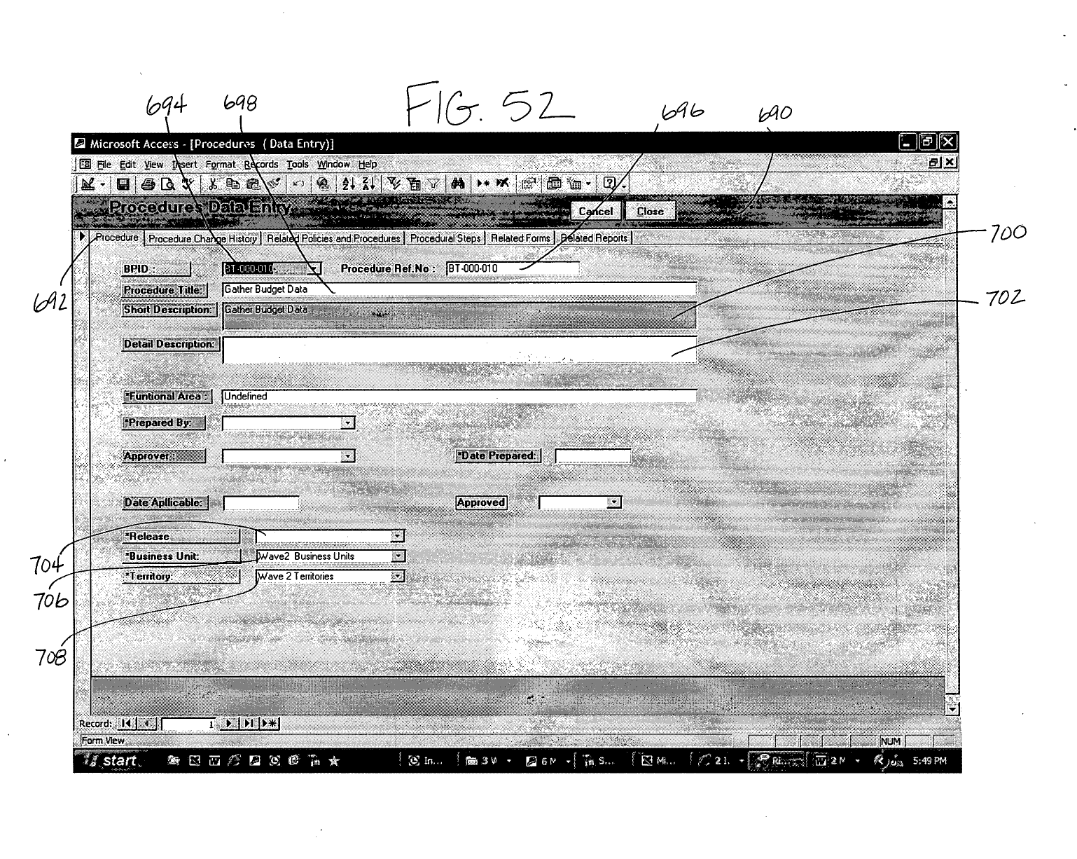

Referring to FIG. 51, the process and package submenu includes a procedures screen 670, which displays project procedure information. In particular, the procedures screen includes fields 64 for the display of the reference number 672, procedure reference number 674, procedure title 676, and activity description 678. The procedures screen also includes filters 62 for the entry of procedure-related data, in particular, the business process ID 680, functional area 682, release 684, business unit 686, and territory 688. A project procedure can be entered by the user in a procedures data entry screen 690, shown in FIG. 52. When a procedure tab 692 selected on the procedures data entry screen, fields are displayed of the BPID 694, procedure reference number 696, procedure title 698, short description 700, detail description 702, release 704, business unit 706, and territory 708.

The Project Management Submenu

The project management submenu includes information related to project issue management. For example, the project management submenu includes a master list of all project issues and action items, and provides for their reporting. Action items are identified and tracked for all change requests under the project management submenu. Project management submenu screens also display information about the project organization and team members.

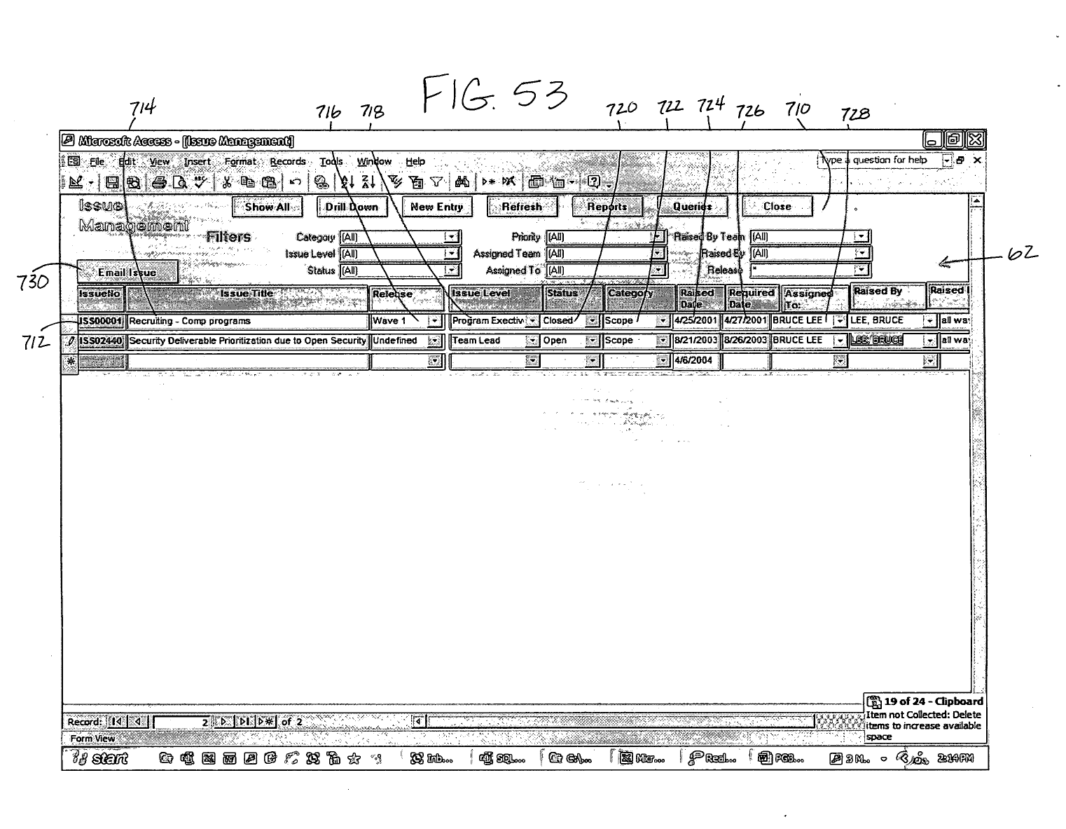

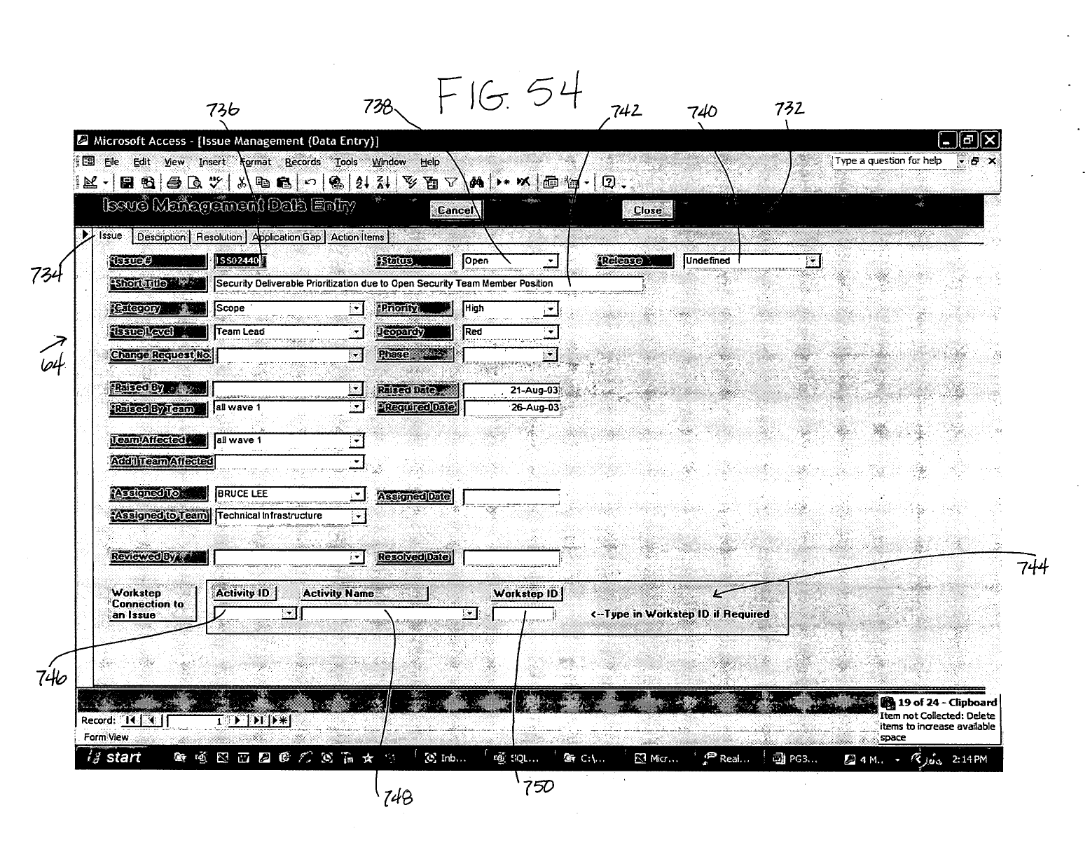

Referring to FIG. 53, the project management submenu includes an issue management screen 710, which includes fields 64 for the display of the issue number 712, issue title 714, release 716, issue level 718, status 720, category 722, raised date 724, required date 726, and individual assigned to the issue 728. The issue management screen also includes filters 62 for sorting the issue-related data. The issue management screen also includes an electronic-mail trigger button 730, which, when selected, launches MS Outlook, attaches an issue report (not shown) as a document, and sends the issue report document to the assigned person. Referring to FIG. 54, an issue management data entry screen 732, when an issue tab 734 is selected, includes fields for the entry of the issue number 736, status 738, release 740, and title 742. The issue management data entry screen also includes fields 744 for the entry of information to connect an issue to a work step. In particular, the issue management data entry screen includes fields for the entry and display of an activity ID 746, activity name 748, and work step ID 750 for the work step connected to the issue.

Referring again to FIG. 4, the project management submenu also includes a change request screen 752, which includes fields 64 for the change request ID (“CRID”) 754, change request name 756, status 758, and priority 760. The change request screen also includes filters 62 having fields for the entry of information used to sort the change request data. The change request screen also includes an electronic-mail trigger button 761, which, when selected, launches MS Outlook, attaches a change request report (not shown) as a document, and sends the change request document to the assigned person.

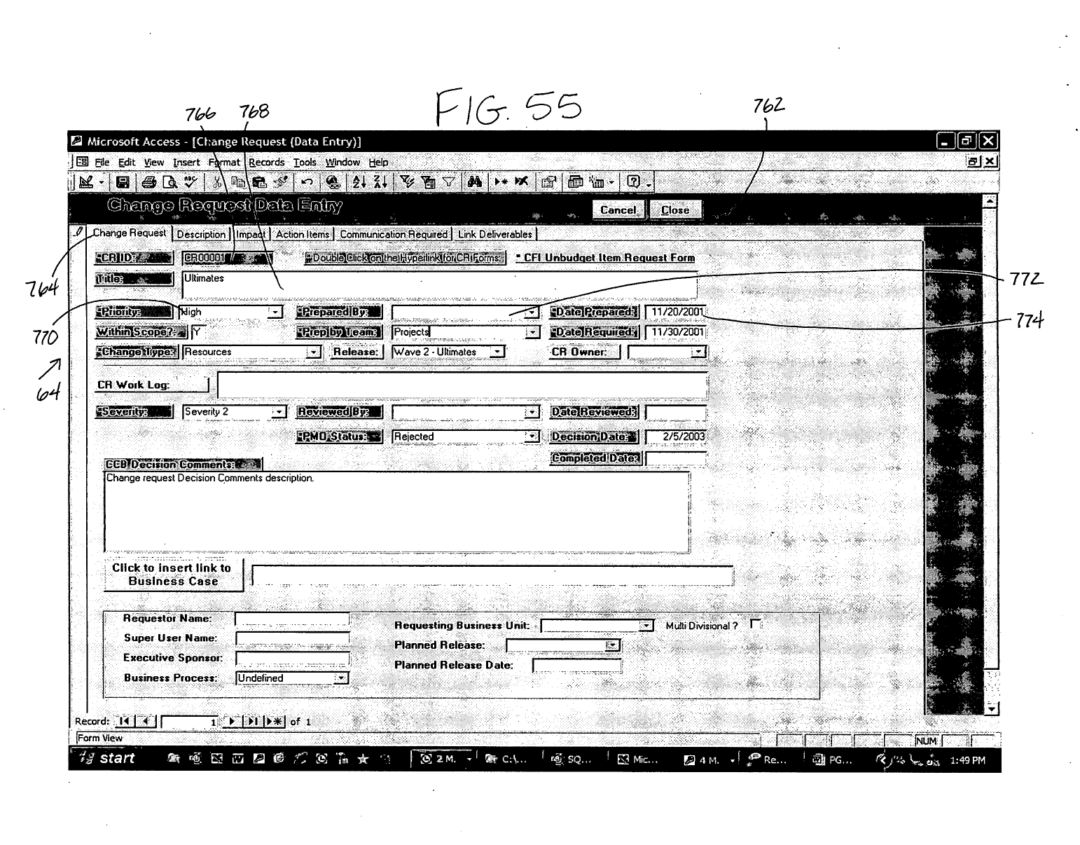

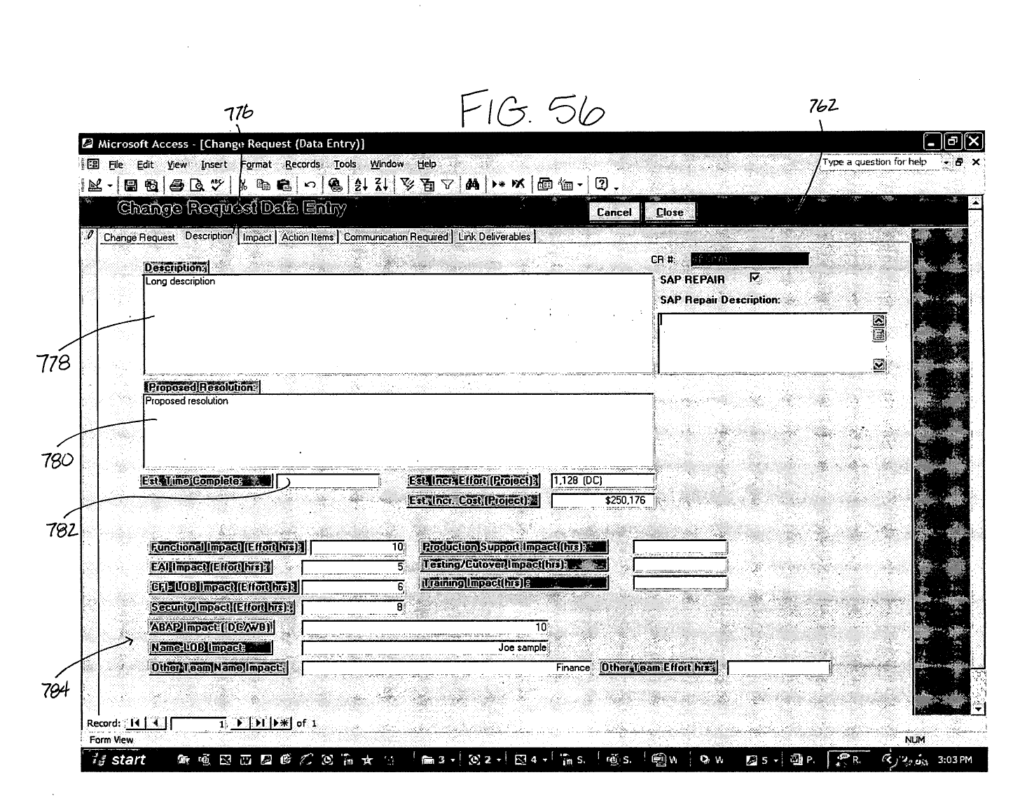

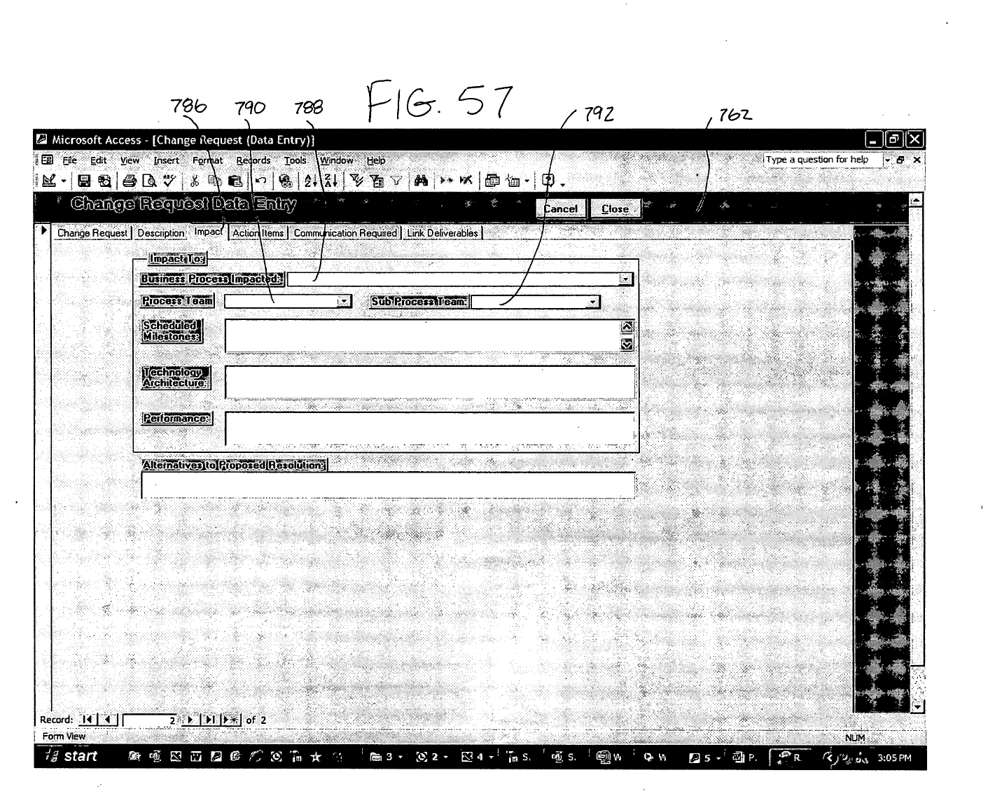

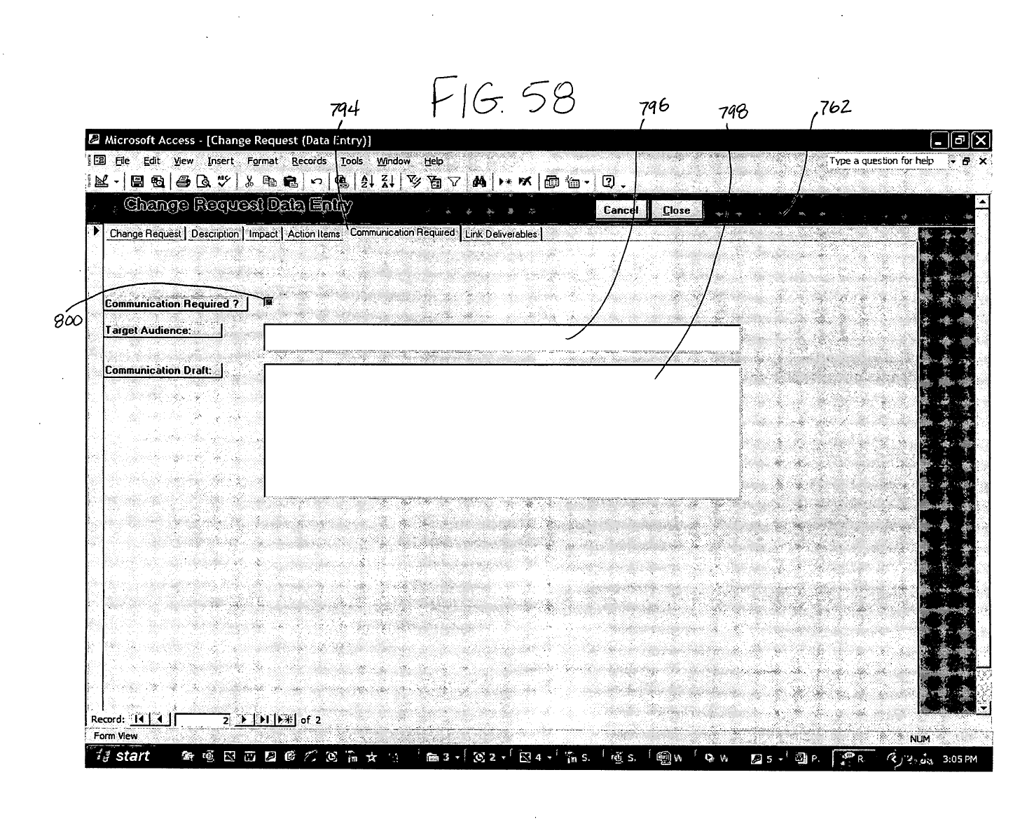

Referring to FIG. 55, a change request data entry screen 762, with a change request tab 764 selected, is shown that includes fields 64 for the entry of the CRID 766, title 768, priority 770, name of the person who prepared the change request 772, and date prepared. Referring to FIG. 56, when a description tab 776 is selected on the change request data entry screen, fields are displayed for the entry of a description of the change request 778, proposed resolution 780, estimated time to complete the change request 782, and impact 784, e.g., the estimated effort in hours, of the change request on different project teams. When an impact tab 786 is selected on the change request data entry screen (see FIG. 57), fields are displayed for entry of the name of the business process 788, process teams 790, and sub process teams 792 that will be impacted by the change request. When a communication required tab 794 is selected on the change request data entry screen (see FIG. 58), fields are displayed for the entry of the target audience 796 and communication draft 798. Also, a checkbox 800 is displayed, which is selected when communication is required. When a link deliverables tab 802 is selected on the change request data entry screen, fields are displayed for the viewing and entry of the change request ID 804, deliverable ID 806, and deliverable name 808.

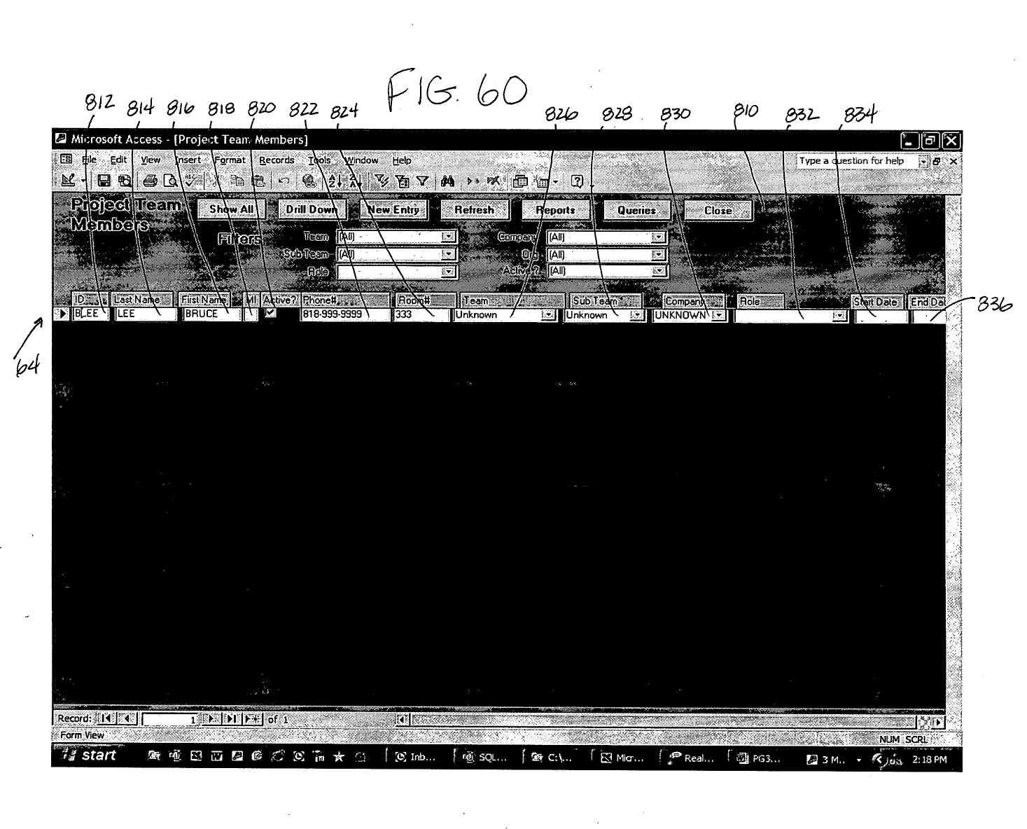

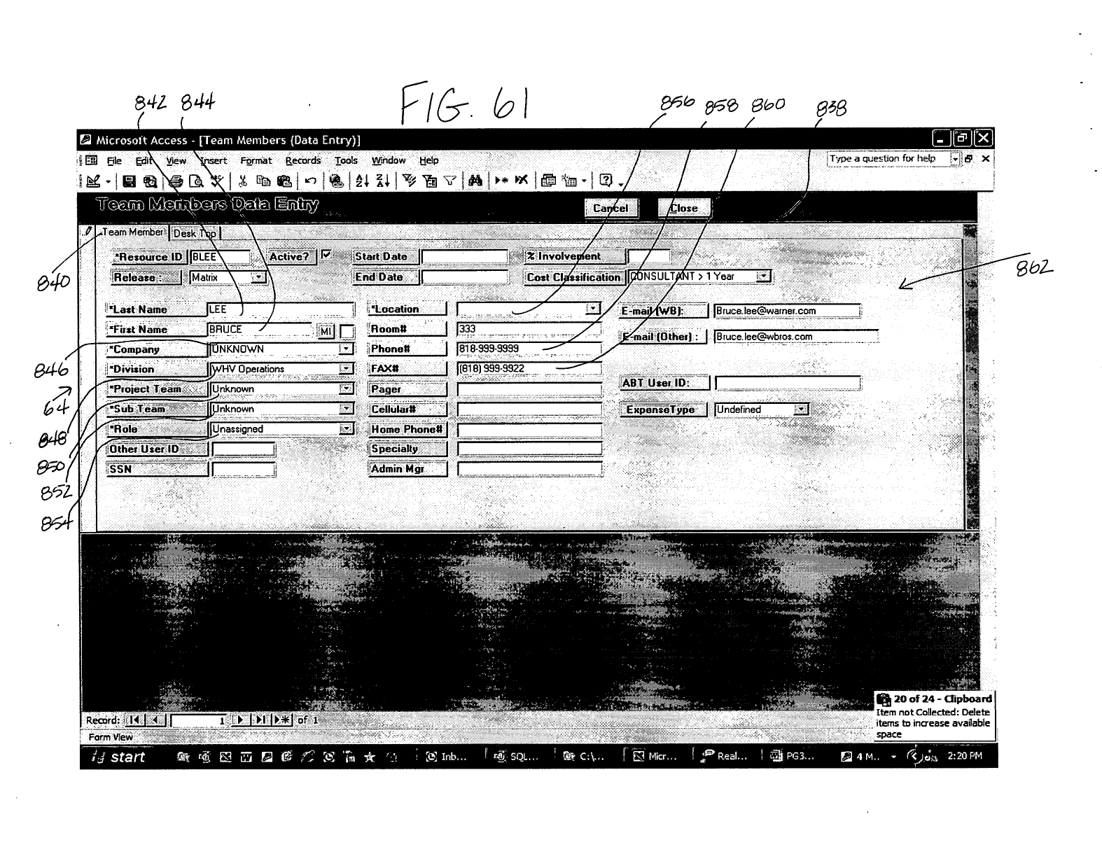

Referring to FIG. 60, the project management submenu also includes a project team member screen 810, which includes fields 64 for the project team member's ID 812, last name 814, first name 816, middle initial (“MI”) 818, activity status 820, phone number 822, room number 824, team name 826, sub team name 828, company name 830, role 832, start date 834, and end date 836. Referring to FIG. 61, a team members data entry screen 838 includes a team member tab 840, which, when selected, displays fields for the entry of team member information, e.g., last name 842, first name 844, company 846, division 848, project team 850, sub team 852, role 854, location 856, phone number 858, facsimile number 860, and electronic-mail address 862.

The Training and Performance Support Submenu

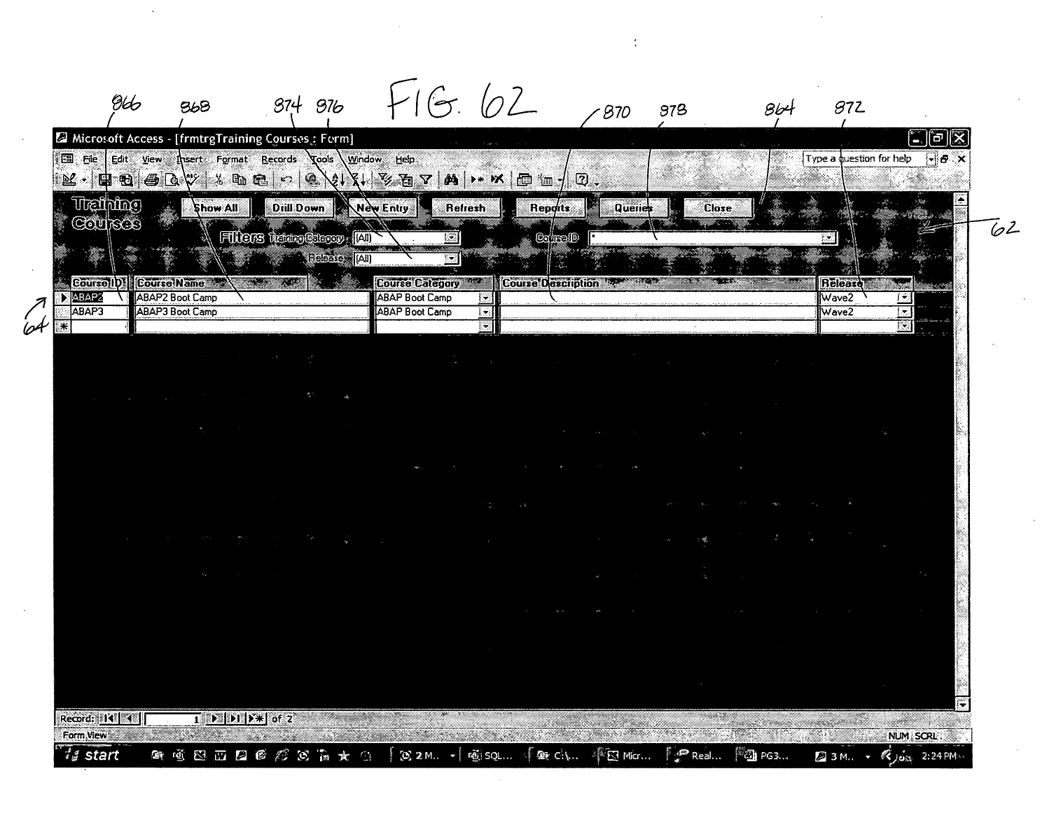

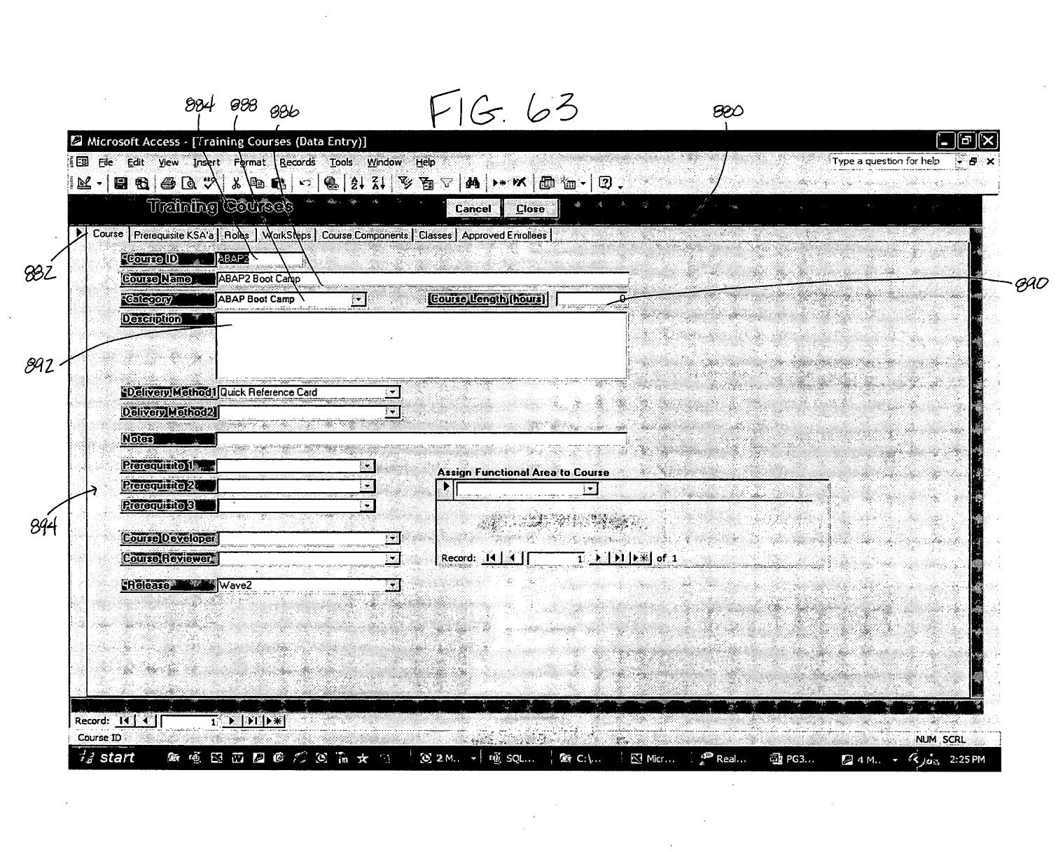

The training and performance support submenu involves information related to training courses, classes, facilities, vendors, and approved enrollees. Referring to FIG. 62, a training courses screen 864, which is located under the training and performance support submenu, includes fields 64 for the display of the course ID 866, course name 868, course description 870, and release 872. The training courses screen also includes filters 62 having fields for the entry of the training category 874, release 876, and course ID 878. Referring to FIG. 63, the training and performance submenu also includes a training courses data entry screen 880, which, when a course tab 882 is selected, includes fields for the entry of, for example, the course ID 884, course name 886, category 888, course length 890, description 892, and prerequisites 894 for a new course.

The program has been integrated with a web-based training management system (“TMS”) that pulls stakeholder data from the databases to enroll students in courses, notifies students of their schedules, and schedules classes and other training activities, e.g., online training. Many triggers and stored procedures have been created on the database side of the program under the training and performance support submenu to facilitate the successful interaction of the TMS and the program.

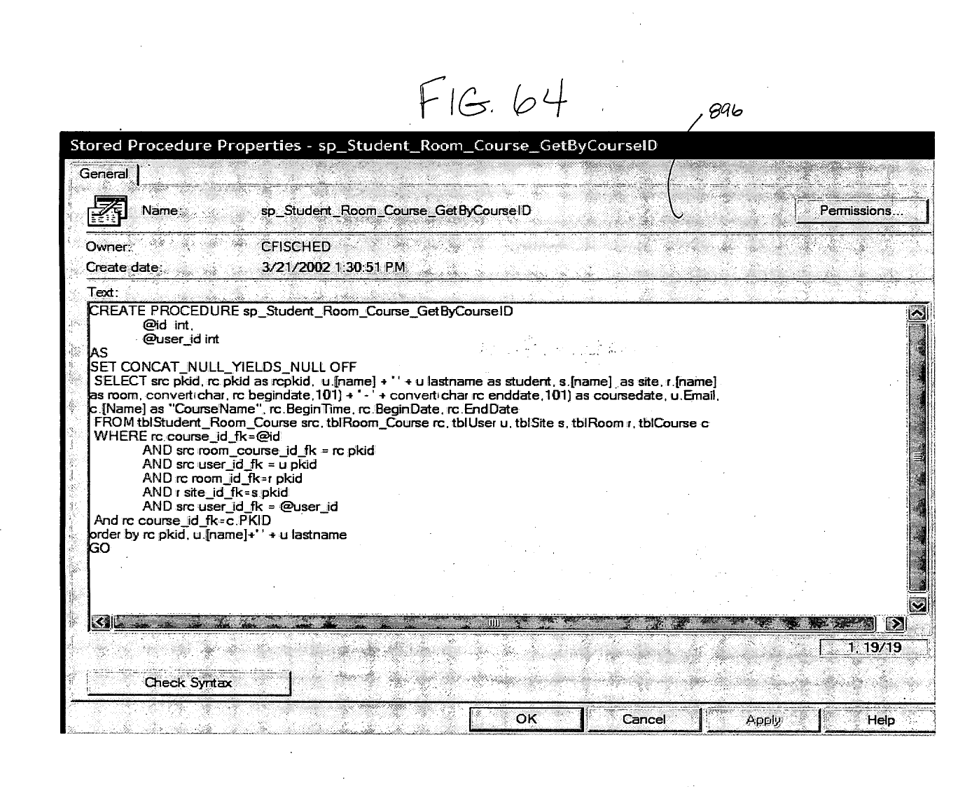

A trigger is a special type of stored procedure that automatically takes effect when the data in a specified table is modified. For example, when a business role mapping occurs in the program, a trigger alerts the TMS that data has been modified. After the alert, a stored procedure is executed in the TMS. A stored procedure sends commands to SQL Server and processes the results. The stored procedure definition contains two primary components: the specification of the procedure name and its parameters, and the body of the procedure, which contains Transact-SQL statements that perform the procedure's operations. For example, a stored procedures screen 896 (see FIG. 64) is accessed to pull student, room, and course information.

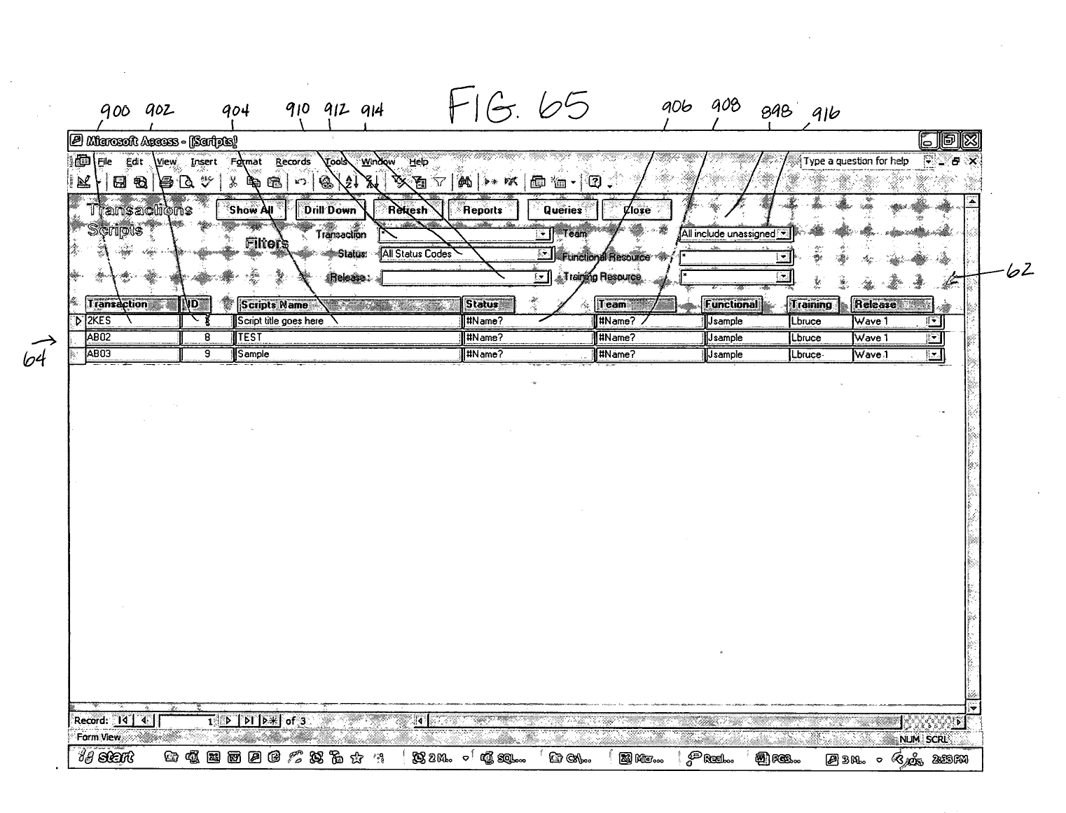

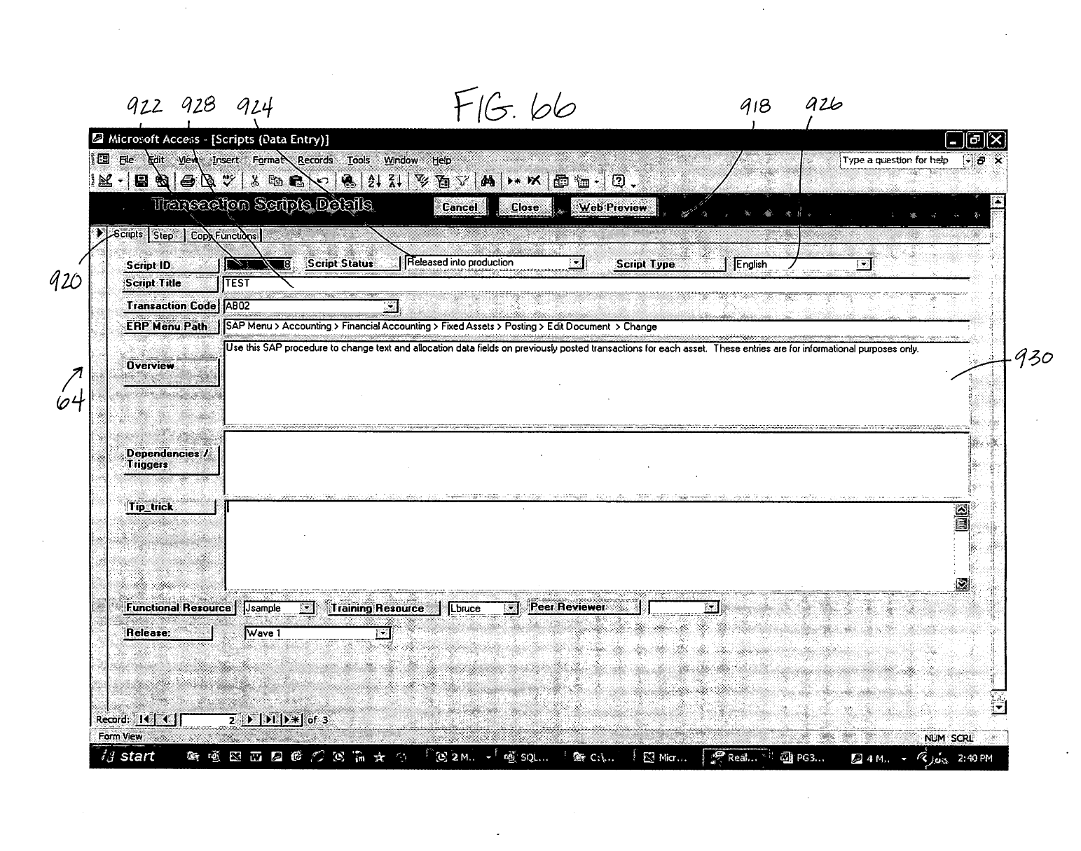

Referring to FIG. 65, a transactions scripts screen 898, which is included under the training and performance support submenu, includes fields 64 for the display of the transaction type 900, transaction ID 902, scripts name 904, status 906, and team 908. The transactions scripts screen also include filters 62 having fields for the entry of the transaction name 910, status 912, release name 914, and team name 916. Referring to FIG. 66, a transaction scripts details screen 918, when a scripts tab 920 is selected, includes fields for the viewing or entry of the script ID 922, script status 924, script type 926, script title 928, and overview 930.

Program Features

The program includes group-based security features, which reduce the risk of inadvertent or misguided changes to critical data, and restrict user access to particular data. The program includes three different security groups having the following permissions: group one, which permits read only access to the data; group two, which permits read, write, and create access to the data; and group three, which permits read, write, create, and destroy access to the data. The security groups associated with each stakeholder are assigned to the user account. A login ID by itself does not give a user permission to access the data. A login ID must be associated with a user account in each database before anyone connecting with that login ID can access the database. If a login ID has not been explicitly associated with a user account in a database, it is associated with the guest user ID. If a database has no guest user ID, a user cannot access the database unless it has been associated with a valid user account.

The program also includes an audit trail feature which tracks when changes are made to the databases, the identity of the user that made the changes, and when the changes were made. For example, the business process data entry screen 524 (see FIG. 37) and the work step data entry screen 592 (see FIG. 45) include underlying fields (not shown) for the entry of the user's name and the update time of all changes. A timestamp and the username are attached to the data records when they are changed. The audit trail is implemented in a two step process. First, two fields, the “LastUpdated” and the “UpdatedBy” fields, are added to the underlying tables of FIGS. 37 and 45, and are populated by the system. The “LastUpdated” field captures the time of the change. The “UpdatedBy” field captures the user's ID. The second part of the process is handled by visual basic code that pulls the current date and user ID data and populates the respective fields in the screens.

The program advantageously includes both territory and division-specific data. As a result, items related to a project can be assigned to a specific territory and/or division. The program also advantageously allows users to access and modify records from different states, e.g., the current process or design specification, and the new or proposed process or design specification, and projects. As mentioned above, the program also allows the user to link supporting technical documents (not shown), e.g., screen shots, VISIO diagrams, and various technical or design documents, stored in formats different from that used by the program into records stored by the program. Thus, the program provides a central place where the supporting documentation can be linked and viewed.

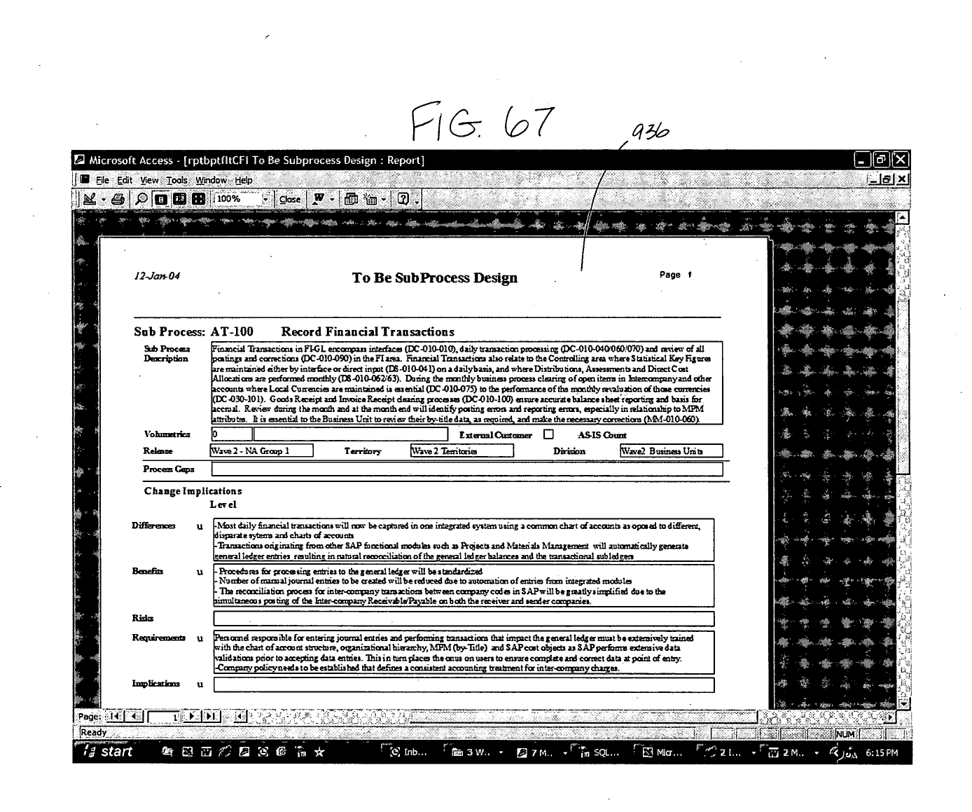

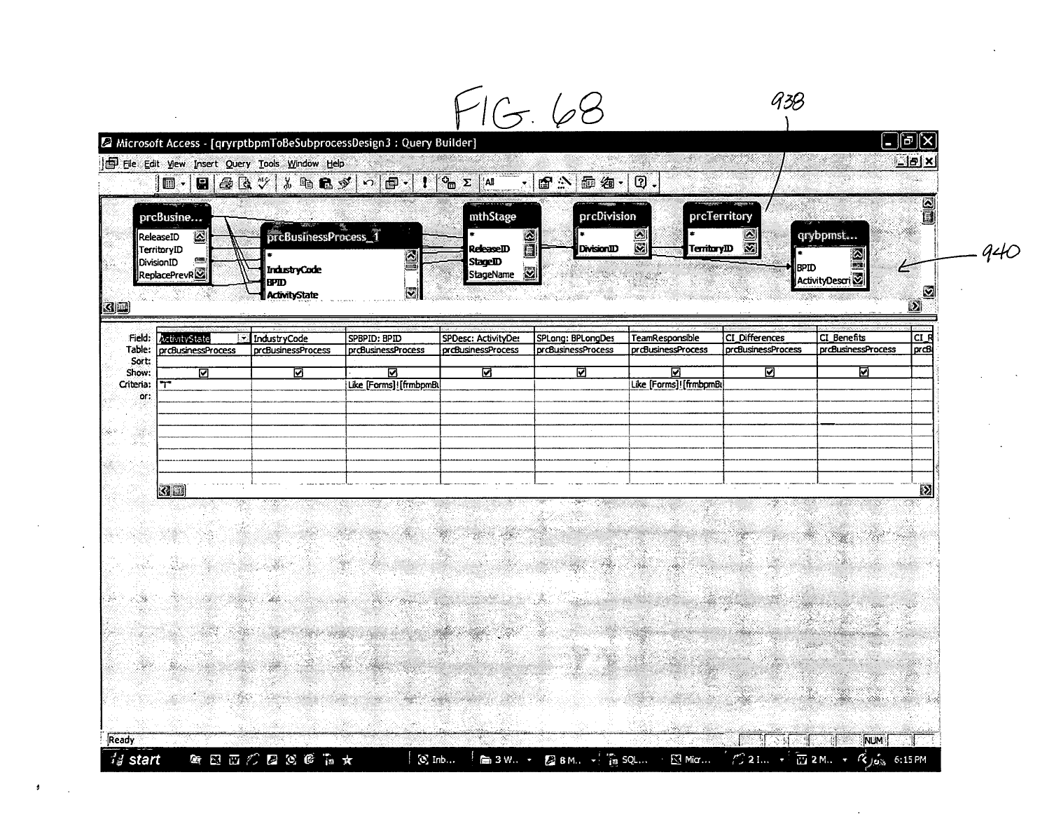

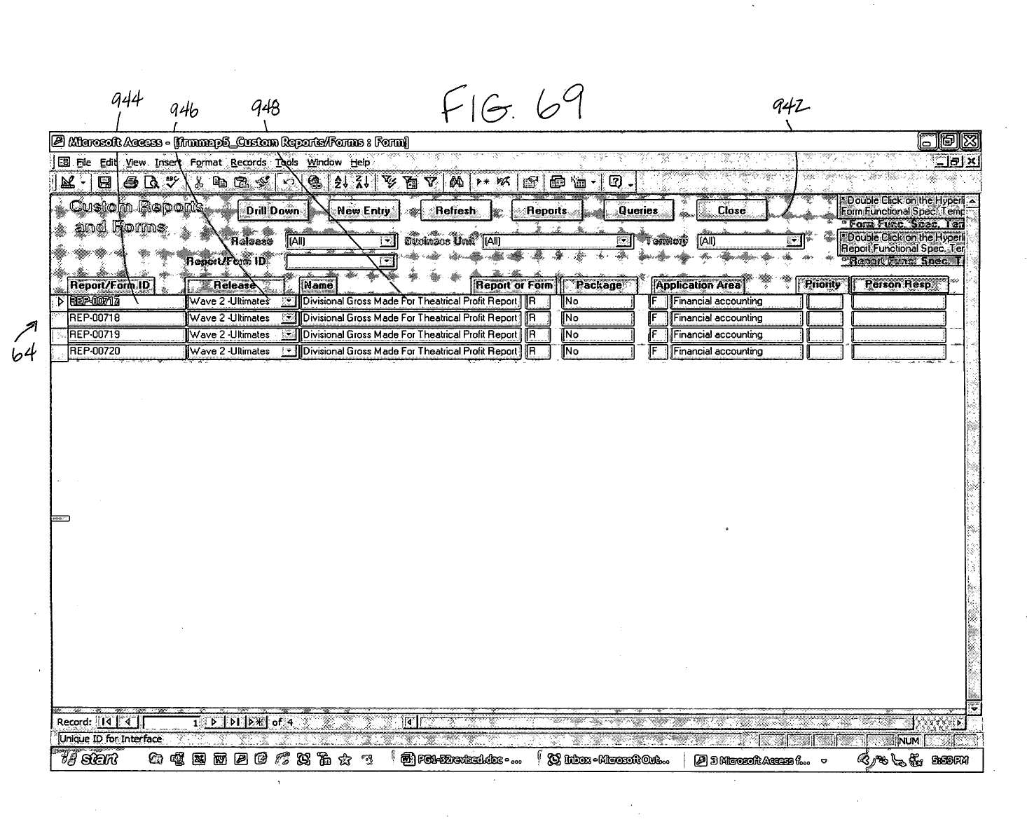

Furthermore, the program advantageously provides for custom reports (not shown) and queries (not shown), which are used to view and analyze project data. Most of the custom reports are created in MS Access, thus allowing the program to be a customizable and flexible reporting tool. Referring to FIGS. 4 and 43, screens 30 of the program include the ability to generate custom reports by clicking on a screen's reports button 50. After clicking on the report button, referring additionally to FIG. 18, a new window will open with lists 254 of reports. The user can run any of these reports by double clicking on them. The user has the choice of filtered reports 932, ones based on user-input criteria, or standard reports 934. An example report 936 is shown in FIG. 67. The report is created in MS Access by querying data from different tables 14 and 16 in the program (see the prior discussion of the query process). FIG. 68 is a screen shot 938 of an underlying query that was built in MS Access to retrieve the data from the database. In particular, FIG. 68 shows the tables 940 that were accessed when generating the query. Query Builder is the tool in MS Access that is used to create the custom queries. Query Builder allows for the capability to: display and sort records; perform calculations; generate data for forms, reports, and other queries; and find and display data from two or more tables. Referring additionally to FIG. 69, custom reports and forms (not shown) can be generated by inputting information shown in fields 64 displayed in a custom reports and forms screen 942 such as the report/forms ID 944, release 946, and report name 948.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

What is claimed is:

1. A computer-readable medium included in a server that has a database and to which a workstation having a monitor is coupled for viewing by a user, the computer-readable medium comprising instructions for database management wherein:
the database includes project data related to multiple tasks handled by more than one project group;
the instructions prompt a display of the project data on the monitor; and
the instructions prompt a display of a filter on the monitor that the user can use to perform sorting of the project data.

2. The computer-readable medium according to claim 1, wherein the instructions prompt a display of an icon on the monitor that is selectable by the user and that generates a report based on the project data.

3. The computer-readable medium according to claim 1, wherein the instructions allow the user to input project data into the database.

4. The computer-readable medium according to claim 1, wherein the project data is selected from the group consisting of project release information, project division information, business unit information, and territory information.

5. The computer-readable medium according to claim 1, wherein the instructions are written in a computer language selected from the group consisting of MS Access and Visual Basic.

6. The computer-readable medium according to claim 1, wherein the instructions are configured to facilitate a display of stakeholder project data selected from the group consisting of a stakeholder's name, a stakeholder's job title, a stakeholder's business role, a stakeholder's work location, a stakeholder's electronic-mail address, a stakeholder's facsimile number, a stakeholder's business unit, a stakeholder's network identification, a stakeholder's employment start date, a stakeholder's employment end date, a stakeholder's spending limit, a stakeholder's approval limit, and a stakeholder's spending limit approver.

7. The computer-readable medium according to claim 1, wherein the instructions are configured to facilitate a display of inventory data selected from the group consisting of server identification information, workstation identification information, and printer information.

8. The computer-readable medium according to claim 1, wherein the instructions are configured to facilitate a display of business process data selected from the group consisting of project organization information, team member information, project policy information, project procedures information, business process information, business sub-process information, business activity information, business work step information, project issue information, action item information, and change request information.

9. The computer-readable medium according to claim 1, wherein the project data displayed on the monitor is configured in a screen, and the instructions are configured to facilitate copying of a functionality of the screen and project data mapped to the screen when the user creates another screen.

10. The computer-readable medium according to claim 1, wherein the instructions are configured to provide the user with access to a view that facilitates a fast querying of project data stored in the database.

11. The computer-readable medium according to claim 1, wherein the instructions are configured to facilitate a display of change request information selected from the group consisting of an estimated time of completion of a change request and an impact of the change request on different project teams.

12. The computer-readable medium according to claim 1, wherein the instructions are configured to facilitate a display of training information selected from the group consisting of training course information, a training course developer name, facility information, and enrollee information.

13. The computer-readable medium according to claim 1, wherein the instructions are configured to pull stakeholder information from the database, enroll a stakeholder in a training course, and notify the stakeholder of a class schedule.

14. The computer-readable medium according to claim 1, wherein the instructions include a security feature that restricts the user's access to particular project data and provides the user permission to project data selected from the group consisting of read-only access, read-write-create access, and read-write-create-destroy access.

15. The computer-readable medium according to claim 1, wherein the instructions include an audit trail that tracks change information selected from the group consisting of a time when a change was made to the data in the databases and an indication of who made the change.

16. A computer-readable medium included in a server that has a database and to which a workstation having a monitor is coupled, the computer-readable medium comprising instructions for database management wherein:
the database includes project data related to multiple tasks handled by more than one project group;
the instructions prompt a display of the project data on the monitor for viewing by a user; and
the instructions prompt a display of a filter on the monitor that the user can use to perform sorting of the project data;
wherein:
the project data displayed on the monitor is configured in a screen, and the instructions are configured to facilitate copying of a functionality of the screen and project data mapped to the screen when the user creates another screen,
the instructions are configured to provide the user with access to a view that facilitates a fast querying of project data stored in the database,
the instructions are configured to facilitate a display of change request information selected from the group consisting of an estimated time of completion of a change request and an impact of the change request on different project teams,
the instructions are configured to facilitate a display of training information selected from the group consisting of training course information, a training course developer name, facility information, and enrollee information,
the instructions include a security feature that restricts the user's access to particular project data and provides the user permission to project data selected from the group consisting of read-only access, read-write-create access, and read-write-create-destroy access, and
the instructions include an audit trail that tracks change information selected from the group consisting of a time when a change was made to the data in the databases and an indication of who made the change.

17. A method for managing a database stored on a server, the method comprising:
providing a workstation having a monitor configured to facilitate a display of project data included in the database for viewing by a user, wherein the project data is related to multiple tasks handled by more than one project group;
providing the user an ability to perform a search on the project data;
displaying a filter on the monitor that the user can use to perform sorting of the project data; and
providing the user an ability to display search results on the monitor.

18. The method according to claim 17, further comprising displaying an icon on the monitor that is selectable by the user to generate a report based on the project data.

19. The method according to claim 17, wherein the project data is selected from the group consisting of project release information, project division information, business unit information, and territory information.

20. The method according to claim 17, further comprising displaying stakeholder project data selected from the group consisting of a stakeholder's name, a stakeholder's job title, a stakeholder's business role, a stakeholder's work location, a stakeholder's electronic-mail address, a stakeholder's facsimile number, a stakeholder's business unit, a stakeholder's network identification, a stakeholder's employment start date, a stakeholder's employment end date, a stakeholder's spending limit, a stakeholder's approval limit, and a stakeholder's spending limit approver.

21. The method according to claim 17, further comprising displaying inventory data selected from the group consisting of server identification information, workstation identification information, and printer information.

22. The method according to claim 17, further comprising displaying business process data selected from the group consisting of project organization information, team member information, project policy information, project procedures information, business process information, business sub-process information, business activity information, business work step information, project issue information, action item information, and change request information.

23. The method according to claim 17, wherein project data displayed on the monitor is configured in a screen, the method further comprising copying a functionality of the screen and project data mapped to the screen when the user creates another screen.

24. The method according to claim 17, further comprising providing the user with access to a view that facilitates a fast querying of project data stored in the database.

25. The method according to claim 17, further comprising displaying change request information selected from the group consisting of an estimated time of completion of a change request and an impact of the change request on different project teams.

26. The method according to claim 17, further comprising displaying training information selected from the group consisting of training course information, a training course developer name, facility information, and enrollee information.

27. The method according to claim 17, further comprising pulling stakeholder information from the database, enrolling a stakeholder in a training course, and notifying the stakeholder of a class schedule.

28. The method according to claim 17, further comprising restricting the user's access to particular project data and providing the user permission to project data selected from the group consisting of read-only access, read-write-create access, and read-write-create-destroy access.

29. The method according to claim 17, further comprising providing an audit trail that tracks change information selected from the group consisting of a time when a change was made to the data in the databases and an indication of who made the change.
